(19) United States
(12) Patent Application Publication
(10) Pub. No.: US 2005/0005261 A1
(43) Pub. Date: Jan. 6, 2005

(54) Component integration engine

(76) Inventor: William B. Severin, Centreville, VA (US)

Correspondence Address: JAGTIANI + GUTTAG, 10363-A DEMOCRACY LANE, FAIRFAX, VA, 22030, US

(21) Appl. No.: 10/882,318

(22) Filed: Jul. 2, 2004

Related U.S. Application Data
(60) Provisional application No. 60/484,251, filed on Jul. 2, 2003.

(51) Int. Cl. G06F 9/44

(52) U.S. Cl. 717/108; 717/116; 717/120

(57) ABSTRACT

The present invention provides meta-implementation layer comprising: a metamodel repository containing a plurality of descriptors; a plurality of implementations for providing access to software components described by the plurality of descriptors; a metametamodel repository including a plurality of metamodel descriptors for describing the descriptors and a plurality of metamodel implementations for describing said implementations, wherein the meta-implementation layer provides access to an implementation of the plurality of implementations to thereby allow a user to have access to the software components of a software program. The present invention also provides a component integration engine using a meta-implementation layer.

### CROSS-REFERENCE TO RELATED APPLICATIONS

This application claims the priority of U.S. Provisional Patent Application No. 60/484,251, entitled “Component Integration Engine,” filed Jul. 2, 2003 and the entire disclosure and contents of this provisional patent application are hereby incorporated by reference.

### BACKGROUND

1. Field of the Invention

The present invention relates to a computer method and system for creation of computer software.

2. Related Art

Object-oriented programming distributes data and functionality among different objects. Dividing a system into objects tends to increase reusability of code. Many programs that require the same groupings of features and functionality can reuse a model. When programs require similar groupings of features and functionality, object-oriented techniques like model inheritance and method overriding allow most of the code to be reused while adding new methods and attributes or varying existing methods and attributes. Inheritance does not allow the removal of methods or attributes.

Objects connect to other objects by attribute references, parameter references, and method calls into the other objects. Having many connections between objects tends to reduce the reusability of code. The higher the number of connections between objects, the more the object requires the other objects in order work correctly. When objects require other objects in order to perform properly, they behave more like a single, larger object, working against the goal of dividing a system into smaller objects.

Many differences exist even between programs of a similar nature. These differences require the addition and variation of methods and attributes through inheritance. These small differences lead to a proliferation of models, each of which is only slightly different from the others. This proliferation increases costs associated with software maintenance since new models need to be documented, tested, debugged, and maintained.

In order to increase code reuse and reduce model proliferation, resulting in lower cost of development and maintenance, an approach is needed to reduce the number of connections between models and reduce the number of attributes and number of methods that needs to be changed through inheritance.

### SUMMARY

According to a first broad aspect of the present invention, there is provided a meta-implementation layer comprising: a metamodel repository containing a plurality of descriptors; a plurality of implementations for providing access to software components described by the plurality of descriptors; a metametamodel repository including a plurality of metamodel descriptors for describing the descriptors and a plurality of metamodel implementations for describing the implementations, wherein the meta-implementation layer provides access to an implementation of the plurality of implementations to thereby allow a user to have access to the software components of a software program.

According to a second broad aspect of the invention, there is provided a component integration engine comprising: a meta-implementation layer for allowing a user to have access to components of a software program; a plurality of component integration instances for providing access to software component instances to thereby allow the software component instances to be assembled in the software program; communication means for allowing a user to communicate with the component integration engine; and assembly means for assembling the component integration instances to build the software program.

According to a third broad aspect of the invention, there is provided a computer system having a meta-implementation layer stored therein, wherein the meta-implementation layer comprises: a metamodel repository containing a plurality of descriptors; a plurality of implementations for providing access to software components described by the plurality of descriptors; a metametamodel repository including a plurality of metamodel descriptors for describing the descriptors and a plurality of metamodel implementations for describing the implementations, wherein the meta-implementation layer provides access to an implementation of the plurality of implementations to thereby allow a user to have access to the software components of a software program.

According to a fourth broad aspect of the invention, there is provided a storage medium including instructions stored thereon that when executed by a computer system produce a meta-implementation layer, wherein the meta-implementation layer comprises: a metamodel repository containing a plurality of descriptors; a plurality of implementations for providing access to software components described by the plurality of descriptors; a metametamodel repository including a plurality of metamodel descriptors for describing the descriptors and a plurality of metamodel implementations for describing the implementations, wherein the meta-implementation layer provides access to an implementation of the plurality of implementations to thereby allow a user to have access to the software components of a software program.

### BRIEF DESCRIPTION OF THE DRAWINGS

The invention will be described in conjunction with the accompanying drawings, in which:

FIG. 1 is a block diagram illustrating a meta-implementation of the present invention;

FIG. 2 is a block diagram illustrating the metametamodel repository of the meta-implementation layer of FIG. 1;

FIG. 3 is a component integration engine including the meta-implementation layer of FIG. 1;

FIG. 4 is a block diagram showing relationships between metamodels, other metamodels, and models used with the meta-implementation layer and component integration engine according to one embodiment of the present invention;

FIGS. 5-34 are a block diagram, in multiple sections, illustrating how a component integration engine according to one embodiment of the present invention operates;

FIG. 35 is a block diagram illustrating a component integration engine server according to one embodiment of the present invention;

FIG. 36 is a block diagram illustrating service contexts of a component integration engine server according to one embodiment of the present invention;

FIG. 37 is a block diagram illustrating a certificate_store manager of a component integration engine server of the present invention; and

FIG. 38 is a block diagram showing a customizer manager of a component integration engine server according to one embodiment of the present invention mapping a type of component to the customizer responsible for customizing that type of component.

### DETAILED DESCRIPTION

It is advantageous to define several terms before describing the invention. It should be appreciated that the following definitions are used throughout this application.

Definitions

Where the definition of terms departs from the commonly used meaning of the term, applicant intends to utilize the definitions provided below, unless specifically indicated.

For the purpose of the present invention, the term “method” refers to a named section of code within a model that performs a specific action. A method might take data as arguments and might return data. A method that returns data is called a function. A method that does not return data is called a procedure.

For the purposes of the present invention, “ODBC” is an abbreviation for Open Database Connectivity.

For the purposes of the present invention, “SQL” is an abbreviation for Standard Query Language.

For the purposes of the present invention, “CIE” is an abbreviation for Component Integration Engine.

For the purposes of the present invention, “DDL” is an abbreviation for Data Definition Language (part of SQL).

For the purposes of the present invention, “DML” is an abbreviation for Data Manipulation Language (part of SQL).

For the purposes of the present invention, “MVC” is an abbreviation for Model View Controller pattern.

For the purposes of the present invention, the term “abstraction” refers to the removal of uninteresting or unimportant details from a software definition to create a model.

For the purposes of the present invention, the term “attribute” refers to a named data value held by an object.

For the purposes of the present invention, the term “indirection” refers to the use of an intermediate object placed between the primary object and the entity using that the primary object object. An indirection buffers the entity using the primary object from the primary object, allowing changes to be made to the behavior or functionality of the primary object without the entity using the primary object noticing the change.

For the purposes of the present invention, the term “accessor” refers to an indirection between a descriptor and an implementation. An accessor behaves as if it was an implementation, but delegates to a real implementation. An accessor allows implementations that are not fully self-describing to be contained by the accessor to add the missing details.

For the purposes of the present invention, the term “aggregation” refers to a relationship between a model and one of its attributes in which the attribute is one part of the larger whole. An example of an aggregation is automobile components. The automobile aggregates the engine, tires, and other components into a larger object. The object performing these aggregations is referred to as an “assembly.” A “composition” is a special type of aggregation in which the attribute parts are created exclusively for the larger whole and are not shared with any other object. In this case the “assembly” is also a “composite object”.

For the purposes of the present invention, the term “association” refers to a relationship between two independent models.

For the purposes of the present invention, the term “association model” refers to a model containing one or more attributes for each model participating in an association relationship. An example of an association is a business and its employees. Each employee would exist and have purpose outside of the business. The business relationship provides an association between these people and may provide benefit to each person and the business participating in this association. An example of an association model is a cross-reference table in a database. A cross-reference table defines a many-to-many relationship between two entity tables, neither of which contains any reference to the other. Each entity table contains objects that are independent and complete. The cross-reference table serves solely to establish the relationship between these tables. A cross-reference table might be used to track which employee works at which business.

For the purposes of the present invention, the term “base model” refers to a model that defines features and functionality that are inherited by other models.

For the purposes of the present invention, the term “categorization” refers to a process of grouping similar models. Categorization makes it easier to refer to multiple models that share common characteristics. Models of the present invention that extend from the same base model fit into the type defined by that base model. Models that participate in the same interface fit into the type defined by that interface.

For the purposes of the present invention, the term “class” refer to an object type; a group of objects that have the same features and functionality. Classes are blueprints or definitions used to create software instances called objects. Software models are implemented in classes.

For the purposes of the present invention, the term “classifier” refers to an element in a metamodel which is not a feature of another element and which participates in the process of categorization. Classifiers include connectors, datatypes, interfaces, models, and signals. Classifiers are described using classifier descriptors including connector descriptors, datatype descriptors, interface descriptors, model descriptors, and signal descriptors.

For the purposes of the present invention, the term “command” refers to a component that performs a specific action. In addition a command must describe the input data it expects and the output data it produces.

For the purposes of the present invention, the term “component integration engine” or “CIE” refers an application that is able to assemble software applications directly from the description of the software application. A component integration engine provides a mechanism for using the meta-implementation layer to construct software applications in a consistent and effective manner through simple integration techniques without requiring lower-level programming language implementation. A component integration engine is a software engine that combines software components through metadata.

For the purposes of the present invention, the term “machine readable medium” refers to any medium or media on which a software program or data for a software program may be stored for use by a computer system. Examples of data machine readable media include such as floppy disks, Zip™ disks, CD-ROM, CD-R, CD-RW, DVD, DVD-R, flash memory, hard disks, optical disks, etc. The meta-implementation layer and/or component integration engine or any part of the meta-implementation layer or component integration engine of the present invention may be stored on one or more machine readable media that together effectively act similarly to single machine readable medium. Two or more machine readable media acting similarly to single machine readable medium may be referred to as a “machine readable medium” for the purposes of the present invention.

For the purposes of the present invention, the term “software component” or “component” refers to a binary object or program that performs a specific function and is designed in such a way to easily operate with other components and applications.

For the purposes of the present invention, the term “constraint” refers to a limit or restriction in a metamodel. Several types of constraints exist in metamodels. Occurrence constraints limit the number of times an instance can occur in the model. Occurrences cannot be negative. Value constraints limit the values allowed for an attribute. Access constraints restrict the use of a feature to users who hold the required credentials. Some examples of occurrence constraints are: “the box model can contain a maximum of twelve instances,” “the box model must contain at least one can instance,” “the car model can hold from zero to seven passenger instances,” etc. Some examples of value constraints are: “the ‘apple’ model ‘color’ attribute is of datatype string and must be one of: [‘Red,’ ‘Green,’ ‘Yellow’], “the ‘test’ model ‘percentage right’ value is of datatype number and must be between 0 and 100,” “the ‘cat’ model ‘owner name’ attribute value is of datatype string and must be less than 60 characters long,” etc. Some examples of access constraints: The “apple” model “color” attribute is restricted to users in the “grocer” group. The “test” model “percentage right” value can only be written to if the user is in the “teacher” group.

For the purposes of the present invention, the term “descriptor” refers to an interface implemented by classes that describe an implementation. The descriptor contains the descriptions of features and functionality allowed and required in an implementation. A descriptor is a specific type of metadata.

For the purposes of the present invention, the term “failure” refers to a software operation being unable to successfully complete, breaking out of the current execution and rising up the stack until the failure can be handled. Failures are broken into several categories: A “functional error” occurs when an operation should succeed, but an unusual or infrequent condition in the system prevented success. A “data error” occurs when improper or missing data is provided to an operation which requires that data in order to succeed. A “data bug” occurs when data is provided that is correct according to the rules for the data but the program did not anticipate and cannot handle that data. A “functional bug” describes an operation that successfully completes even though it completes the incorrect operation. Functional bugs are not always automatically detected during execution. Some functional bugs are detected by postcondition constraints.

For the purposes of the present invention, the term “feature descriptor” refers to a part of a metamodel that describes each feature of the model described by the metamodel. Feature descriptors for operations are referred to as “operation descriptors”. Feature descriptors for attributes are referred to as “attribute descriptors”. Feature descriptors for operation parameters are referred to as “parameter descriptors”. Feature descriptors for constraints are referred to as “constraint descriptors”. Feature descriptors for constructors are referred to as “constructor descriptors”. Feature descriptors for destructor are referred to as “destructor descriptors”. Feature descriptors for failures are referred to as “failure descriptors”. Feature descriptors for signals are referred to as “signal descriptors”. Each feature descriptor also includes name, description, and display name attributes. The name attribute is used to identify the name of the feature being described. The description attribute is used to describe the usefulness and purpose of the feature. The display name attribute is used to present a human readable name for the feature and may or may not be different from the value assigned to the name attribute.

For the purposes of the present invention, the term “generalization/specialization relationship” refers to a representation of the modeling processes of abstraction and categorization. A model specializes another model of the present invention by extending it. A model generalizes several other models by serving as a base model to those other models. Interfaces also participate in generalization/specialization relationships. Models specialize interfaces by implementing them in a specific way. Interfaces generalize models that share certain characteristics to in order to allow for polymorphic functionality.

For the purposes of the present invention, the term “implementation” refers to a structure that provides a mechanism to execute of all operations (including methods, signals, etc.) described in a descriptor, a mechanism to hold all static data described in a descriptor (including attributes, parameters, etc.), and a mechanism for creating instances of the type described by the descriptor. The instances created by an implementation hold all instance data described by the descriptor for that implementation.

For the purposes of the present invention, the term “inheritance” refers to the ability of one or more software models to of the present invention extend a base model in order to receive all the features and functionality of that parent model while adding new features and functionality. Models that inherit from a base model may also override features inherited from the parent model to change functionality or further restrict features. When common features and functionality may be logically grouped, but for technical reasons cannot be implemented in a parent model, an interface may be appropriate. When models share a type, either through a parent model or an interface, software processes can use these models interchangeably.

For the purposes of the present invention, the term “instance” refers to a single entity following the definition given by an implementation. The instances created by an implementation hold all instance data described by the descriptor for that implementation. The instance has access to the static data held by its implementation and can execute operations through the mechanism provided by the implementation.

For the purposes of the present invention, the term “interface” refers to a set of operations that must be implemented by a model in order for that model to participate in the interface's type for polymorphic functionality. An interface defines operations that must be implemented by any models that participate in that interface. Interfaces are a way of communicating over the boundary between two or more components. The components know how to communicate with each other because they all understand the interface used for this communication.

For the purposes of the present invention, the term “layer” or “software layer” refers to an indirection consisting of a plurality of components related to a specific task. An example “security layer” might consist of several components used to filter or restrict access to sensitive data. The security layer serves as an indirection between the user and the data.

For the purposes of the present invention, the term “manager” refers to a mechanism for sharing components between processes to improve scalability and centralize configuration. Each manager is responsible for holding a plurality of a single type of component. These components can be reused thousands of times before shutdown and may even be used by multiple users at the same time. Managers associate a unique identity or name with each component for easy retrieval.

For the purposes of the present invention, the term “member” is a synonym for attribute.

For the purposes of the present invention, the term “metadata” refers to data that describes other data.

For the purposes of the present invention, the term “meta-implementation layer” refers to a software layer that serves as an indirection between those entities that use an implementation and the implementation itself. The meta-implementation layer allows the actual implementation to be changed or replaced with another implementation without the need for the user of the meta-implementation to be aware of that change. A meta-implementation layer provides a connection between a descriptor and the implementation of that descriptor allowing users of the meta-implementation layer a greater understanding of the implementation and its design (the “why does it work this way”) while simultaneously buffering the user from the implementation specifics (the “how exactly does it work to accomplish that task”). There exists a one-to-one mapping between a descriptor's parts and the parts in the meta-implementation layer for that descriptor.

For the purposes of the present invention, the term “metamodel” refers to a description of a model and is synonymous with the term “model descriptor”. A metamodel may be used to describe any model. Since a metamodel is a model that describes models, a metamodel may be constructed to describe another metamodel. A metamodel for a model may include the structure, operations, and constraints on the use of the model.

For the purposes of the present invention, the term “model view controller” refers to a design pattern used to separate data storage from business logic and display logic. The model is the object that holds the data. The view is the component that displays the data. The controller interprets input from the view to determine what action to take. It is a misconception to believe that the controller contains the business logic. The controller could more accurately be called the “input controller” since object-oriented programming should correctly place related business logic in the model.

For the purposes of the present invention, the term “model” refers to a software definition containing enough detail to be useful to a software application. A model does not need to include every detail of a real object. A model of the present invention may extend only one base model, but may also implement zero to many interfaces.

For the purposes of the present invention, the term “object oriented programming” refers to the customary definition of the term object oriented programming i.e. a type of programming in which programmers define not only the datatype of a data structure, but also the types of operations (functions) that can be applied to the data structure. In this way, the data structure becomes a class that includes both data and functions. In addition, programmers can create relationships between one class and another. For example, classes can inherit characteristics from other classes.

For the purposes of the present invention, the term “object” refers to a software representation that follows the definition given by a model to represent one instance of that class. For example, if a software metamodel describes a blueprint for a “dog”, a class implements that blueprint, and an object instance can be used to hold the information for a specific dog named “Spot” with brown fur owned by “John”. Generally, an object is any item that can be individually selected and manipulated. This can include shapes and pictures that appear on a display screen as well as less tangible software entities. In object-oriented programming, for example, an object is a self-contained entity that consists of both data and procedures to manipulate the data.

For the purposes of the present invention, the term “package” refers to a logical grouping of related models that have different features and functionality. Models in the same package cannot solely by virtual of being in the same package be used interchangeably. Instead models in the same package are models that are likely to be used together while performing some functionality. A package does not eliminate the possibility of models implementing polymorphic behavior; it simply does not endow that characteristic.

For the purposes of the present invention, the term “polymorphism” refers to the ability of a software program to use different implementations that share a common base class or interface.

For the purposes of the present invention, the term “primitive” refers to a basic type that has no base model from which the basic type may of the present invention extend. A primitive is data used in a software program that is not an object and therefore has no class definition. A primitive is a built in part of the language and is usually simple. Primitives include Boolean, character, date, integer, number, rootclassifier, rootinterface, time, and void. Boolean types may only contain “true” or “false”; no other values are possible. Character types may contain a value representing a language character. Date types represent a day in the current calendar. Integer types are whole numbers with no fraction or decimal part. Number types may contain any numeric value. Time types contain an indicator of a particular division within a date such as hours, minutes, and seconds. The void type represents no type at all. Void is used to indicate that no type is legal or that no object is returned (from an operation). The RootClassifier type is used for base models that do not of the present invention extend any other previously defined model. The RootInterface type is used for interfaces of the present invention that do not extend from any previously defined interface.

For the purposes of the present invention, the term “problem domain” refers to a problem or the subject matter of interest and defines what details are included and what details are eliminated during the process of abstraction of a software definition.

For the purposes of the present invention, the term “relationship” refers to a link or connector between models.

For the purposes of the present invention, the term “resource” refers to an available reserve or supply of anything that can be drawn on when needed. Components use available resources to accomplish tasks. Resources are different from components in that they are not classifiers in the component integration engine; rather the component integration engine uses them. Examples include hard drives, network cards, memory, databases and files.

For the purposes of the present invention, the term “service context” refers to a logical grouping of services available for a particular group of users within a virtual host. Service groups share the resources of that virtual host, but each service context holds different services. While all users in a virtual host have access to the shared resources, the services available to make use of those resources is determined by the service context. In this way the “administration” service context might make services available to add new services to service contexts, while the “marketing” service context does not.

For the purposes of the present invention, the term “service” refers to a task on a server performed on behalf of a user. The type of task is determined by the service.

For the purposes of the present invention, the term “software definition” refers to a description of a software program that includes sufficient detail to allow the software to be implemented. Software definitions may take the form of a plurality of textual descriptions, a plurality of diagrams, a plurality of requirements, or a plurality of descriptors. A software definition may include any combination of these of these things. A software definition may capture diagrams and textual descriptions as descriptors and may translate descriptors to text descriptions and diagrams.

For the purposes of the present invention, the term “thread of execution” or “thread” refers to the ability of a computer to appear to be executing multiple programs or parts of a program simultaneously. The computer rapidly switches execution between threads, making it appear that the threads are executing simultaneously. Computers with more than one central processing unit may execute a thread on each central processing unit simultaneously.

For the purposes of the present invention, the term “type” refers to a category such as a base model, an interface, a primitive, etc. Type is synonymous with “classifier”.

For the purposes of the present invention, the term “virtual host” refers to a grouping of services and resources made available for a particular group of users. It serves as a logical separation when certain services and resources should be available to one particular group of users, but not another group.

For the purposes of the present invention, the term “virtual implementation” refers to assemblies of meta-implementations (including other virtual implementations and accessors) that behave as an implementation for a specific descriptor. A virtual implementation fulfills the implementation for a specific descriptor. Rather than creating a “real” implementation layer using source code generators and mapping the meta-implementation to this layer, a set of virtual implementations exist for each descriptor of the present invention. There is a one-to-one relationship between the virtual implementation and the descriptor for the virtual implementation. Therefore, a virtual implementation is directly traceable to the descriptors describing it. For example, a dog metamodel might describe two attributes (owner and fur color) and one operation (bark). A virtual implementation for this metamodel contains a VirtualModelImplementation (dog) assembled from two VirtualAttributeImplementations and a VirtualOperationImplementation and mapped back to the dog metamodel. The first VirtualAttributeImplementation instance holds a string value representing the owner's name and mapped to the owner descriptor in the metamodel. The second VirtualAttributeImplementation instance holds a value of class “color” and map to the fur color descriptor. The bark operation is assembled from a VirtualDataType instance holding the value “bark” and a SystemPrintImplementation to print the word “bark” to the screen. In a similar manner, any software implementation can be created out of a very small set of virtual implementation instances without requiring code compilation. However, since the virtual implementation classes are compiled, these virtual implementations perform only slightly slower than a natively compiled implementation.

For the purposes of the present invention, the term “computer system” refers to any type of computer system that implements software including an individual computer such as a personal computer, mainframe computer, mini-computer, personal data assistant (PDA), etc. In addition computer system refers to any type of network of computers, such as a network of computers in a business, the Internet, computers connected by wired or wireless connections to one or more computers on either a permanent or temporary basis, etc. A computer system also refers to electronic devices that implement one or more functions of a computer such as: a cell phone, a television, a videogame console, a compressed audio or video player such as an MP3 player, a DVD player, a microwave oven, etc. The meta-implementation layer and/or computer integration engine may be stored on an individual computer or be stored on one or more computers of a network of computers

For the purposes of the present invention, the term “user” refers to all users of a meta-implementation layer, a component integration engine, or any other software program. A user may be an end user, a programmer, a system administrator, a software developer, another computer system, etc.

For the purposes of the present invention, the term “visual display device” or “visual display apparatus” includes any type of visual display device or apparatus such as a CRT monitor, LCD screen, LEDs, a projected display, a printer for printing out an image such as a picture and/or text, etc. A visual display device may be a part of another device such as a computer monitor, television, projector, telephone, laptop computer, watch, kitchen appliance, electronic organ, automatic teller machine (ATM) etc.

Description

The present invention provides a meta-implementation layer for accessing metadata is provided, which is not only ubiquitously available for every function and data structure available in a computer system but is also compiled into the program so it is faster than existing metadata methods. Metadata can be defined for any structure, allowing it to describe object-oriented and non-object oriented structures, and includes a definition of the structure, including methods, attributes, constructors, destructors, and events. Metadata is used to convey the description of data that is acceptable, filter values if they are not acceptable, get or set the current values on a specific object or data structure, and invoke execution of an operation.

The present invention provides a method of accessing objects constructors, methods, and attributes through metadata in a compiled form that does not require a specific interface, implementation or naming convention for the implementation. Metadata for an object does not require that the object implements a specific interface, extends a specific parent class, or follow a specific naming convention as is required by other contemporary metadata mechanisms. Metadata for an object does not require the object to implement the metadata mechanics. By removing metadata mechanics from the object, legacy and existing code does not have to be rewritten thereby avoiding the introduction of new errors into the code. Metadata mechanics allow compiled or dynamic access. Dynamic mechanics requiring an object implement a specific interface or naming convention and are in common use. Compiled metadata mechanics may be faster than dynamic mechanics and are not in use elsewhere contemporary to this invention.

The present invention also provides a component integration engine, which is a system and method for integrating objects and data within an object-oriented computing environment using metadata. The component integration engine manages the interactions between two or more objects and between objects and data, simplifying integration and limiting unexpected side effects. The unique combination of centralized managed resources, metadata for configuring objects and data, and a command architecture which uses metadata to describe input, instructions, and output creates a new type of software application hereafter referred to as a component integration engine or a component integration engine. The component integration engine uses the command in conjunction with metadata to combine small, simple commands into assemblies that perform complex processes and software applications. The engine does this by using metadata to setup input data, using metadata to invoke methods in a specific order, and returning the final result. Data and method invocations through metadata provide the component integration engine with the benefit of class indirection, object indirection, function substitution and data substitution.

The present invention also provides a new pattern for displaying and controlling model information is provided, which modifies the traditional “model view controller” pattern using metadata to allow for more flexibility and code reuse.

The component integration engine of the present invention provides a combination of a) centralized managed resources b) metadata for configuring all objects and structured data in the running system, and c) a command architecture which uses metadata to describe input, instructions, and output.

In embodiments of the meta-implementation layer and component integration engine of the present invention, a set of centralized managers is responsible for managing objects that describe common functionality such as access to shared resources (files, databases, email servers, caches), parallel processing (thread pools, user access points), and security (login, authorization, code validation, data validation). These managers are themselves managed by a “ManagerManager”. Any manager or managed component can be interchanged with another managed component that is accepted by the manager. Programs accessing managed resources by identity have no way of knowing what specific object will be retrieved from a manager, only that it will fit the type of the object requested to perform a specific task. This decouples object connections, since objects reference the managers to access other objects rather than referencing these objects directly. This indirection allows model substitution, object substitution, functional substitution and data substitution to occur at run-time. A manager can manage any object that is side effect free.

Objects that are side effect free can be used and shared between many processes concurrently. By retrieving an object by a known identity or by a query, changes in manager configuration allow model substitution, object substitution and functional substitution at run-time.

Objects that are not side effect free can be retrieved from component selectors. A component selector is itself side effect free, so it can be managed. The selector accepts the type of object that is requested, and returns the appropriate object. A factory may use the request to construct a new object each time. A pool may return objects that it holds, and accept the object back into the pool after it is no longer in use by the process. The components available for selection can be configured to allow model substitution, object substitution and functional substitution at run-time. By creating side-effect free strategies, fewer models need to be developed due to small differences in functionality.

In embodiments of the meta-implementation layer and component integration engine of the present invention, a set of persistence engines is responsible for managing objects that describe common data structures (such as customer, address, inventory, images, etc.). These persistence engines are side effect free. Programs accessing data through a persistence engine have no way of knowing what specific object implementation will be retrieved from a manager, only that it will fit the type of object requested to perform a specific task. This decouples object connections, since objects reference the persistence engines or managers to access other objects rather than referencing these objects directly. This indirection allows model substitution, object substitution and data substitution to occur at run-time. Any data for which metadata can be retrieved can be managed by a persistence engine. By using persistence engines for data, fewer models need to be developed due to small differences in data structure.

The present invention also provides a method for configuring and accessing any object or structured data in the running computer environment using metadata. Objects for retrieving metadata, called “customizers”, are managed by the customizer manager. An appropriate customizer can be configured for every structure (object or data format) in the system. For any object for which a customizer has not been setup, the system defaults to a customizer that uses dynamic discovery techniques to retrieve metadata. The ubiquitous metadata allows programs to always externalize configuration, input data, and instructions, allowing programs to be extremely flexible and manageable.

A command architecture of the present invention uses one or more commands which perform small tasks working together to perform more complex tasks. Metadata exists to describe input, instructions, and output. The metadata allows any metadata-aware component to use any command without requiring it to understand different interfaces for each subject area. In this way any commands can be combined together without requiring code to match different interfaces for each new subject area. Any information necessary for using a command is described by the command's metadata, and understanding of the subject area is left to the programmer or computer program that assembles the commands into a program. This singular way of dealing with all commands eliminates the proliferation of component integration code.

The component integration engine of the present invention may use centralized managed resources. Managed objects may be used without side effects to the managed resources or to independent processes. Mechanisms exist which can be used to protect the shared resources from alteration after registration in the manager. Additionally, shared resources are not allowed to change themselves or any other shared resource except locally within the process using the shared resource. Many processes can use a single shared resource and anything occurring within one process will have absolutely no affect on any other process.

The centralized managers are themselves managed by a single manager, the “ManagerManager”, which all other components can access in order to list any manager and any managed component. Managed objects are stored by identity (which is not necessarily a string name as is required by naming contexts), which allows components to be found by any component that knows the identity. Managers may also expose a query interface to allow components to be discovered by characteristics of the component, even when an identity is unknown. Managers may restrict the type of component allowed to be registered or may allow dynamic registration of components. The ManagerManager allows dynamic registration of managers, which allows any manager to be replaced by a different type of manager to allow for different performance characteristic in the centralized management of resources. Examples include “local in-memory manager”, “database managed manager”, and “LDAP managed manager.”

Managers available on the network allow many component integration engines to share a common set of managed resources. Component integration engines can share these same managed resources regardless of programming language, operating system, database, file structure or any other technical specification aside from common network access. Metadata for component customization of all objects and structured data in the running system may be understood by humans or computers.

Compiled configuration objects, called “customizers”, are a managed resource. By selecting a different customizer from the customizer manager, different mechanisms can be employed to configure the same type of object. This allows for dynamically changing the configuration mechanism, but offers the speed of unchangeable, compiled code. In other words, since the metadata and customizers are part of the system, they are also customizable. A configuration is not limited to attributes; configuration of an object may involve calling specific constructors, setting attributes, invoking methods and registering to receive specific events. Data used in the configuration process is always external to the source code, never compiled into the code. This allows administrators to change the functionality of any component at run-time or replace a specific component with a different component at run-time, completely changing a system's performance characteristics. A developer can add or change components in a running system to implement new functionality or change existing functionality without recompiling or even stopping the running system.

Metadata is not limited to the object-oriented structure but can be applied to any structured data. Object metadata is a specific implementation related to accessing object-oriented data structures composed of constructors, data, and methods. Object metadata is specific implementation of metadata as applied to objects.

Metadata-aware objects can access hierarchical data or relational data through the metadata as if it were an object. Recognizing the larger pattern of metadata describing any structured data significantly expands the power of a component integration engine by allowing transparent access to non-object structured data as if it were an object.

Since metadata does not require objects or data to implement a specific interface or naming convention, any existing or new technology or data format can be integrated with metadata aware components once the metadata has been developed for the new structure. This means the development of a new type of component instantly makes the new functionality and data in a component available for use by any new or existing systems.

The component integration engine of the present invention may use command architecture that uses metadata to describe input, instructions, and output. Instructions are used to set parameters used by a command to determine how to perform the command. For example a command may take the name of an email transport protocol to determine how to communicate with an email server. Instructions can be described by metadata. Metadata can describe attribute names and value constraints, necessary method invocations, necessary constructors, and events that are generated during execution. A command provides metadata to describe the structure and type of the data it accepts as input. Metadata can describe attribute names and value constraints, available method invocations, available constructors, and events that are generated during execution of methods on the input data. A command provides metadata to describe the structure and type of data it produces as output. Metadata can describe attribute names and value constraints, available method invocations, available constructors, and events that are generated during execution of methods on the output data.

Commands may be combined to perform complex actions and create component integration. This integration of managed components, unmanaged components, structured data, and unstructured data through the “command architecture” can be used to produce applications without programming new code. Existing components provide access to resources, existing commands provide the functionality necessary, and metadata structures them together to produce the desired process.

If a data structure does not exist which is found necessary to perform a new process, the data structure may be created as a dynamic data structure, such as XML, or it may be compiled from source code into an object which is then made available to the run-time environment. In the present invention, a mechanism also exists to create a data structure using virtual implementations to create the structure and related operations.

If a function does not exist which is found necessary to create a new process, the function may be created dynamically by combining existing functions, or it may be compiled from source code into a new command which is then made available to the run-time environment.

In the present invention, a mechanism exists to request the performance of a command or a combination of commands. The request may be received from a variety of sources including but not limited to a network connection, a web page submission, or a GUI client.

A metadata-based XML marshalling/un-marshalling system allows the component integration engine to convert any object to XML by retrieving all of its attributes via its metadata, then writing the type of object and the name and value of each attribute as XML. This allows a component integration engine to automatically convert any object to and from an XML metadata format. The component integration engine can also use XSLT templates to convert from unknown XML formats to the expected metadata formats in order to allow it to construct appropriate objects for any XML request. XSLT commands exist in the command architecture. The component integration engine can use structured metadata customizers to access XML in structured formats other than the standard metadata format to convert XML to objects and objects to XML.

In some embodiments, the meta-implementation layer and component integration engine may include a Hierarchical Model View Controller that uses events based on metadata (an HMVC pattern). The model-view-controller pattern has been redesigned to use a “model”—“model controller”—“view controller”—“view” pattern, each part of which is allowed to be a hierarchy of objects. Communications occur only between adjacent parts. Communications between the model controller and view controller only occur at the top-most level of the hierarchy, instead of the traditional MVC or HMVC patterns which allow communication between any parts in the system and at any level. Adding this restriction between the model and view controllers allows greater distribution to occur by inserting a “forward” between them (leading to the pattern of “model”—“model controller”—“server-side forward”—“client-side forward”—“view controller”—“view”). Events define the values they carry using a definition. Upon initial registration of an event listener, the metadata definitions are passed to the listener followed by the current values. This innovation allows listeners to more correctly respond to events by adjusting to differences in the metadata, or use the metadata to more fully constrain values.

Metadata used in the meta-implementation layer and component integration engine of the present invention does not require that the object implement a specific interface, extend a specific parent model, or follow a specific naming convention as is required by other contemporary metadata mechanisms. Instead metadata is compiled into a customizer class that recognizes the metadata for a specific type of object. Compiled metadata is faster than dynamic metadata and can be applied to any object rather than objects that derive from a common class, implement a specific interface, or use a standard naming convention. The objects being described do not need to be designed or implemented differently in order to be described by metadata.

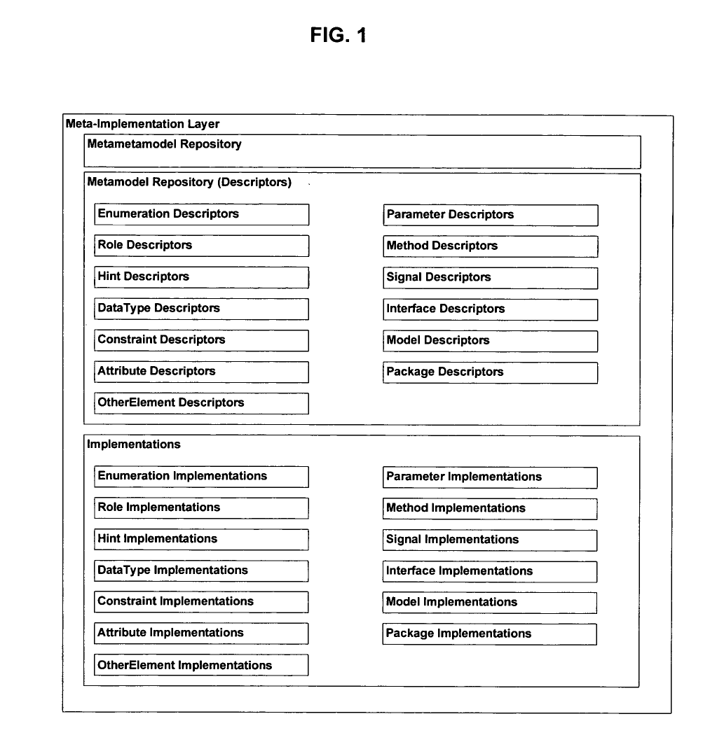

FIG. 1 illustrates a meta-implementation layer of the present invention that includes a metametamodel repository, a metamodel repository and implementations. The metamodel repository includes enumeration descriptors, role descriptors, hint descriptors, datatype descriptors, constraint descriptors, attribute descriptors, other element descriptors, parameter descriptors, method descriptors, signal descriptors, interface descriptors, model descriptors, and package descriptors. The implementations include includes enumeration implementations, role descriptors, hint implementations, datatype implementations, constraint implementations, attribute implementations, other element implementations, parameter implementations, method implementations, signal implementations, interface implementations, model implementations, and package implementations.

The functioning of the various descriptors and implementations of the meta-implementation layer of FIG. 1 are described in more detail below. Also, it should be understood that not all meta-implementation layers of the present invention include all of the types of descriptors and implementations of the meta-implementation layer shown in FIG. 1

An enumeration descriptor describes a set of named constants. Enumeration descriptors assign a string value to the name that is used in the implementation to retrieve the value for that name. The enumeration descriptor associates this name with a configuration descriptor that holds the attribute values necessary to create an instance of that value. Enumeration descriptors are a datatype used by attribute descriptors and parameter descriptors when the values expected fall into a limited set of known constants.

“Other element descriptors” or “future element descriptors” may be added to the metamodel to represent new computing technology concepts not already captured in other elements in the meta-implementation layer. These future elements are first be defined in the meta-metarepository to define their structure and use. After being defined in the meta-metamodel repository, instances of these descriptors can be added to the metamodel repository.

An enumeration implementation is a set of constant named values. The enumeration holds the name value pairs and can retrieve the value for a given name and can retrieve the name for a value. The names and values are constant and cannot be changed once added to the enumeration.

Other element implementations or “future element implementations” are defined for each “other element descriptor”. These future implementation types will define the features and functionality necessary for a future technology or future computer concept to be added to the meta-implementation layer. The element implementation will provide a mechanism to create instances of itself (as is required of all implementations) as well as a mechanism to use the implementation or instances for the purpose the element implementation fulfills.

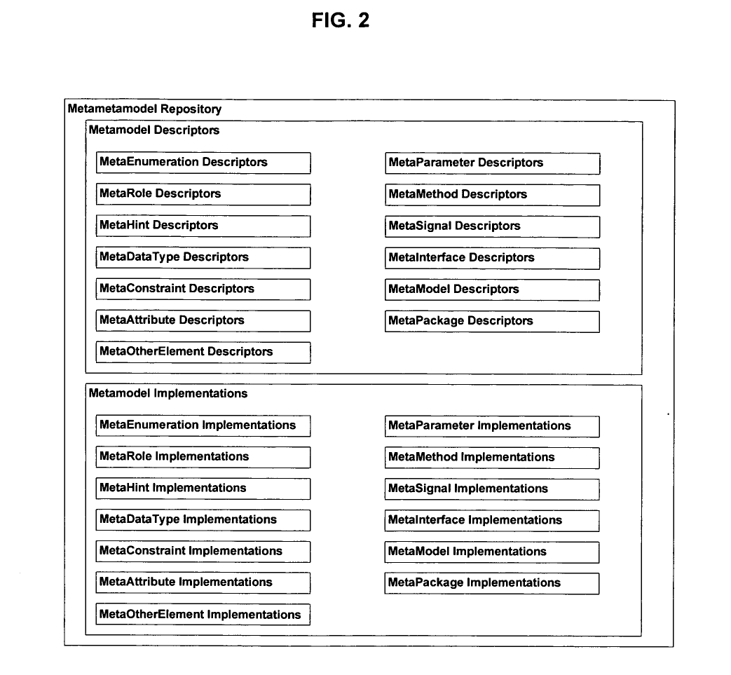

FIG. 2 illustrates metametamodel repository of FIG. 1 in greater detail. The metametamodel repository includes metamodel descriptors and metamodel implementations (metamodel descriptors describe model descriptors and metamodel implementations describe model implementations). The Meta-metamodel repository includes metaenumeration descriptors, metarole descriptors, metahint descriptors, metadatatype descriptors, metaconstraint descriptors, metaattribute descriptors, other meta-element descriptors, metaparameter descriptors, metamethod descriptors, metasignal descriptors, metainterface descriptors, metamodel descriptors, and metapackage descriptors. Implementations include includes metaenumeration implementations, metarole descriptors, metahint implementations, metadatatype implementations, metaconstraint implementations, metaattribute implementations, other meta-element implementations, metaparameter implementations, metamethod implementations, metasignal implementations, metainterface implementations, metamodel implementations, and metapackage implementations.

Each of the types of metamodel descriptors of the metametamodel repository of FIG. 2 is associated with a similarly name descriptor in the metamodel repository. For example, the metaenumeration descriptors of the metamodel descriptors are associated with the enumeration descriptors of the metamodel repository. Similarly each of the types of metamodel implementation is associated with similarly named implementations. For example, the metaenumeration implementations are associated with the enumeration implementations. Also, it should be understood that not all metametamodel repositories of the present invention include all of the types of metamodel descriptors and metamodel implementations of the metamodel repository shown in FIG. 2.

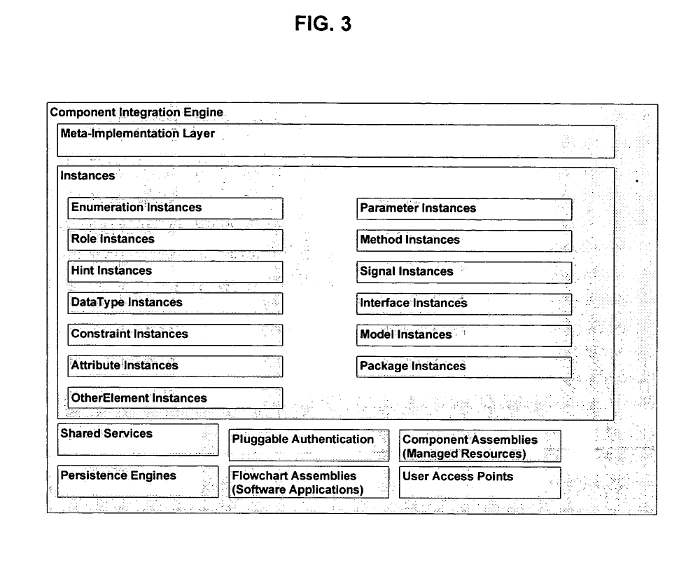

FIG. 3 illustrates a component integration engine of the present invention that includes the meta-implementations layer of FIG. 1 and instances. The instances include enumeration instances, role instances, hint instances, datatype instances, constraint instances, attribute instances, other element instances, parameter instances, method instances, signal instances, interface instances, model instances, and package instances. The component integration engine also includes shared services, pluggable authentication, component assemblies, persistence engines, flow chart assemblies and user access points.

Shared services are a set of operations used in software applications that are available as part of the component integration engine. These services may provide access to platform specific functionality (like hardware access, network listening, file storage, etc.), performance sensitive functionality (like real-time scheduling, mathematical computations, etc.) or very common functionality (like database access, email access, formatting, message queuing, object caching, etc.). A shared service must implement the service interface that specifies how to start, stop, and pause the service. Otherwise, shared services are integrated into the component integration engine exactly like any other component; they are described by descriptors and accessible through the meta-implementation layer. The only shared service required in a component integration engine is a service to facilitate the control of the component integration engine itself. This service provides the support for configuring the component integration engine and starting, stopping, or pausing the component integration engine.

The pluggable authentication layer provides a standardized interface for authenticating users of the component integration engine and assigning the appropriate credentials to those users. Authentication is the process of verifying a user is who the user claims to be. Authorization is the process of granting permission to a user. Authorization credentials are generally assigned during the authentication process and are generally checked by access constraints. Credentials may be created and assigned through other means and authorization may be enforced by other mechanisms. The pluggable authentication layer allows different authentication components to be “plugged-in” or switched around to provide the best component for performing the authentication.

Component assemblies are groups of components with defined relationships used together to perform a specific task. A component assembly is similar to a model instance. Both component assemblies and model instances have a set of data instances (models call these attributes, component assemblies call these members). Both component assemblies and model instances have a set of operations that can be performed upon them (models call these methods, component assemblies call these operations). The difference between a component assembly and a model is duration. The component assembly is generally used for a shorter period of time to perform its specific task and then disassembled. If a component assembly is used for a longer period of time, it should be formally examined and a model implementation created.

Persistence engines provide a mechanism for storing attribute data and state information for components to a storage device like a hard drive or database. The data from the storage device can then be used to recreate the components at a later time. The storage device “persists” the data. A persistence engine is a software component that accepts a software component or piece of data and stores that data to the storage device. The persistence engine also knows how to retrieve that data from the storage device. Advanced persistence engines may support queries to retrieve specific components or sets of components from the storage device and may also support different transaction levels to ensure proper synchronization across multiple users accessing data simultaneously.

Although the component integration engine depicted in FIG. 3 includes component assemblies, persistence engines, and flow chart assembles, depending on the application, a component engine of the present invention may not include component assemblies, persistence engines and flow chart assemblies. Also, it should be understood that not all component integration engines of the present invention include all of the types of instances of the component integration engine shown in FIG. 3

An enumeration instance is a datatype instance holding a single value selected from the choices listed in the enumeration.

Other element instances or “future element instances” may be created by other element implementations described by other element descriptors. Instances of these future elements will represent a specific item following the implementation described by the element's implementation. That implementation will be described by a descriptor for the future element type. These other element instances will operate in a manner appropriate to the new technology paradigm or technology that required the definition of a new element type.

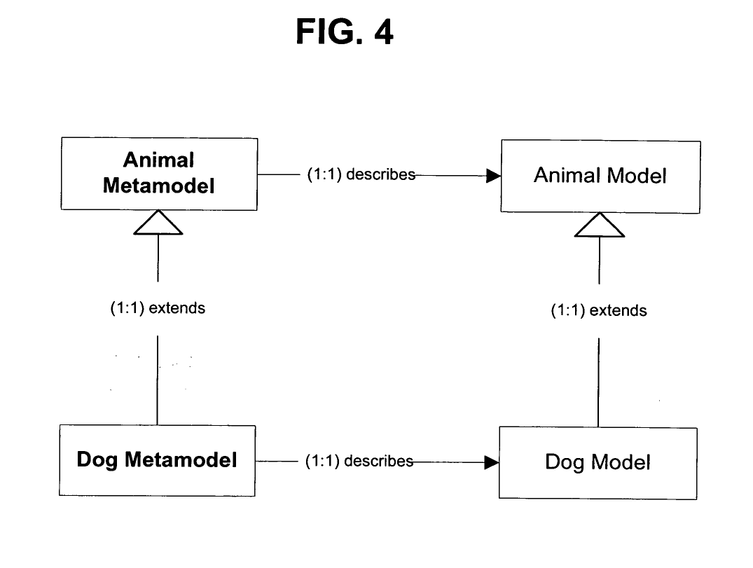

FIG. 4 illustrates that metamodels of the present invention extend extend other metamodels of the present invention, and metamodels describe models. Models of the present invention may also extend other models described by the model's parent metamodel. A dog metamodel of the present invention extends an animal metamodel, and a dog model of the present invention extends an animal model.

In FIG. 4 the base model attribute of the Dog metamodel is a pointer to the Animal metamodel. It is very important to note the metamodel does not contain an implementation of the model like a class does in object-oriented programming. A metamodel clearly and exactly describes a model, but the details of implementing the model are not included.

A complete metamodeling tool contains the ability to accurately detail relationships between models. A relationship is a link or connector between models. A relationship is described as occurring between two models in the same way that a model describes the item it represents. In the same way that an instance of a model represents one occurrence of that model, an instance of a relationship represents one occurrence of the relationship. An instance of a relationship occurs between two or more instances of models. Some type of relationships used in the present invention: association (“has-a”, “uses”, “knows about”), aggregation (“has-a”, “part-of”), generalization/specialization (“is-a”, “extends from”), and interaction (“communicates-with”).

An association is a relationship of one model that is aware of another independent model. This type of relationship is frequently defined through the use of attribute descriptors. A model instance holding an attribute is “aware-of” the instance value assigned to that attribute. If an instance of a model holds an instance of another independent model in an attribute, then the relationship is an instance of an association relationship. When two models have an association that is not captured by either model, an association relationship may still be created. In order to capture the relationship, a model is created to represent that relationship. This model is an association model containing one attribute for each model participating in the association relationship. Static attributes create these association relationships for all instances of the model. Instance attributes create association relationships for a single instance of the model.

An aggregation is a relationship between a model and one if its parts. This type of relationship is frequently defined through the use of attribute descriptors. A model instance holding an attribute “has-a” value assigned to that attribute. An aggregation differs from an association in that the part is not independent.

A generalization/specialization relationship exists when a model extends a base model.

An interaction relationship is a type of relationship that can be described as “communicates with”, “calls upon”, or “makes use of”. Operation descriptors serve to describe interaction relationships. An instance of the model holding the operation interacts with instances of those models passed as parameters. Interaction relationships may also be established by an attribute holding a value later used by an operation. In this case, the distinction between an association relationship and an interaction relationship becomes blurred.

Interaction relationships may also be modeled by creating a process entity model. A process entity model does not represent a real-world object, but instead represents the execution of a process or the occurrence of an event. The process entity contains an attribute to hold each of the items associated by the process. Student enrollment, banking deposits, product orders, and line items are examples of process entities. In the figures described below, interaction relationships are shown by a line between the two entities. The cardinality, or number of occurrences allowed, is shown on each end of this line. To distinguish between an interaction and other relationships, the interaction line has an arrow from the model initiating the interaction to the other model.

An example of the interaction relationship is a bank deposit or withdrawal where a customer makes use of an automated teller machine (ATM). The customer exists independently of the ATM but is not constantly aware of the ATM (as in a association relationship). The customer is neither composed of the ATM (as in an aggregation) nor a specific version of the ATM (as in a specialization). The customer briefly associates with the ATM to perform a specific task, the deposit. An instance of the interaction relationship begins at the beginning of the operation and ends at the end of the operation. Process entities can be useful to record the occurrence of this relationship. In this case, a bank transaction model might contain attributes for the customer identity, the ATM identity, the date, and the dollar amount deposited. An instance of the bank transaction holds an instance of the customer, and instance of the ATM, a date value, and a dollar amount value. This data can then be stored in a database to correctly update the customer's balance.

Metamodels, feature descriptors, and other descriptors are descriptions that represent interfaces to be implemented in a metamodeling tool. Metamodels describe how a model should be implemented. Metamodels are a type of descriptor. Metamodels are comprised of descriptions of smaller parts. These smaller parts are also described using descriptors. Not everything that can be described is a model or part of a model. Descriptors can be used to describe these items too.

A descriptor defines an implementation. The descriptor contains descriptions of the features and functionality allowed and required in an implementation. The descriptors of the present invention are interfaces that must be implemented to participate in the modeling tool. Different modeling tools may implement the same descriptor interface differently. Different modeling tools may create different implementations based on the descriptors.

A class is an implementation specific to object-oriented programming. All classes are implementations.

In one embodiment, the present invention provides a type of meta-implementation called an accessor. An accessor is a meta-implementation containing the descriptor and behaving as an implementation by delegating to a real implementation. No metamodeling equivalent exists for an accessor. A virtual implementation is a meta-implementation containing the descriptor and behaving as an implementation by assembling other implementations to create a larger or more complex implementation. The most basic virtual implementations correspond to the most basic parts of a typical programming language: variables, loops, flow control, and method calls.

Each descriptor has a name and may have relationships with the following elements as well: a display name, a description, hint instances and role instances. A descriptor has a one-to-one association relationship with a name that provides a name for the mode. Any tool using the model uses this name. The name may be a string or a more complex object. A descriptor has zero or one association relationship with a display name that provides a name to display to a user. The display name may be presented to human users as a more attractive alternative to the name. A descriptor has a zero to one association relationship with a description that provides details about the model for its correct use. A description may be useful for human users and automated documentation. A descriptor has a zero-to-many association relationship with hint instances that are name-value pairings, which add details to the metamodel that cannot adequately be captured anywhere else. A descriptor has a zero-to-many association relationship with role instances that are each a group of related hints found to be commonly occurring.

A metamodel describes a model, but does not implement that model or know how to access the various features of a specific model implementation. Each descriptor also has no signals. No additional events are added by the failure descriptor.

A failure descriptor of the present invention is a descriptor and holds the identity of the descriptor that is the type of error thrown from an operation when an error occurs. Failure Descriptors describe the errors that may occur when an operation is attempted. Failure descriptors do not model the failure; a metamodel describes the failure. A failure descriptor has no operations. In a failure descriptor, a descriptor change event is fired whenever an attribute value is added, changed or removed from the failure descriptor.

A constraint descriptor of the present invention is a feature descriptor representing a check that results in a true or false condition. If the condition is true, an activity can continue. If false, a failure is thrown to stop the current operation from occurring. A wide variety of constraints can exist including maximum and minimum number of occurrences (occurrence constraint), maximum and minimum values for an attribute (value constraint), possession of security credentials (access constraint), and many more. The constraint descriptor does not attempt to enforce a constraint, only to describe it. The name of the constraint may describe what the constraint enforces. The name of each data instance indicates the purpose of the value as it applies to a particular constraint implementation. The values of each data instance configure the conditions of the constraint instance.

It is important to note that constraint descriptors are mapped to a “constraint implementation” holding the model implementation that actually implements that constraint. The constraint description needs to be captured and is mapped to a constraint implementation for consistency, but the implementation of a constraint is a model just like any other model in the system.

A constraint descriptor has a one-to-one association relationship with a configuration that provides the values for each attribute in the model descriptor necessary to setup the constraint. A constraint descriptor describes a constraint, but does not implement that constraint. Also, no additional events are added by the constraint descriptor.

A feature descriptor of the present invention is a descriptor held by another descriptor. Many of the descriptors described below, such as attributes and methods are feature descriptors. Every feature descriptor has several common characteristics. A feature descriptor has a one-to-one association or aggregation relationship with a parent, the object holding the feature descriptor. A feature descriptor also has a zero-to-many association relationship with access constraint instances that are restrictions to prevent access to the feature implementation unless the user holds certain credentials. A feature descriptor describes an abstraction of various other types useful for describing “features” of a model. It does not perform any operations. Also, no additional events are added by a feature descriptor.

A datatype descriptor of the present invention is a descriptor describing an item of data. A data descriptor may have relationships with the following elements: an initial value, occurrence constraint descriptors, value constraint descriptors, and access constraint descriptors, and occurrence constraint descriptors.

A datatype descriptor describes the type of value(s) allowed to be assigned to a data holder such as an attribute instance or parameter instance. A data descriptor has a zero or one association relationship with an initial value that is a configuration containing the values for each attribute in a model descriptor of the type specified in the datatype descriptor. Any implementation of the datatype descriptor may be used to create an instance of the initial value model. That instance is configured using these values to create the initial value. A datatype descriptor has a zero-to-many aggregation relationship with occurrence constraint descriptors that are descriptions of restrictions to determine how many values can be assigned to the data placeholder implementation. In addition, a datatype descriptor has a zero-to-many aggregation relationship with value constraint descriptors that are descriptions of restrictions to restrict the allowed values held by a placeholder implementation. A datatype descriptor also has a zero-to-many association relationship with access constraint descriptors that describe restrictions to prevent access to the feature implementation unless the user holds certain credentials.

A datatype descriptor describes a datatype, but does not implement that datatype, hold the data value, or know how to access or change that value. No additional events are added by the datatype descriptor.

A configuration contains the name of an implementation (model implementation or primitive) and the data instances necessary to set each attribute for that implementation. A configuration is used to construct a new instance of that implementation and “configure” it. The use of a configuration allows implementations to be referenced by name rather than requiring instances of implementations in the modeling tool. A configuration has a one-to-one association relationship with the implementation name that is the name of the implementation of the object this configuration can configure. A configuration has a zero-to-many association relationship with data instances that are the name and value to use to setup or configure an instance. These data instances may be any appropriate classifier instance including a datatype instance or model instance. A configuration describes the instance it configures, but does not implement that instance. A data event is fired whenever a value is accessed, a change is attempted, or a change is applied. A data event is also fired when the implementation name is changed.

An attribute descriptor of the present invention is a feature descriptor and aggregates a datatype descriptor. Attribute descriptors describe data held by the model. This data may be a primitive data value or a composite data value like an instance of a model. Attribute descriptors also indicate the proper relationship between the attribute and the attribute's owner model. Attribute descriptors have relationships with a datatype descriptor and a relationship type and may have relationships with the following elements: access constraint descriptors, retrieval failure descriptors, storage failure descriptors, prechange signal descriptors and postchange signal descriptors.

An attribute descriptor has a one-to-one aggregation relationship with datatype descriptor that is the type of value(s) allowed to be assigned to the value of an instance of the attribute. An attribute descriptor has a zero-to-many association relationship with access constraint descriptors that are each a description of restrictions to prevent access to the attribute implementation unless the user holds certain credentials. Access constraint descriptors are inherited from the feature descriptor that an attribute descriptor of the present invention extends. An attribute descriptor has a one-to-one association relationship with a relationship type that is the type of relationship between the attribute owner and the attribute value. Generally the relationship types are association relationship, aggregation, and interaction relationships. An attribute descriptor also has a zero-to-many association relationship with retrieval failure descriptors that are the failures that may occur when an attempting to get the attribute. An attribute descriptor also has a zero-to-many association relationship with storage failure descriptors that are the errors that may occur when an attempting to set the value of the attribute. An attribute descriptor also has a zero-to-many association relationship with prechange signal descriptors that define notification events that occur before a change is applied to an attribute. The prechange signal also defines how to register and deregister interest in receiving these events. An attribute descriptor also has a zero-to-many association relationship with postchange signal descriptors that define notification events that occur after an attribute is changed. The postchange signal also defines how to register and deregister interest in receiving these events.

An attribute descriptor describes an attribute, but does not implement that attribute, hold the attribute value, or know how to access or change that value. Also no additional events are added by the attribute descriptor.

An operation descriptor of the present invention is a descriptor describing functionality or actions. Operation descriptors may have relationships with the following elements: parameter descriptors, failure descriptors, suboperation descriptors and access constraint instances.

Operation descriptors have a zero-to-many aggregation relationship with parameter descriptors that provide details about the data that is be passed into the operation in order for the operation to be performed. Some parameters may affect the way an operation behaves and other parameters hold data upon which to operate. Operation descriptors have a zero-to-many association relationship with failure descriptors that are each a description of the errors that may occur when an operation is attempted. Operation descriptors have a zero-to-many association relationship with suboperation descriptors that are each a list of the operations that this operation descriptor goes through in the order this operation would be executed. These suboperation descriptors are similar to “pseudo code” used to write easy to understand versions or source-code in a programming language. Operation descriptors have a zero-to-many association relationship with access constraint descriptors that are restrictions to prevent access to the feature implementation unless the user holds certain credentials.

An operation descriptor describes an operation, but does not implement that operation or know how to invoke that operation. No additional events are added by the operation descriptor.

A parameter descriptor of the present invention is a feature descriptor describing data passed as input or received as output from an operation. A parameter descriptor has a relationship with a datatype descriptor, a reference type, a direction, and may have relationships with the following elements: precondition value constraint descriptors and postcondition value constraint descriptors.

A parameter descriptor has a one-to-one aggregation relationship with a datatype descriptor that is the type of value(s) allowed to be assigned to the parameter. A parameter descriptor has a one-to-one aggregation relationship, with a reference type that is the manner in which the parameter is referenced. Generally, a parameter is accessed by reference or by value. Access by reference points to the real value directly. Access by value is a shallow copy of the real value (allowing the child values to be changed by reference, but not allowing the parameter value to be changed). A parameter descriptor has a one-to-one aggregation relationship with a direction that is one of: In, Out, or InOut. The direction determines the originator of the parameter reference. “In” means an external process passes in the parameter. “Out” means this process must set the parameter before completion. InOut means an external process passes in the parameter and this process is allowed to change the parameter reference before completion. Out and InOut require the Reference Type to be “by reference”. A parameter descriptor has a zero-to-many association relationship, with a precondition value constraint descriptors that are each a description of the restrictions on allowed values held by the parameter implementation. A parameter descriptor has a zero-to-many association relationship with postcondition value constraint descriptors that are each a description of the restrictions placed on the values allowed for each parameter after the execution of the operation.

A parameter descriptor describes a parameter, but does not implement that parameter, hold the parameter value, or know how to access or change that value. No additional events are added by the parameter descriptor.

A method descriptor of the present invention is a feature descriptor and an operation descriptor. A method descriptor is an operation participating in a model. The method descriptor is logically related to the model in which the method descriptor participates. Instance methods must be performed using an instance of the model to which it belongs. Instance methods may access both instance and static attribute values from the model to which it belongs. Static methods do not require an instance of a model and may only access static attributes of the model. A method descriptor has a relationship with a return data descriptor and may have a relationship with the following elements: precondition constraint descriptors, postcondition constraint descriptors, and signal descriptors.

A method descriptor has a one-to-one aggregation relationship with a return data descriptor that is the type of the value(s) allowed to be returned from an execution of the operation. The default type for return type is void. A method descriptor has a zero-to-many association relationship with precondition constraint descriptors that are each description of constraints placed on the system, model or parameters that must be met before the execution of the operation can begin. If precondition constraints are not met, a failure is generated by the constraint and the operation never executes. A method descriptor has a zero-to-many association relationship with postcondition constraint descriptors that are each a description of constraints placed on the system, model or return value that must be met in order for the operation to be considered a successful execution. If these constraints are not met, the condition fires a failure and the operation fails. A method descriptor has a zero-to-many association relationship with signal descriptors that are each a description of events that may be fired during the execution of the operation and the associated methods to register interest in receiving these event notifications.

A method descriptor describes an operation with a set of attributes, but does not implement that method or know how to invoke that method. No additional events are added by the method descriptor.

A signal descriptor of the present invention is a classifier descriptor. Signal descriptors describe event notifications and the mechanism for registering to receive these notifications. A signal descriptor has a relationship with a listener type and registration operation descriptors and may have a relationship with the following elements: registration constraint descriptors, listener access operation descriptors, and deregistration operation descriptors.

A signal descriptor has a one-to-one association relationship with a listener type that is the interface type required by the generator of the events in order to notify the listener when the event occurs. A listener type uses an identity to lookup the interface descriptor for that type. A signal descriptor has a zero-to-many association relationship with registration constraint descriptors that are constraints that further restrict the models that can register to receive event notification. For example, a registration constraint may limit registration to a single listener. A signal descriptor has a one-to-many aggregation relationship with registration operation descriptors that are the operations implemented by the source of events to allow listeners to register interest in receiving events. A signal descriptor has a one-to-many aggregation relationship with deregistration operation descriptors that are the operations implemented by the source of events to allow listeners to remove themselves from receiving events. A signal descriptor has a zero-to-many aggregation relationship with listener access operation descriptors that are the operations available to investigate the listeners registered to receive event notifications.

A signal descriptor describes a signal, but does not implement that signal. No additional events are added by the signal descriptor.

A constructor descriptor of the present invention is an operation descriptor and a feature descriptor. A constructor descriptor describes the available mechanism to create a new instance of a particular classifier. A constructor descriptor inherits attributes from operation descriptor and feature descriptor, but adds no additional attributes. A constructor descriptor describes a constructor with a set of attributes, but does not implement that constructor or know how to invoke that constructor. No additional events are added by the constructor descriptor.

A destructor descriptor of the present invention is an operation descriptor and a feature descriptor. A destructor descriptor describes the manner in which an instance of a particular model is disposed. A destructor descriptor has a zero-to-many association relationship with precondition constraint descriptors that are each a description of constraints placed on the system, model or parameters that must be met before the execution of the operation can begin. If precondition constraints are not met, a failure is generated by the constraint and the destructor never executes. A destructor descriptor describes a destructor with a set of attributes, but does not implement that constructor or know how to invoke that destructor. No additional events are added by the destructor descriptor.

A “metamodel” or a “model descriptor” of the present invention describes a model. A model descriptor of the present invention is a classifier descriptor. A model descriptor has a relationship with a version, a parent metamodel and a destructor descriptor. A model descriptor may have a relationship with the following elements as well: interface descriptors, static attribute implementations, instance attribute descriptors, static operation descriptors, instance operation descriptors, signal descriptors, and construction descriptors.

A model descriptor has a one-to-one aggregation relationship with a version that provides details about the number of modifications that have been made to the model. A model descriptor has a one-to-one association relationship with a parent metamodel that is the parent metamodel from which this metamodel of the present invention extends. If no created parent exists, the parent metamodel is Root Type. A model descriptor has a zero-to-many aggregation relationship with interface descriptors that describe the interfaces implemented by the model. Interfaces allow for polymorphic functionality in the program using the model. A model descriptor has a zero-to-many aggregation relationship with static attribute implementations that only occur once across all instances of a model. The attribute is implemented and instantiated in the model implementation. A model descriptor has a zero-to-many aggregation relationship with instance attribute descriptors that describe data attributes of the model. Attribute descriptors imply the ability to get and set the value of the attribute unless otherwise constrained. Therefore, operations setting and getting the value(s) of an attribute should not be added as operation descriptors. Instance attributes occur once per instance of a model. A model descriptor has a zero-to-many aggregation relationship with static operation descriptors that describe the functionality of the model. Static operations do not require an instance of the model in order to be executed and may only access static attributes of the model. A model descriptor has a zero-to-many aggregation relationship with instance operation descriptors that describe functionality of the model. Instance operations must be performed using an instance of the model and may access both instance and static attribute values. A model descriptor has a zero-to-many association relationship with signal descriptors that describe notifications the model produces and the mechanism for registering to receive these notifications. A model descriptor has a zero-to-many aggregation relationship with constructor descriptors that are the descriptors of constructors used to create instances of model implementations. A model descriptor has a one-to-one aggregation relationship with a destructor descriptor that is a descriptor of the destruction process to dispose of an instance of the implementation of this model.

A metamodel describes a model, but does not implement that model or know how to access the various features of a specific model implementation. No additional events are added by the metamodel.

An interface descriptor of the present invention is a classifier descriptor that describes an interface. An interface descriptor has a relationship with a version and may have a relationship with the following elements: other interface descriptors, static attribute implementations, and instance operation descriptors. An interface descriptor has a one-to-one association relationship with a version that provides details about the number of modifications that have been made to the model. An interface descriptor has a zero-to-many aggregation relationship with interface descriptors that describe the interfaces of the present invention extended by this interface. Interfaces allow for polymorphic functionality in the program using the interface. An interface descriptor has a zero-to-many aggregation relationship with static attribute implementations: All attributes defined in an interface have to be implementations and must be assigned an initial value. This value cannot be changed once set. An interface descriptor has a zero-to-many aggregation relationship with instance operation descriptors that describe functionality the interface understands how to perform. Instance operations must be performed using an instance of a model implementing the interface.

An interface descriptor describes an interface, but does not implement that interface or know how to access the various features of a specific interface implementation. No additional events are added by the interface descriptor.

A package descriptor of the present invention is a descriptor describing the logical grouping of models into packages. A package descriptor may contain zero or more packages and zero or more models that are described by the package descriptor. A package descriptor has a relationship with a name and may have a relationship with a display name, a description, attribute descriptors, access constraint descriptors, hints and roles.

A package descriptor has a one-to-one association relationship with a name attribute that provides a name for the package. Any tool using the package uses this name for the package. A package descriptor has a zero to one association relationship with a display name that provides a name to display to the user. The display name may be presented to human users as a more attractive alternative to the name. A package descriptor has a zero to one association relationship with a description that provides details about the parameter for its correct use. A description is mainly useful for human users and automated documentation. A package descriptor has a zero-to-many aggregation relationship with attribute descriptors. A package generally contains an attribute to hold child package implementations and an attribute to hold model implementations. Additional attributes may be added for attributes such as specification version, specification vendor, and so on. A package descriptor has a zero-to-many association relationship with access constraint descriptors that describe the security constraints placed upon access to a destructor. A package descriptor has a zero-to-many association relationship with hints that are name-value pairings, which add details to the metamodel that cannot adequately be captured anywhere else and that are inherited from feature descriptor. A package descriptor has a zero-to-many association relationship with roles that are each a group of related hints found to be commonly occurring.

A package descriptor describes a package, but does not implement that package. No additional events are added by the package descriptor.

A version descriptor of the present invention is a feature descriptor providing details about the number of modifications that have been made to its parent. Versions include a major release, minor release, build release, and revision release. The first public release is frequently referred to as 1.0.0.0. Very minor fixes increase the revision release. Minor changes that involved changes to several other models increase the build release and reset the revision release to zero. Small but significant changes increase the minor release and reset the build and revision release to zero. Very large changes increase the major release and reset the minor release, build release, and revision release to zero. The values allowed in a version are not always numeric, instead the allowed values are determined by the data descriptors. A version descriptor includes a major release attribute descriptor, a minor release attribute descriptor, a build release attribute descriptor, and a revision release attribute descriptor.

A version descriptor has a one-to-one association relationship with a major release attribute descriptor that provides details on the major release attribute. Generally, the major release is a number and cannot be less than zero. A version descriptor has a one-to-one association relationship with a minor release attribute descriptor that provides details on the minor release attribute. Generally, the minor release is a number and cannot be less than zero. A version descriptor has a one-to-one association relationship with a build release attribute descriptor that provides details on the build release attribute. Generally, the build release is a number and cannot be less than zero. A version descriptor has a one-to-one association relationship with a revision release attribute descriptor that provides details on the revision release attribute. Generally, the revision release is a number and cannot be less than zero.

A version descriptor describes a version, but does not implement that version. No additional events are added by the version descriptor.

A hint descriptor of the present invention is a descriptor that is a group of attributes adding details to a descriptor that are not adequately be captured anywhere else. Hint descriptors describe the implementation of specific hints. A hint can be added to any descriptor. A hint can be used to create a descriptor implementation which has not yet been formally defined, or which is extremely domain specific. Hints can be useful to aid the user's understanding of the model or to store values used in the automatic generation of implementations from the descriptor as described in more detail below. Also notice that since hints are part of the modeling process, no access constraints exist. The modeling tool enforces access constraints.

A hint descriptor has a one-to-many aggregation relationship with attribute descriptors that describe the attributes hint instances hold. A hint descriptor describes a hint, but does not implement that hint. No additional events are added by the hint descriptor.

A role descriptor of the present invention is a descriptor serving as a mechanism for adding many related hints to a metamodel or feature descriptor in a logical grouping. A role descriptor may have a relationship with hint descriptors and role descriptors.

A role descriptor has a zero-to-many aggregation relationship with hint descriptors that provide details about the hints contained by the role. A role descriptor has a zero-to-many aggregation relationship with other role descriptors that allows for the inclusion of all the hints from one or more other roles to participate as hints in this role.

A role descriptor describes a role, but does not implement that role. No additional events are added by the role descriptor.

In case one of the above-described descriptors does not fully meet the needs of the modeler, some implementations of modeling tools can include a meta-metarepository feature. The meta-metarepository contains the descriptors described above displayed as metamodels. The user of the modeling tool can alter these models, or construct a new model to create a new descriptor type. This type becomes part of the ontology of the modeling tool and may be used from that point on as if it were a native modeling descriptor.

By using metamodels to define models, different implementations can be created using different software languages. For example, a customer model may be implemented as a C++, Visual Basic, or a Java class. The current state of the industry relies heavily on hand coding to implement a model from a metamodel. Some pioneering companies use computer aided software engineering (CASE) tools or Unified Modeling Language (UML) tools to generate source code directly from the metamodel. This source code may be a largely complete object-oriented implementation of the model described in the metamodel. The Object Management Group (OMG) has advanced the goals of CASE by introducing a common metadata description language for writing metamodels in XML syntax. This XML Metadata interface (XMI) language allows different modeling and CASE tools to be used together to generate source code. The OMG has also defined a Metadata Object Facility (MOF) that defines a mapping process for object-oriented programming models. This mapping process may be used to translate a metamodel into another metamodel, another view of the same metamodel, or source code.

The present invention provides a new concept not covered by CASE tools, XMI, or the MOF. The new concept is that of a direct access layer between the metamodel and its implementation using a meta-implementation layer. This layer allows general tools that understand metamodels to access and manipulate the implementation of that model. Tools can interact with one or more models to use and integrate these models.

Unlike the MOF, the implementation of a metamodel does not have to be object-oriented. Unlike CASE and Executable UML, the implementation of a metamodel is not the required to be the result of generating source code and compiling the result. The implementation is not the result of a long and complex mapping process to generate this source code as required by MOF. Instead, a platform is selected which contains one implementation for each of the model descriptor types. There is a one-to-one relationship between each model descriptor and each metamodel accessor and the model descriptors and accessors are organized in exactly the same way as the metamodels are organized.

A meta-implementation layer of the present invention may include accessors that access an implementation of an implementation layer or virtual implementations that are the implementation. The accessors may be meta-implementation accessors, language-specific implementation accessors, database specific accessors, and other types of implementation accessors. The meta-implementation layer may be implemented in any language including yet-to-be developed programming languages. The meta-implementation can access any software implementation including yet-to-be developed software implementations. The meta-implementation layer is mapped to a metamodel or other descriptor.

Rather than requiring an object-oriented class, compiled from a source code written in a specific language, the meta-implementation layer allows a meta-implementation provider to implement the functionality in any way to produce functionality desirable to the system. It makes no difference to the meta-implementation layer how the implementation occurs, as long one meta-implementation accessor exists to access the true implementation for each descriptor in the metamodel.

In a C++ meta-implementation of the present invention there may be a language-specific implementation model accessor that access a class. The language-specific implementation model accessor may have a one-to-one association relationship with a metamodel, and a zero-to-many association relationships with attribute accessor, operation accessors, signal accessors, constructor accessors and destructor accessors. The class may have a similar one-to-many association relationships with a class attribute, a class method, class event methods, class constructors, and class destructors. The attribute accessors use the class attribute, the operation accessors use the class method, the signal accessors use the class event methods, the constructor accessors use the class construction, and the destructor accessors use the class destructors.

For example, one meta-implementation provider may write C++ source code for each attribute descriptor, operator, signal, model, and relationship described in the metamodel. Then the meta-implementation provider would generate more C++ source code to create an accessor to each feature on each C++ class.

For example, a rubber ball class with attributes for bouncy_factor and color and an operation named bounce would be generated as a class with a two member variables, BouncyFactor (one-to-one association relationship, Integer) and Color (one-to-one association relationship, String), and one function, public void bounce( ). Three more classes are created as accessors to these features. RubberBallBouncyFactorAccessor would implement AttributeAccessor and provide access to the bouncy factor attribute of the RubberBall class. RubberBallBouncyColorAccessor would implement AttributeAccessor and provide access to the color attribute of the RubberBall class. RubberBallBounceAction would implement OperationAccessor and execute the bounce function of the RubberBall class. A RubberBallConstructorAccessor would exist to create new instances of RubberBall. The true instances would be wrapped in a RubberBallInstance in order to preserve the connection to the accessor which created it.

A different meta-implementation provider may generate database tables and store each instance of a metamodel as a record in that table. A database implementation model accessor accesses rows in a database table. Each database implementation model accessor has a zero-to-many association relationship with a metamodel. The database implementation model accessor aggregates attribute accessors, operation accessors, signal accessors, constructor accessors, and destructor accessors which are associated with the metamodel's attribute descriptors, operation descriptors, signal descriptors, constructor descriptors, and destructor descriptors respectively. Each database model accessor instance is a row in a database table. The attribute accessors use the table column, the operation accessors use the stored procedure, the signal accessors use the database triggers or message queues, the constructor accessors use a stored procedure or insert statement, and the destructor accessors use a stored procedure or delete statement.

To continue the example, the aggregation relationship attributes of a metamodel are stored as columns in the table. Association relationship attributes are stored as foreign key references to records in tables for the associated metamodel. Operations are implemented as stored procedures and interaction relationships would be stored as process entity models in cross-reference tables. A generalized attribute accessor exists which would perform an SQL update statement whenever an attribute accessor requires a change. The attribute accessor performs an SQL select to retrieve the value for the attribute. The meta-implementation vendor may also implement various caching and optimization techniques to reduce unnecessary database access calls.

A third type of meta-implementation simply acts as a wrapper around a meta-implementation. Due to the limited number of meta-implementation interfaces, it is possible to simply create one wrapper meta-implementation for each interface to add new functionality to all interfaces. Adding new functionality to all aspects of a program is sometimes referred to as aspect programming. New aspects (such as logging all attribute value changes) can be added to a system dynamically at runtime.

For example, to create a log entry every time an attribute value is changed, a wrapper may be created for the attribute accessor interface that first writes the log entry then calls the normal attribute access method on the true meta-implementation. All implementations of attribute accessor can be wrapped with this attribute accessor wrapper to add this type of functionality.

Other meta-implementation providers may use LDAP storage, random access files, procedural languages, structured languages, a virtual implementation, or in some yet-to-be developed technology. Meta-implementation providers may use a plain object-oriented implementation, a CORBA implementation, or an Enterprise Java Beans (EJB) implementation approach. The provider may choose to implement the layer using C++ or may opt to use the added facilities made available as part of .NET. A meta-implementation provider may also implement accessors to all of these technologies plus the database and object-oriented technologies described above. By providing accessors to a variety of implementation types, systems will be able to integrate from a variety of sources and distribute the application to take advantage of the particular advantages of each platform.

A meta-implementation layer of the present invention defines one implementation interface for each descriptor interface. As long as each implementation accesses the other implementations through the meta-implementation layer, different implementations can be mixed together even if they are on different platforms, written in different languages, and using different implementation paradigms (like relational database structures versus object-oriented structures versus structured programming).

An accessor of the present invention provides access to an implementation in a way that is consistent with the descriptor of that implementation. There is always a one-to-one mapping between a descriptor and an accessor. There is not necessarily a one-to-one mapping between an accessor and an implementation. The accessors of the present invention are interfaces an accessor must implement to participate in the meta-implementation. Different meta-implementations may implement the same accessor interface differently. Accessors have a one-to-one association relationship with descriptors for which this accessor provides access to an implementation. Accessors have a one-to-many association relationship with implementations that corresponds to the features described in the descriptor. The accessor may use parts of one or several different implementations in order to provide access in a manner consistent with the descriptor. An accessor has a one-to-one association relationship with a name that is the name of the accessor. An accessor has a zero-to-one association relationship with a description that provides details about the hint for the correct use of this accessor and details about the implementation. A description is useful for human users and automated documentation. This description is different from the description on the metamodel object. That description provides details about how the model is designed and why; this description provides details on use of the implementation (as used through the accessor). An accessor may produce signals related to events occurring in the accessor implementation. Listeners interested in receiving these signals may use registerImplementationListener(listener) to register interest. Listeners no longer wishing to receive these signals may use deregisterImplementationListener(listener) to stop receiving signals.

An accessor of the present invention provides access to an implementation. Use of the implementation depends of the submodel of accessor. A meta-implementation change event is fired whenever an attribute value is added, changed or removed from the accessor.

A failure descriptor in the metamodel layer describes the failures an operation throws, not the failure itself. The failure is modeled using a metamodel. To access a failure, use the metamodel accessor for the failure. Otherwise, the tool using the accessor that generates the failure must handle these failures.

Constraints are not accessed via an accessor to an implementation. Instead the implementation provides the constraints or a constraint implementation is added to the accessor making use of the constraint. The accessor imposes the restriction, even if it is not imposed by the true implementation.

A feature accessor of the present invention is an accessor that is part of a larger accessor. A feature accessor has a one-to-one association relationship with a feature descriptor for which this accessor provides access to an implementation. A feature accessor has a one-to-many association relationship with an implementation that corresponds to the features described in the descriptor. A feature accessor may use parts of one or several different implementations in order to provide access in a manner consistent with the descriptor. A feature accessor has a zero-to-one association relationship with a parent accessor that is a reference to the accessor containing the feature accessor. A feature accessor has a zero-to-many association relationship with an access constraint implementation that enforces restrictions related to security access.

A feature accessor provides access to an implementation. Use of the implementation depends of the submodel of feature accessor. A feature accessor adds no additional events.

A datatype accessor of the present invention is an accessor that provides access to data. Attribute Accessor and Parameter Accessor inherit from datatype accessor. A datatype accessor has one-to-one association relationship with a datatype descriptor that is the attribute descriptor for which this accessor provides access to an implementation. A datatype accessor has one-to-one association relationship with a datatype implementation that is the attribute implementation that this accessor uses to perform the actual storage and retrieval of values. A datatype accessor has zero-to-many association relationship with occurrence constraints that are each an implementation of a constraint to restrict the number of values assigned to the attribute implementation. A datatype accessor has zero-to-many association relationship with value constraints that are an implementation of a constraint to restrict the values allowed to be held by an attribute implementation. A datatype accessor has zero-to-many association relationship with access constraints that are each implementation of a constraint to restrict the access to values held by the attribute implementation.

An instance of a datatype accessor has the following may include the following operations a getValue( ) that returns the current value(s) after checking access constraints, a setValue(Instance) that removes any previous value and sets it to the new value after checking all constraints, an addValue(Instance) that adds the instance given to the current values after checking all constraints, a removeValue(Instance) that removes the given instance from the current values after checking to see if the value is being held and checking access and occurrence constraints, and clearValues( ) that remove all values after checking access and occurrence constraints.

A datatype accessor adds no additional events.

An attribute accessor of the present invention is a feature accessor that provides access to an attribute of a model implementation. Unlike an attribute descriptor, an attribute accessor does not aggregate a datatype accessor. The datatype is accessed directly through the attribute implementation, not a datatype accessor. Attribute accessors allow a value to be set and retrieved. If static, the value of the attribute is shared by all instances. Otherwise the value is assigned only to a single instance.

An attribute accessor has a one-to-one association relationship with an attribute descriptor that is the attribute descriptor for which this accessor provides access to an implementation. An attribute accessor has a one-to-one association relationship with an attribute implementation that is the attribute implementation that this accessor uses to perform the actual storage and retrieval of values. An attribute accessor has a zero-to-many association relationship with access signal accessors that each provide the mechanism to register an appropriate instance's interest in receiving notification when the attribute value is accessed. Also provides the mechanism to remove interest in receiving notification for an event. The instance registering interest in receiving event notification must implement the appropriate interface to match the listener type described in the signal descriptor. An attribute accessor has a zero-to-many association relationship with prechange signal accessors that each provide the mechanism to register an appropriate instance's interest in receiving notification when the attribute value about to be changed. Prechange signal accessors also provided the mechanism to remove interest in receiving notification for an event. The instance registering interest in receiving event notification must implement the appropriate interface to match the listener type described in the signal descriptor. An attribute accessor has a zero-to-many association relationship with postchange signal accessors that each provide the mechanism to register an appropriate instance's interest in receiving notification when the attribute value has just changed. The postchange signal accessors also provide the mechanism to remove interest in receiving notification for an event. The instance registering interest in receiving event notification must implement the appropriate interface to match the listener type described in a signal descriptor. An attribute accessor has a zero-to-many association relationship with occurrence constraints that are each an implementation of a constraint to restrict the number of values assigned to the attribute implementation. An attribute accessor has a zero-to-many association relationship with value constraints that are each an implementation of a constraint to restrict the values allowed to be held by an attribute implementation. An attribute accessor has a zero-to-many association relationship with access constraints that are each an implementation of a constraint to restrict access to the attribute implementation unless the user holds certain credentials.

Attribute accessors may include the following operations a getValue( ) operation that returns the current value(s) after checking access constraints, a setValue(Instance) operation that removes any previous value and sets it to the new value after checking all constraints, addValue(Instance) that adds the instance given to the current values after checking all constraints, removeValue(Instance) that removes the given instance from the current values after checking to see if the value is being held and checking access and occurrence constraints, and clearValues( ) that remove all values after checking access and occurrence constraints.

An attribute data event is fired when the value of an attribute implementation is changed to a new value.

An operation accessor of the present invention is an accessor that provides a mechanism to execute the operation. If the operation accessor is static, an instance is not required to perform the execution. Otherwise, an instance of the model containing the operation is needed to perform the operation.

An operation accessor has a one-to-one association relationship with an operation descriptor that is the operation descriptor for which this accessor provides access to an implementation. An operation accessor has a one-to-one association relationship with an operation that is the operation implementation that the operation accessor uses to perform the action. An operation accessor has a zero-to-many association relationship with a parameter implementation that is represented by parameter accessors. Parameter accessors provide augmented constraints above those performed by the operation implementation. An operation accessor has a zero-to-many association relationship with parameter accessors that are used by the operation accessor to impose occurrence, value, and access constraints on the parameter values. An operation accessor has a zero-to-many association relationship with access constraints that are each an implementation of a constraint to restrict access to the operation unless the user holds certain credentials.

An operation accessor may include the following may include the following operations execute(ParameterList) that attempts to perform the operation by executing the operation implementation. First all access and precondition constraints are checked for the operation accessor and parameter accessors. Then the operation is attempted. If the operation implementation is successful, the postcondition constraints are checked for the operation accessor and parameter accessors.

An operation event with the status of the preconditions is fired to all interested parties after execute(ParameterList) method performs all the precondition tests. A second event is sent at the successful completion of the operation. A third event is fired with the status of the postconditions or the operation. A fourth event is fired only if a failure occurs during the execution of the operation.

A parameter accessor of the present invention is a feature accessor that performs constraint checks on the values passed to an operation accessor. These constraints will fire a failure if they are not satisfied, canceling execution.

A parameter accessor has a zero-to-many association relationship with a parameter descriptor that is represented by the parameter accessor. Parameter accessors provide augmented constraints above those performed by the operation implementation. Since most languages do not have a separate construct for parameters, parameters refer to the value assigned to their position in the operation parameter list. A parameter accessor has a zero-to-many association relationship with precondition constraints that are each an implementation of a constraint to restrict the values allowed to be held by the parameter before execution of the operation. A precondition constraint may also enforce a constraint, like a no modification constraint, by adding a wrapper around the parameter value. A parameter accessor has a zero-to-many association relationship with postcondition constraints that are each an implementation of a constraint to restrict the values allowed to be held by the parameter after execution of the operation. A post condition constraint can also remove wrappers added by precondition constraints as necessary. A parameter accessor has a zero-to-many association relationship with occurrence constraints that are each an implementation of a constraint to restrict the number of values assigned to the parameter.

A parameter accessor of the present invention may include the following operations: a precheck(instance) that perform the precondition constraint checks and the access constraint checks against a given instance, and a postcheck(instance) that performs the postcondition constraint checks against a given instance.

A parameter event is fired with the results of the precondition check. A second parameter event is fired with the results of the postcondition check (if the operation is successful enough to reach the post condition check).

A method accessor of the present invention is an operation accessor and a feature accessor on a model accessor. A method accessor has one-to-one association relationship with an operation descriptor that is the operation descriptor for which method accessor provides access to an implementation. A method accessor has one-to-one association relationship with a method implementation that is the operation implementation that the method accessor uses to perform the action. A method accessor has zero-to-many association relationship with signal accessors that use the signal implementations they describe to access the appropriate operations in the model implementation to register for event notifications. Signal accessors also provide the mechanism to remove interest in receiving notification for an event. The instance registering interest in receiving event notification must implement the appropriate interface to match the listener type described in the signal descriptor. A method accessor has zero-to-many association relationship with precondition constraints that are each an implementation of a constraint to restrict some environmental condition or state of the model implementation before the execution of the operation. These types of constraints may check for the installation of a security manager, the existence of a database connection, or some other environmental condition. These constraints may also check to see if a model implementation has entered into the correct state to allow the execution of this operation. Constraints related to the parameter values are held by the parameter descriptors. A method accessor has zero-to-many association relationship with postcondition constraints that are each an implementation of constraints to check for certain conditions at the end of the operation. Similar to precondition constraints in checking for environmental and model related assumptions.

A method accessor may include the following operation: execute(ParameterList) that attempts to perform the method by executing the method implementation. First all access and precondition constraints are check for the operation accessor and parameter accessors. Then the operation is attempted. If the operation implementation is successful, the postcondition constraints are checked for the operation accessor and parameter accessors.

A method accessor adds no additional events.

A signal accessor of the present invention is a feature accessor that describes a notification and provides the mechanism to register an appropriate instance's interest in receiving notification when the model generates an event. A signal accessor also provides the mechanism to remove interest in receiving notification for an event. The instance registering interest in receiving event notification must implement the appropriate interface to match the listener type described in the signal descriptor. Note that signal accessors do not require access constraints as the operations accessors impose these constraints. Also note the existence of the listener operation that was contained in the signal descriptor. The implementation places the burden of implementing the listener operations on the listener. The signal accessor can still contain the description of how to perform those operations on a listener, rather than pushing these operation descriptors to a model accessor.

A signal accessor has a one-to-one association relationship with a signal descriptor that is the signal descriptor for which this accessor provides access to an implementation. A signal accessor has a one-to-one association relationship with a signal implementation that is the signal implementation that this accessor uses to perform the action. A signal accessor has a one-to-many aggregation relationship with listener operation accessors that call upon the operation implementation in the listener implementation. A signal accessor has a one-to-many aggregation relationship with registration operation accessors that call upon operation implementations in a signal implementation. These operations are usually operation implementations on the model implementation without a composite “signal” object held by the model. A signal accessor has a one-to-one aggregation relationship with deregistration operation accessors that call upon operation implementations in a signal implementation. These operations are usually operation implementations on the model implementation without a composite “signal” instance held by the signal source model. A signal accessor has a one-to-many aggregation relationship with listener access operation accessors that call upon operation implementations in the signal implementation. These operations are usually operation implementations on the model implementation without a composite “signal” instance held by the listener model. A signal accessor has a zero-to-many aggregation relationship with listener registration operation accessors that call upon the operation held by the signal implementation to perform registration for event notification. A signal accessor has a zero-to-many aggregation relationship with listener deregistration operation accessors that call upon the operation held by the signal implementation to remove an instance from registration for event notification. A signal accessor has a zero-to-many aggregation relationship with listener access operation accessors that call upon the operation held by the signal implementation to list all instances registered for event notification. A signal accessor has a zero-to-many association relationship with registration constraints that are each an implementation of constraints to check for certain conditions of the listener instances being registered. These constraints may also be used to restrict the type and number of listeners.

A signal accessor may include the following operations: register(Instance) that attempts to register the given instance as a listener (Registration constraints are applied to the listener before performing the registration event), deregister(Instance) that attempts to remove the given instances from listening to event notifications, and listListeners( ) that returns an enumeration to the listeners currently listening for events from this signal.

A registration event with the status of the registration constraints is fired to all interested parties after the register(Instance) method performs all the precondition tests. A second event is sent at the successful completion of the registration operation. Events are also fired when deregister(Instance) and listListener( ) methods are called.

A constructor accessor of the present invention is an operation accessor and a feature accessor on a model accessor. Constructor accessors provide a mechanism for creating new instances of the model accessed by the model accessor.

A constructor accessor has a one-to-one association relationship with a constructor descriptor that is the constructor descriptor for which the constructor accessor provides access to an implementation. A constructor accessor has a one-to-one association relationship with a constructor implementation that is the constructor implementation that this accessor uses to perform the actual construction. The parameter accessors represent the parameters in the constructor. Constructor accessors inherit all the attributes from feature accessor and operation accessor, but do not add any additional attributes.

A constructor accessor includes the following operation: newInstance(ParameterList) that is the method call to perform a construction with the given values as parameters. The parameters in the parameter list must match the type and be accepted by the parameter accessors in order for construction to be successful.

A constructor accessor adds no additional events.

A destructor accessor of the present invention is an operation accessor and a feature accessor of a model accessor. Destructor accessors provide a mechanism to destroy an instance of the model being accessed by the model accessor. Depending on the persistence rules associated with a meta-accessor implementation, this may permanently destroy the instance from the persistence store, or it may simply remove the representation of that persisted object from memory. The accessor implementer will document the level of destruction as it applies to persisted data.

A destructor accessor has a one-to-one association relationship with a destructor descriptor that is the destructor descriptor for which this accessor provides access to an implementation. A destructor accessor has a one-to-one association relationship with a destructor implementation that is the destructor implementation that the destructor accessor uses to perform the actual destruction. A destructor accessor has a zero-to-many association relationship with precondition constraints that are each an implementation of a constraint to restrict some environmental condition or state of the model implementation before the execution of the operation. These types of constraints might check for the installation of a security manager, the existence of a database connection, or some other environmental condition. These constraints might also check to see if a model implementation has entered into the correct state to allow the execution of this operation. Constraints related to the parameter values are held by the parameter descriptors.

A destructor accessor includes the following operation: destroy( ) that is the method call to perform a destruction.

A destructor accessor adds no additional events.

A model accessor of the present invention is an accessor that defines the responsibilities for accessing an implementation of a model corresponding to a specific metamodel. For each feature in the metamodel, there must be a feature accessor in the model accessor.

A model accessor has a one-to-one association relationship with a metamodel that the metamodel for which the model accessor provides access to an implementation. There exists a one-to-one relationship for each descriptor in the metamodel to each child accessor in this model accessor. A model accessor has a one-to-one association relationship with a parent model accessor that the parent model accessor is configured to give access to all the features of the parent model. This model accessor delegates to its parent model accessor wherever the model it describes would use features inherited from it parent. A model accessor has a one-to-one association relationship with a version that provides details about the number of modifications that have been made to the model implementation. A model accessor has a one-to-many aggregation relationship with constructor accessors that provide a mechanism for creating new instances of the model described by the model descriptor. There may exist several different constructors, each of which uses a different number and type of arguments. A model accessor has a one-to-one aggregation relationship with a destructor accessor that provides a mechanism to destroy an instance of the model being described. Depending on the persistence rules associated with a meta-accessor implementation, this may permanently destroy the instance from the persistence store, or it may simply remove the representation of that persisted object from memory. The accessor implementer will document the level of destruction related to persisted data. A model accessor has a zero-to-many association aggregation with static attribute accessors that are attribute accessors that do not require an instance of the model in order to be accessed. Static attribute accessors allow the value to be set and retrieved where the attribute is shared among all instances of the model. A model accessor has a zero-to-many aggregation relationship with instance attribute accessors that are attribute accessors that require an instance of the model in order to be accessed. Instance attribute accessors allow the value to be set and retrieved on one specific instance. A model accessor has a zero-to-many aggregation relationship with static operation accessors that do not require an instance of the model in order to be executed. Static operation accessors provide a mechanism to execute the operation. A model accessor has a zero-to-many association relationship with instance operation accessors that are operation accessors that require an instance of the model in order to be executed. Instance operation accessors provide a mechanism to execute the operation. A model accessor has a zero-to-many association relationship with signal accessors that provide the mechanism to register an appropriate instance's interest in receiving notification when the model generates an event. Signal accessors the mechanism to remove interest in receiving notification for an event. The instance registering interest in receiving event notification must implement the appropriate interface to match the listener type described in the signal descriptor.

A model accessor includes the following operation: newInstance(ParameterList) that is used to construct a new instance of the model. This operation delegates to the appropriate constructor accessor to return the appropriate instance.

To register interest in events fired by an instance of a model implementation, interested listeners should register using the signal accessors. To register interest in signals fired by the model accessor, a listener should use registerImplementationListener(listener) inherited from the accessor base model. This type of use applies to all accessors. A model accessor adds no additional events.

An interface accessor of the present invention is an accessor that provides access to implementations of interfaces. While the interface definition provides the details for both static attributes and the required operations to implement an interface, the operations are implemented by model implementations, not interface implementations. Therefore, interface accessors provide access to static attributes from the interface, but require a model instance to perform operations.

An interface accessor has a one-to-one association relationship with an interface descriptor that is the interface descriptor for which the interface accessor provides access to an implementation. There exists a one-to-one relationship for each descriptor in the interface descriptor to each child accessor in this interface accessor. An interface accessor has a one-to-one association relationship with an interface implementation that is the implementation of the interface. An interface accessor has a zero-to-many aggregation relationship with interface accessors that are wholly included as part of itself. An interface accessor has a zero-to-many aggregation relationship with static attribute accessors that are attribute accessors that do not require an instance in order to be accessed. These accessors allow the value to be retrieved but not changed. An interface accessor has a zero-to-many aggregation relationship with operation accessors that require an instance of a model instance implementing this interface in order to be executed. These accessors provide a mechanism to execute the operation.

The accessors contained in an interface accessor provide the operations available. An interface accessor adds no additional events.

A package accessor of the present invention is an accessor that provides access to the various logical groupings of models. The root package accessor may be stored in a well-known location, like the metamodel repository, in order for software applications to be able to find meta-implementation accessors and virtual implementations.

A package accessor has a one-to-one association relationship with a package descriptor that is the package descriptor for which the package accessor provides access to an implementation. A package accessor has a one-to-one association relationship with a package implementation that is the package implementation that the interface accessor uses to perform the action. A package accessor has a zero-to-many association relationship with metamodel implementations that are the metamodel accessors that are children of this package accessor refer to the metamodel implementations that are children of this package accessor's implementation. A package accessor has a zero-to-many association relationship with package implementations that are the package accessors that are children of this package accessor refer to the package implementations that are children of this package accessor's implementation. A package accessor has a zero-to-many association relationship with package accessors that are child package accessors describing child package implementations of this package accessor's package implementation. A package accessor has a zero-to-many association relationship with model accessors (that are child model accessors describing child model implementations of this package accessor's package implementation. A package accessor has a zero-to-many aggregation relationship with attribute accessors that are the accessors to retrieve other attributes of the package.

Package accessors are purely descriptive and provide access to other package and model accessors. A package accessor adds no additional events.

Versions are not accessed. Instead, the version of the accessor is described using a version implementation. This is equivalent to the descriptors in the metamodeling layer holding a version instance describing the version of the descriptor.

No hint accessors exist. Hints exist only in the modeling layer. Hints capture descriptions necessary for implementations that are not captured elsewhere. Once an implementation exists or is accessed via an accessor, there is no longer a need for hints.

No role accessors exist. Roles exist only in the modeling layer. In the meta-implementation layer, interfaces serve a similar position.

In one embodiment, the present invention provides virtual implementations. Where meta-implementation accessors serve to access a real implementation written and compiled in source code, a virtual implementation serves as both the meta-implementation and the “real” implementation. The virtual implementation creates a one-to-one relationship from its assembly of implementations to the descriptors in the meta-implementation layer. Each virtual implementation type works as part of the larger virtual implementation to create assemblies that behave exactly like a real implementation.

Accessors may use the assemblies of virtual implementations in exactly the same way as a real implementation. The virtual implementation assemblies behave exactly like real implementations. The difference is that virtual implementations are constructed (and optionally modifiable) at runtime. No source code is written, no source code is compiled, and no source code needs to be managed. Given a tool which properly constructs a virtual model implementation assembly from a model descriptor (a one-to-one mapping of each feature descriptor to a feature implementation), virtual implementations require no more effort to create than a fully documented UML diagram.

A user (a human or other type of user) may use a virtual implementation as the meta-implementation layer in the same way that it uses accessors. Since the meta-implementation serves as a layer of indirection between the user and the implementation, the user is completely unaware of the differences between an accessor and a virtual implementation.

A virtual implementation of the present invention takes a step toward the goal of a computer being able to modify its own programming. Normally, artificial intelligence is created in a neural network, genetic algorithm, or logic-based program. In every case, the computer is able to apply logic to “reason” out a result or create patterns of input that lead to patterns of output. While each of these programs allows the computer to construct new patterns, genes, or logic, none of these environments allow the computer to understand how to change the surrounding environment.

For example, a neural network can change the connections between nodes and the values assigned to the connections between nodes, but can never change the back-propagation rules that define how those values are determined. A genetic algorithm can create new genes and determine which genes are dominant, but cannot create a neural network. A logic program can combine existing logic to arrive at more powerful logical constructs, but cannot suddenly decide to represent these logical constructs as graphical representations (unless the programmer has already added this capability).

A program that describes itself (meta-implementation layer), describes its reason for existing in that manner (metamodel layer), and allows implementation to change dynamically (virtual implementation) lacks only the logic to do so. If a sufficiently powerful reasoning engine (neural network, genetic algorithm, or logic engine), were applied to such a language on a sufficiently powerful computer, such a program would be capable of rewriting itself to achieve the goals defined in the reasoning engine. A user could define these goals or these goals may be the result of operations conducted by the reasoning engine itself.

Virtual implementations of the present invention also allows for programming by contract functionality. For example, to enforce a contract asserting an operation cannot change any attributes of a parameter, a parameter implementation can create a read-only pass-through model and give that model to the operation. Even if the operation attempts to make a change to the parameter's attributes, it will fail because of the read-only protection. The operation can still perform all the normal read operations, since the read-only pass-through simply delegates read operations to the real parameter model. Not all programming languages have sufficient complexity to enforce contractual constraints like this one. Since a virtual implementation has access to its own description and behaves as an extensible language, it can add new functionality to enforce contract-programming ideas.

A virtual implementation of the present invention also allows for aspect programming. Due to the limited number of virtual implementation interfaces, it is possible to create a wrapper virtual implementation for each interface to add new aspects to all implementations. Adding new functionality to all aspects of a program is sometimes referred to as aspect programming. New aspects (like logging all attribute value changes) can be added systematically at runtime.

The meta-implementation layer of the present invention may blend parts of a virtual implementation with parts of other meta-implementations through the use of accessors. By selecting a virtual implementation for the model, then selecting accessors for database storage and accessors for compiled C++ source code, a meta-implementation can combine the advantages of each type of implementation to achieve the best balance of performance, flexibility, and maintenance.

As long as the appropriate accessors exist, the virtual model implementation can store its attributes in locations other than virtual attribute implementations and can perform operations in ways other than virtual operation implementations. This allows the virtual object to serve as a placeholder in the tool using the virtual implementation, while performing “non-virtual” data manipulation.

An example system might use meta-implementations to store all attributes data in a database. The constructor accessors would require enough information to create a record in a database and retrieve a primary key. The primary and foreign keys for this database record are stored in a virtual instance. All attribute changes to the virtual object are actually updates to the database, using the virtual instance to retrieve the primary key for the where clause. Most operation calls are stored procedure calls implemented as database-operation accessors. Some operation accessors may calls compiled C++ code written as part of a legacy system. These operation implementations perform calculations related to the data stored in the attributes. In order to make this system available over the Internet, a Java Servlet, Python module, or IIS plugin is used to access this meta-implementation layer and produce HTML.

Another approach to blending multiple different languages together is to create virtual implementations that are really references to a meta-implementation accessor. This allows the “true” meta-implementation layer to always point to a virtual implementation. Whenever functionality is needed in from a non-virtual implementation, an accessor implementation is used. This implementation simply delegates its responsibilities to a different meta-implementation provider.

For example, a virtual operation may contain several sub-operations. One of these sub-operations is an AccessorOperationImplementation that passes values to database-specific accessor to call a stored procedure. The OperationImplementation behaves exactly as the virtual operation expects, but performs its logic in the database. This is analogous to embedded SQL in a programming language.

In fact, more languages are being embedded into each other in today's development environment. Generally the embedded language is treated in such a way that the language into which it is embedded is unaware of it. Language integration allows all meta-implementations to interact with each other, fully aware of each other, but unconcerned about the specifics of implementation. Some of the most extreme cases of embedding languages into each other come from Active Server Pages (ASP) and Java Server Pages (JSP).

Both of these template-design languages contain a language that is executed on the server (Java for JSP, Visual Basic for ASP). This code can retrieve data from a database using embedded SQL. The results of that SQL query are translated to XML in order to be formatted by an XML Style sheet Language Template (XSLT). The XSLT produces an HTML document containing Cascading Style Sheets for style, HTML for content and markup, and JavaScript for dynamic content. The resulting ASP (or JSP) page contains all six languages in a single file: VB, SQL, XSLT, HTML, JavaScript, and CSS! While there are certainly better ways of performing this type of operation, it occurs frequently enough to warrant serious attention. Accessor implementations allow the mixing of an unlimited number of languages (and non-language software paradigms), as long as a meta-implementation accessor exists for each one. Each meta-implementation has its language completely separated while being integrated through the meta-implementation accessor interfaces and model descriptors.

The meta-implementation layer defines one implementation interface for each descriptor interface. As long as each implementation accesses the other implementations through the meta-implementation layer, different implementations can be mixed together even if they are on different platforms, written in different languages, and using different implementation paradigms (like relational database structures versus object-oriented structures versus structured programming).

An implementation actually performs functionality and creates new structures for storing and retrieving data. The implementations of the present invention are interfaces that an implementation must implement to participate in the meta-implementation layer. These interfaces are the same interfaces an accessor must implement. A virtual implementation differs from an accessor by being the implementation rather than delegating to an implementation. Different virtual implementations may implement the same implementation interface differently.

An implementation has a one-to-one association relationship with a descriptor that is the description for which a given implementation is an implementation. An implementation has a zero-to-one association relationship with a description that is a description of the implementation and use. An implementation may include the following operation: newInstance(ParameterList) that creates a new instance of this implementation. An implementation change event is fired when the implementation is changed in any way.

Implementations define the rules something must follow to be an instance of that implementation. An instance holds a reference to the rules it follows. An instance cannot change the implementation to which it points. The implementation is set at construction.

An instance has a one-to-one relationship with an implementation that is the implementation defining the instance.

A failure descriptor in the metamodel layer describes the failures an operation throws, not the failure itself. The failure itself is implemented using a model implementation. To access a failure, use the model implementation for the failure.

A constraint implementation of the present invention is an implementation holding a model implementation used to perform a specific restriction. The model must implement the constraint interface to participate as a constraint.

A constraint implementation has a one-to-one association relationship with a model implementation that is the identity of the model used to implement the particular constraint associated with the constraint implementation.

The configuration in a constraint descriptor gives the identity of the model implementation for a given constraint. That identity is used to retrieve the model implementing the constraint from the metamodel repository. No additional relationships are added by the constraint implementation.

A constraint implementation may include the following operations: getModelIdentity( ) that gets the identity of the model this constraint uses as a real implementation, and getModelImplementation( ) that gets the model that implements the constraint. That model will be used for constructing new instances of the constraint. The model must implement I_ConstraintInstance.

A constraint implementation defines no additional signals.

Composite constraints exist to provide AND/OR operations to combine two or more simple constraints into a more complex constraint. Since each constraint is evaluating a Boolean expression, composite constraints simple use logic to combine these expressions.

The AndConstraintImplementation contains one data implementation for the constraints which will be combined together using the AND Boolean operation.

An access constraint implementation of the present invention is a feature implementation and a constraint implementation. Access constraints check the current thread of control to see if it contains an authorized user. If no user has authorized, the constraint may perform a callback requesting the user authenticate. Otherwise the constraint fails, the operation stops, and a failure is thrown. If a user has been authenticated, an access constraint looks to see if the user has the appropriate credentials required to execute the current operation. If the user does not hold these credentials, the operation stops and throws a failure. An access constraint defines a single data implementation holding credential information that will be checked by the access constraint. Some access constraints will create the credentials based on the parent of which the access constraint a feature. Others will have a static set of credentials.

An occurrence constraint implementation of the present invention extends a feature implementation and constraint implementation. Occurrence constraints examine the number of items allowed in a specific location. A MinimumOccurrenceConstraint would require that there exist at least x instances, where x is a value set in the constraint descriptor. A MaximumOccurrenceConstraint would require that no more than x instances exist, where x is a value set in the constraint descriptor. Many other occurrence constraints are possible.

An occurrence constraint implementation is a simple extension of constraint implementation and feature. Below occurrence constraint is a sub-implementation of occurrence constraint that restricts the number of occurrences to between a minimum value and a maximum value. The range constraint defined two data implementations maximum value and minimum value. The range constraint expects two data instances to be set on the constraint instance. The range constraint implementation may further enforce the restriction that the maximum data instance is always greater than or equal to minimum data instance by creating a premutator operation on the minimum value and maximum value data implementations.

A value constraint implementation of the present invention extends feature implementation holding and constraint implementation. Value constraints inspect a data object and compare a value to a set of requirements. Value constraints can limit numbers to certain ranges. For example, a RangeValueConstraint can ensure a percentage parameter is always between 0 and 100. A PasswordConstraint could ensure a password have at least 8 characters with at least one number and one symbol. A value constraint could also ensure a composite value does not contain certain characteristics. A product order containing zero-to-many line items could be checked to have at least one line item in order to enter the sendOrder( ) operation. The range constraint used as an example above for occurrences could also be used to enforce value constraints. The value being checked by the constraint is the occurrence count in the occurrence constraint; the value being checked by the constraint is the value in a value constraint.

A value constraint implementation is a simple extension of constraint implementation. The data implementations vary with the constraint being imposed.

A constraint instance of the present invention is an instance. A constraint instance performs the actual checks based on its configuration. A constraint instance has a one-to-one association relationship with a constraint implementation that is the constraint implementation of which the constraint instance is an instance. A constraint instance has a one-to-one association relationship with a model instance that is the model implementing the constraint. This model must implement the correct constraint interface to be understood by the constraint instance and must follow the description provided by the constraint implementation.

A check of a constraint instance is defined by the submodel of constraint and is implemented by the model. A constraint check event occurs when a constraint is applied to a specific value. The event is fired after the constraint to notify of the success or failure of the constraint check.

An access constraint instance of the present invention extends constraint instance and feature instance. The constraint has a pointer to its parent and may use its parent information to perform the security check. For example, does the user have permission to use an object named ‘marketing database’.

An access constraint instance of the present invention has a one-to-one association relationship with an access constraint implementation that is the access constraint implementation of which the access constraint instance is an instance.

Constraints may have attributes defined by the metamodel and implemented by the model implementation. Constraint instances, including access constraint instances, do not place any additional attribute requirements on the model implementation of a constraint.

An access constraint instance include a check( ) operation that checks to see if the current user has the required access privileges. An access constraint defines no additional signals.

An occurrence constraint instance of the present invention extends a constraint instance and feature instance. The constraint instance has a pointer to its parent and may use its parent information to perform the occurrence check.

An occurrence constraint instance has a one-to-one association relationship with an occurrence constraint implementation that is the occurrence constraint implementation of which the occurrence constraint instance is an instance.

Constraints may have attributes defined by the metamodel and implemented by the model implementation. The constraint instance does not place any additional attribute requirements on the model implementation of a constraint.

An occurrence constraint instance includes a check(number) operation that checks to see if the given number of occurrences is an allowable count. An occurrence constraint defines no additional signals.

A value constraint instance of the present invention extends another constraint instance and a feature instance. The constraint has a pointer to its parent and can use any of its parent's attributes as part of the constraint check. It is allowable to have interplay between attributes set on the parent, and values allowed by this constraint.

A value constraint instance has a one-to-one association relationship with a value constraint implementation that is the value constraint implementation of which the value constraint instance is an instance.

Constraints may have attributes defined by the metamodel and implemented by the model implementation. Therefore, a value constraint instance does not place any additional attribute requirements on the model implementation of a constraint.

A value constraint instance includes a check(Value) operation that checks to see if the given value is acceptable to this constraint. The value will generally be the value about to be assigned to the implementation. Some constraints may require more than one value. In these cases the value passed into the check method can be an array, a collection, a map, or some other composite data object.

A value constraint defines no additional signals.

A feature implementation of the present invention is an implementation that belongs to (are part of) a larger implementation. Feature implementations contain a reference to the implementation of which they are a part. Features may require access permissions in order to be used.

A feature implementation has a one-to-one association relationship with a feature descriptor that is a reference to the feature descriptor the feature implementation implements. A feature descriptor has a zero-to-one association relationship with a parent implementation that is the implementation of which the feature implementation is a part. A feature implementation has a zero-to-many association relationship with access constraint instances that the access constraints placed on this feature.

A feature implementation adds no additional events.

A feature instance of the present invention is an instance that allows access to the parent instance of which they are a feature. A feature instance has a one-to-one association relationship with a feature descriptor that is a reference to the feature implementation of which the feature instance is an instance. A feature instance has a one-to-one association relationship with a parent instance that is the parent instance of the feature instance.

A feature instance adds no additional events.

A datatype implementation represents a model of data. To hold an instance of data, a datatype implementation is used to create a data instance. A datatype implementation contains the implementations for the constraints defined by the datatype descriptor. A datatype implementation can be used to create a datatype instance. The modeling tool using datatype instances must handle failures thrown by the constraint implementations placed upon that data instance.

A datatype implementation has a one-to-one association relationship with a datatype descriptor that is a reference to the datatype descriptor the datatype implementation implements. A datatype implementation has a zero-to-many association relationship with access constraints that are an implementation of constraints placed upon the access allowed to values. A datatype implementation has a zero-to-many association relationship with occurrence constraints that are an implementation of constraints placed on the number of values a data instance may hold. A datatype implementation has a zero-to-many association relationship with value constraints that are each is an implementation of constraints placed upon the values a datatype instance may hold. A datatype implementation has a zero-to-one aggregation relationship with a premutator operation implementation that is an implementation of the operation(s) to execute just before changing the data value. A datatype implementation has a zero-to-one aggregation relationship with a postmutator operation Implementation that is an implementation of the operation(s) to execute just after changing the data value. A datatype implementation has a zero-to-one aggregation relationship with a preaccessor operation implementation that is an implementation of the operation(s) to execute just before returning the data value.

A datatype implementation adds no additional events.

A datatype instance of the present invention is an instance that holds a piece of data. A datatype instance references its implementation to ensure its definition is enforced. A datatype instance holds only values acceptable to its implementation.

A datatype instance references the data implementation for which the data instance is an instance. The datatype instance may hold constraint instances or may implement these constraints directly. A fully virtual implementation holds the constraint instances. These constraints may throw data errors if the values fail to meet the restrictions imposed by the constraint.

A datatype instance has zero-to-many association relationship with values that are holders for instances of data that meet the constraints placed upon them. A datatype instance has zero-to-many association relationship with values access constraint instances that zero or more security checks place on accessing the value. A datatype instance has zero-to-many association relationship with occurrence constraint instances that zero or more checks place on the number of values allowed in this data instance. A datatype instance has zero-to-many association relationship with value constraint instances that zero or more checks place on the values allowed in this data instance.

A datatype instance may include the following operations: instance getValue( ) that returns the current value. Retrieves the first value if more than one value exists, iterator getValues( ) that returns the current values as an iterator to those values, setValue(Instance) that removes any previous value and sets it to the new value after checking all constraints, setValues( ) that is an array that removes any previous values and sets new values after checking all constraints, addValue( ) that is an instance that add the instance given to the current values after checking all constraints, removeValue(Instance) that removes the given instance from the current values after checking to see if the value is being held and checking occurrence constraints, and clearValues( ) that remove all values after checking occurrence constraints.

A data event is fired whenever a value is added, changed, or removed.

An attribute implementation simply has to apply all its constraints to any value being set or added. An attribute implementation must apply occurrence constraints when clearing all values or removing a single value. The virtual attribute descriptor must always apply the access constraints whenever used. An attribute implementation must also properly notify the signal implementation whenever a change successfully occurs.

An attribute implementation has a one-to-one association relationship with an attribute descriptor that is the attribute descriptor for which this implementation provides access to an implementation. An attribute implementation has a zero-to-many association relationship with prechange signal implementations that provide the mechanism to register an appropriate instance's interest in receiving notification when the attribute is about to change. Also provides the mechanism to remove interest in receiving notification for an event. The instance registering interest in receiving event notification must implement the appropriate interface to match the listener type described in the signal descriptor. An attribute implementation has a zero-to-many association relationship with postchange signal implementations that provide the mechanism to register an appropriate instance's interest in receiving notification after an attribute has changed. An attribute implementation also provides the mechanism to remove interest in receiving notification for an event. The instance registering interest in receiving event notification must implement the appropriate interface to match the listener type described in the signal descriptor. An attribute implementation has a zero-to-many association relationship with access signal implementations that is provide the mechanism to register an appropriate instance's interest in receiving notification that an attribute value is being accessed. An attribute implementation has a one-to-one aggregation relationship with a data implementation that is the implementation describing the actual data to be held.

An attribute implementation adds no additional events.

An attribute instance of the present invention uses the attribute implementation from the model implementation to constrain its values. The attribute instance also contains any attribute listeners registered to listen to it. The model instance also contains listeners for each signal it exposes. If an attribute listener registers with the model instance to listen to all attributes, the model instance will register itself with each attribute instance and will forward all attribute events to its attribute listeners.

An attribute instance has a one-to-one association relationship with an attribute implementation that is the implementation for which the attribute instance is an instance. An attribute instance has a zero-to-many association relationship with a data instance that is a holder for instances of data that meet the constraints placed upon them. An attribute instance has a zero-to-many association relationship with access signal instances that are the signal instances holding listeners interested in hearing about accesses to the attribute values. An attribute instance has a zero-to-many association relationship with prechange signal instances that are the signal instances holding listeners interested in hearing about changes to the attribute values before the change occurs. An attribute instance has a zero-to-many association relationship with postchange signal instances that are signal instances holding listeners interested in hearing about changes to the attribute values after the change has occurred.

An attribute instance may include the following operations: getValue( ) that returns the current value(s), setValue(Instance) that removes any previous value and sets it to the new value after checking all constraints, addValue(Instance) that add the instance given to the current values after checking all constraints, removeValue(Instance) that remove the given instance from the current values after checking to see if the value is being held and checking occurrence constraints, and clearValues( ) that remove all values after checking occurrence constraints.

A data event is fired whenever a value is added, changed, or removed.

An operation implementation is a difficult virtual implementation to construct. For each language construct (like branches, loops, comparisons, etc.), there must exist an operation implementation. These operations are added together in a sequence to construct the virtual operation. This is similar to scripting inside an application, or writing source code where one line is evaluated before the next, with some lines of source code skipping or repeating other lines of source code. Once these primary language elements exist, a virtual operation implementation has all the power of a full programming language. However, a virtual operation implementation still has the advantages of drag-and-drop assembly (if the metamodel tool supports it) and certain aspect-programming advantages from being “virtual.” Security and logging can be added at runtime to a virtual operation implementation, as can any other functionality modification. New operations can be added to the language by creating a new operation implementation. This is similar to but far beyond operator overloading or standard template library functionality in C++.

An operation implementation has a one-to-one association with an operation descriptor that is the operation descriptor for which the virtual operation implementation provides access to an implementation. An operation implementation has a zero-to-many association relationship with suboperations that are used to describe the operations that will be executed by this operation in the order in which they occur. An operation implementation has a zero-to-many association relationship with parameter accessors that are used by the operation implementation to impose occurrence, value, and access constraints on the parameter values.

An operation implementation includes an execute(ParameterList) operation that attempts to perform the operation by executing the operation implementation. First all access and precondition constraints are check for the operation implementation and parameter implementations. Then the operation is attempted. If the operation implementation is successful, the postcondition constraints are checked for the operation implementation and parameter implementations.

An operation implementation adds no additional events.

Examples of the use of an operation implementation sub-implementation for trapping failures are described below.

A failure trap implementation of the present invention is an example of an operation implementation representing a try-catch block used by some programming languages (Visual Basic refers to these as onError blocks). A failure trap implementation serves to capture any failures that occur during execution. Failure descriptors signify errors that must be handled in order for the software to continue executing or errors that explain why execution has been cancelled. In either case, a failure trap allows the program to capture (or trap) a failure and perform an operation to attempt logging or recovery from that error. The finally operation is always executed at the end of the try operation, whether a failure was thrown in the try operation or not. The finally operation implementation is even guaranteed to execute even if a further failure is created in the catch operation implementation that is not caught. It will always be executed if the try operation is executed. Note: precondition constraints can prevent the try operation from executing. When preconditions prevent the try operation from executing, the finally operation is not executed. This is consistent with the statement made earlier: the finally operation will always be executed if the try operation is executed.

A failure trap implementation has a zero-to-many association relationship with failures that are captured when thrown. Failures may be thrown by an operation implementation, constructor implementation, destructor implementation, any constraint type, and by accessor operations. Failure trap implementations capture these error notifications and perform some action. This action may be corrective or may simply record the event. A failure trap implementation has a one-to-one association relationship with a try operation implementation that is the operation to attempt. A failure trap implementation has a zero-to-one association relationship with a catch operation accessor that is the operation to perform whenever a failure is received. A failure trap implementation has a zero-to-one association relationship with a finally operation accessor that is the operation to perform whenever the try operation has been executed whether the execution of the try operation was successful or not.

A failure trap includes Execute(ParameterList) operation that inherited from OperationImplementation.

Instances of failure trap implementation fire failure events fired whenever a failure is trapped. These events can be useful to ensure that a failure trap operation is correctly handling failures. Corrective actions, assumed to always succeed, that fail to perform can cause serious headaches to debugging. These events allow rapid discovery of failed corrective actions.

An operation instance of the present invention represents an operation to execute. At this level, an operation instance provides little value as it simply calls the execute(ParameterList) method on the operation implementation. The operation instance is required to provide one-to-one mapping from an implementation to an instance. In child models of operation instance (like method instance), operation instances provide more value by holding event listeners. Some child models of operation instance may hold parameter values for the operation execution.

An operation instance has a one-to-one association relationship with an operation implementation that is the implementation for which the operation instance is an instance.

An operation instance includes an execute(ParameterList) operation that performs the execution.

An operation event is sent at the successful completion of the operation. An operation failure event is sent if a failure occurs during the execution of the operation that fails the operation.

Parameter implementations of the present invention are used by virtual operation implementations to check constraints applied to parameters. Precondition constraints, access constraints, and occurrence constraints are checked before the operation begins. Postcondition constraints are applied after the execution of the operation. A parameter can be assigned a default value if no value is passed in. A parameter implementation can also enforce “contractual constraints” which are not possible in any third generation programming language. Contractual programming specifies certain constraints about accessing parameters and about changing their values. To enforce contracts, a submodel of the default virtual parameter implementation can be created.

A parameter implementation has a zero-to-many association relationship with a parameter descriptor that is implemented by the parameter implementation. A parameter implementation has a zero-to-many association relationship with recondition constraints that are each an implementation of a constraint to restrict the values allowed to be held by the parameter before execution of the operation. A precondition constraint can also enforce a constraint, like a no modification constraint, by adding a wrapper around the parameter value. A parameter implementation has a zero-to-many association relationship with postcondition constraints that are each an implementation of a constraint to restrict the values allowed to be held by the parameter after execution of the operation. A post condition constraint may also remove wrappers added by precondition constraints as necessary. A parameter implementation has a zero-to-many association relationship with occurrence constraints that are each an implementation of a constraint to restrict the number of values assigned to the parameter.

A parameter implementation may include the following operations: precheck(Value) that perform a check of all precondition constraints against the given parameter value. Also perform a check of all occurrence and access constraints, and postCheck(Value) that perform a check of all postcondition constraints against the given parameter value.

A parameter implementation adds no additional events.

Parameter instances of the present invention are a data instance with the constraints imposed by the parameter implementation. Parameter instances have a one-to-one association relationship with a parameter implementation that is the implementation for which the parameter instance is an instance. A parameter instance has a zero-to-many association relationship with value that are holders for instances of data that meet the constraints placed upon them.

A parameter instance serves only as a holder of data values

A parameter event is fired with the results of a precondition check. A second parameter event is fired with the results of the postcondition check, if the operation is successful enough to reach the post condition check.

A method implementation of the present invention extends an operation implementation. A method is an operation that is a feature of a model. A method implementation has a one-to-one association relationship with a method descriptor is the method descriptor for which the method implementation provides access to another implementation. A method implementation has a zero-to-many association relationship with a signal implementation that provides the mechanism to register an appropriate instance's interest in receiving notification when the attribute generates an event. The signal implementation also provides the mechanism to remove interest in receiving notification for an event. The instance registering interest in receiving event notification must implement the appropriate interface to match the listener type described in the signal descriptor. A method implementation has a zero-to-many association relationship with precondition constraints that are each an implementation of a constraint to restrict some environmental condition or state of the model implementation before the execution of the method. These types of constraints might check for the installation of a security manager, the existence of a database connection, or some other environmental condition. These constraints might also check to see if a model implementation has entered into the correct state to allow the execution of this method. Constraints related to the parameter values are held by the parameter descriptors. A method implementation has a zero-to-many association relationship with postcondition constraints that are each an implementation of constraints to check for certain conditions at the end of the method. Similar to precondition constraints in checking for environmental and model related assumptions.

A method implementation may include an execute(ParameterList) operation that attempts to perform the operation by executing the operation implementation. First all access and precondition constraints are check for the method implementation and parameter implementations. Then the method is attempted. If the method implementation is successful, the postcondition constraints are checked for the method implementation and parameter implementations.

A method implementation adds no additional events.

A method instance of the present invention extends an operation instance. A method instance is an instance of a method to store event listeners for that method. A method instance has a one-to-one association relationship with a method implementation that is the method descriptor for which this implementation provides access to an implementation. A method instance has a zero-to-many association relationship with a signal implementation that provides the mechanism to register an appropriate instance's interest in receiving notification when the attribute generates an event. Also provides the mechanism to remove interest in receiving notification for an event. The instance registering interest in receiving event notification must implement the appropriate interface to match the listener type described in the signal descriptor.

A method instance includes an execute(ParameterList) operation that attempts to perform the operation by executing the operation implementation. First all access and precondition constraints are check for the method implementation and parameter implementations. Then the method is attempted. If the method implementation is successful, the postcondition constraints are checked for the method implementation and parameter implementations.

An operation event with the status of the preconditions is fired to all interested parties after execute(ParameterList) method performs all the precondition tests. A second event is sent at the successful completion of the operation. A third event is fired with the status of the postconditions or the operation. A fourth event is fired only if a failure occurs during the execution of the operation.

A signal implementation of the present invention is an assembly of operation implementations related to sending events. A signal implementation has a one-to-one association relationship with a signal descriptor that is the signal descriptor for which this implementation provides access to an implementation. A signal implementation has a zero-to-many aggregation relationship with a listener registration operation that calls upon the operation held by the signal implementation to perform registration for event notification. A signal implementation has a zero-to-many aggregation relationship with listener deregistration operation implementations that calls upon the operation held by the signal implementation to remove an instance from registration for event notification. A signal implementation has a zero-to-many aggregation relationship with listener access operation accessors that call upon the operation held by the signal implementation to list all instances registered for event notification. A signal implementation has a zero-to-many association relationship with registration constraints that are each an implementation of constraints to check for certain conditions of the objects being registered. Registration constraints may also be used to restrict the type and number of listeners.

A signal implementation may include the following operations: register(Instance) that attempts to register the given instance as a listener. Registration constraints are applied to the listener before performing the registration event, deregister(Instance) that attempts to remove the given instances from listening to event notifications, and listListeners( ) that returns an enumeration to the listeners currently listening for events from this signal.

A registration event with the status of the registration constraints is fired to all interested parties after register(Instance) method performs all the precondition tests. A second event is sent at the successful completion of the registration operation. Events are also fired when deregister(Instance) and listListener( ) methods are called.

A signal instance of the present invention contains the listeners associated with an instance that generates events. A signal instance has a one-to-one association relationship that is the implementation for which the signal instance is an instance. A signal instance has a zero-to-many association relationship with listeners that are holders for listeners implementing the type of the listener to receive events.

A signal instance includes a sendEvent(event) that sends an event to all listeners

A listener event is fired whenever a listener is added, changed, or removed.

A constructor implementation of the present invention passes through the parameters and failures given by the operation implementations it will perform during construction. A constructor implementation has a one-to-one association relationship with a constructor descriptor that is the constructor descriptor for which this implementation provides an implementation. A constructor implementation has a zero-to-many association relationship with failures that may be thrown if the constructor parameters do not match or if the constructor operation implementations throw an error during execution.

A constructor implementation inherits attributes from operation implementation but does not add new attributes.

A constructor implementation includes newInstance(ParameterList) operation that is the method call to perform a construction with the given values as parameters. The parameters in the parameter list must match the type and be accepted by the parameter implementations in order for construction to be successful.

An implementation change event is fired whenever an attribute value is added, changed or removed from the constructor implementation.

A construction event with the status of the preconditions is fired to all interested parties after newInstance(ParameterList) method performs all the precondition tests. A second event is sent at the successful completion of the operations related to construction. A third event is fired with the status of the postconditions. A fourth event is fired only if a failure occurs during the execution of the construction.

A constructor instance of the present invention may be unnecessary for many applications. The constructor implementation performs the work associated with destruction. The constructor implementation can always be retrieved from an instance by going through the metamodel implementation for that instance. A constructor instance does provide support for activities that model current reflection packages available in many programming languages.

A constructor instance has a one-to-one association relationship with a constructor implementation that is the implementation for which the constructor instance is an instance

Depending on the needs of the application, a destructor implementation may simply destroy the virtual model to free memory, or a destructor can first destroy any persistent data related to the virtual model, and then destroy the virtual model. The determination is defined by the operation implementations assigned to the virtual destructor implementation.

A destructor implementation has a one-to-one association relationship with a destructor descriptor that is the destructor descriptor for which the destructor implementation provides an implementation. A destructor implementation has zero-to-many association relationship with precondition constraints that are each an implementation of a constraint to restrict some environmental condition or state of the model implementation before the execution of the destructor implementation. These types of constraints might check for the installation of a security manager, the existence of a database connection, or some other environmental condition. These constraints might also check to see if a model implementation has entered into the correct state to allow the destruction. Constraints related to the parameter values are held by the parameter descriptors.

A destructor implementation includes a destroy( ) operation that is the method call to perform a destruction.

An implementation change event is fired whenever an attribute value is added, changed or removed from the destructor implementation.

A destruction event with the status of the preconditions is fired to all interested parties when the destroy( ) method is called. A second event is sent at the successful completion of the operations related to destruction. A third event is fired only if a failure occurs during the execution of the destruction.

A destructor instance of the present invention may be unnecessary for many applications. The destructor implementation performs the work associated with destruction. The destructor implementation can always be retrieved from an instance by going through the metamodel implementation for that instance. A destructor instance does provide support for activities that model current reflection packages available in many programming languages.

A destructor instance has a one-to-one association relationship with a destructor implementation that is the implementation for which the destructor instance is an instance

A model implementation of the present invention extends another implementation. The virtual model implementation is defined by a model descriptor. The model implementation object contains implementations for each feature accessed by a model accessor. As discussed above, this may be as many as one feature for each feature in the model descriptor, or it may be less if the model accessor uses some non-virtual features.

A model implementation has a one-to-one association relationship with a metamodel that is the metamodel for which the model implementation provides an implementation. There exists a one-to-one relationship for each descriptor in the metamodel to each child implementation in this model implementation. A model implementation has a one-to-one specialization relationship with a parent model implementation that is the parent model implementation that is configured to give implementations for all the features of the parent model descriptor. This model implementation delegates to its parent model implementation wherever it inherits features from it parent and does not override those features. A model implementation has a zero-to-one association relationship with a description that provides details about the hint for the correct use of this implementation and details about the implementation. A description is often useful for human users and automated documentation. This description is different from the description on the metamodel object. That description provides details about how the model is designed and why; this description provides details on use of the implementation. A model implementation has a one-to-one association relationship with a version that provides details about the number of modifications that have been made to the model implementation. A model implementation has a one-to-many aggregation relationship with a constructor implementation that provides a mechanism for creating new instances of the model described by the model descriptor. Several different constructors may exist, each of which uses a different number and type of arguments. A model implementation has a one-to-one aggregation relationship with a destructor implementation that provides a mechanism to destroy an instance of the model being described. Depending on the persistence rules associated with an implementation, this may permanently destroy the instance from the persistence store, or it may simply remove the representation of that persisted object from memory. The implementer will document the level of destruction. A model implementation has a zero-to-many aggregation relationship with static attribute instances that are attribute instances are held by a model implementation and therefore do not require an instance of the model in order to be accessed. These instances allow the value to be set and retrieved where the attribute is shared among all instances of the model. A model implementation has a zero-to-many aggregation relationship with instance attribute implementations that are attribute implementations that require an instance of the model in order to be accessed. These implementations allow the value to be set and retrieved on one specific instance. A model implementation has a zero-to-many aggregation relationship with static operation implementations that are operation implementations that do not require an instance of the model in order to be executed. These implementations provide a mechanism to execute the operation. A model implementation has a zero-to-many aggregation relationship with instance operation implementations that are operation implementations that require an instance of the model in order to be executed. These implementations provide a mechanism to execute the operation. A model implementation has a zero-to-many association relationship with signal implementations that provide the mechanism to register an appropriate instance's interest in receiving notification when the model generates an event. Also provides the mechanism to remove interest in receiving notification for an event. The instance registering interest in receiving event notification must implement the appropriate interface to match the listener type described in the signal descriptor. Signal implementations held by the model implementation are generally all of or a subset of those signals held by each attribute and operation (since the attributes and operations directly generate events and the model does not).

To register interest in events fired by an instance of a model implementation, use the signal implementations. This type of use applies to all implementations.

An implementation change event is fired whenever an attribute value is added, changed or removed from the model implementation. These attribute events relate to the structure of the model implementation, not the values held by the attribute implementations.

To construct a new virtual model instance in the implementation layer, a new VirtualModelInstance is created. The model instance has its definition set to the Model Implementation used to create it. A new attribute instance is added to the new model instance for each instance attribute implementation in the model implementation. The initial values for each instance attribute are set. The operation implementation of the virtual constructor is called. Finally, the model instance is returned to the meta-implementation layer.

A model instance of the present invention is created from a model implementation. This is analogous to creating an instance of an object from a class in object-oriented programming. It is also similar to creating a record matching the description of columns for a table in a database.

For each attribute implementation an attribute instance is created. The model instance performs all constructions, destructions, and operations by using the implementations held by the model implementation.

A model instance has a one-to-one association relationship with a model implementation that is the implementation for which this model is an instance. A model instance has a zero-to-many aggregation relationship with attribute instances that are the attribute instances used to hold attribute values. A model instance has a zero-to-many aggregation relationship with method instances that are the method instances to hold event listeners to specific method events. A model instance has a zero-to-many association relationship with signal instances that are the signal instances used to provide listener support for each event type in either attribute or method instances. Registering to a signal instance on the model listens for all events, regardless of which specific attribute or method generated it. Registering for a signal on a specific method or attribute will receive only that specific instance's events.

An attribute change event is fired whenever an attribute instance fires an attribute change event due to its value changing.

An interface implementation of the present invention provides an implementation for those static final attributes defined in the interface. An interface implementation has a one-to-one association relationship with an interface descriptor that is the descriptor for which the interface implementation is an implementation. An interface implementation has zero-to-many aggregation relationship with interface implementations that are zero or more interfaces this interface of the present invention extends. An interface implementation has zero-to-many aggregation relationship with static attribute instances that the attribute values assigned to those attributes are defined in the interface definition.

An interface implementation serves as a data holder for static attribute values. Operation implementations held by the model implementation perform all operations.

An attribute change event is fired whenever a static attribute instance fires an attribute change event due to its value changing.

A package implementation defines a hierarchy of other package implementations and metamodel implementations. A package implementation has a zero-to-one aggregation relationship with a package attribute implementation that is child package implementations implementing child packages of this package. A package implementation has a zero-to-one aggregation relationship with a model attribute implementation that is a model implementation that belong to this package implementation. A package implementation has a zero-to-one aggregation relationship with static attribute instances that are other attributes the static package implementation may hold. A package implementation has a zero-to-one association relationship with attribute that are other attributes the package may hold.

A package event is fired whenever a model implementation or package implementation is added, changed or removed from the package implementation.

A package instance of the present invention holds those attributes defined by the package implementation. Generally a package instance will have an attribute for holding child package instances and an attribute for holding model implementations.

A package instance has a one-to-one association relationship with a package implementation that is the package implementation for which the package instance is an instance. A package instance has a zero-to-one association relationship with attribute instances that are the attribute values held by this package instance for each attribute defined in the package implementation. A package instance has a one-to-one aggregation relationship with a package attribute instance that is the attribute to hold sub package instances. A package instance has a one-to-one aggregation relationship with a metamodel attribute instance that is the attribute to hold model implementations.

An attribute change event is fired whenever an attribute value is added, changed or removed from the package implementation.

A version implementation is an implementation of a version. Once made available in the metamodeling layer, an implementation is also available for use in the meta-implementation layer and implementation layer described later of the present invention.

A version implementation refers back to a version descriptor detailing the three data implementations the version implementation must possess.

A version implementation has a one-to-one aggregation relationship with a major release attribute implementation that is an attribute implementation describing valid values for the major release. A version implementation has a one-to-one aggregation relationship with a minor release attribute implementation that is an attribute implementation describing valid values for the minor release. A version implementation has a one-to-one aggregation relationship with a build release attribute implementation that is an attribute implementation describing valid values for the build release. A version implementation has a one-to-one aggregation relationship with a revision release attribute implementation that is an attribute implementation describing valid values for the revision release.

A version implementation includes a newInstance(ParameterList) operation to create a new version instance

An implementation change event is fired when the version descriptor is changed to a different version descriptor.

A version instance of the present invention is a grouping of the four data instances defined by a version implementation.

A version instances refers back to a version implementation detailing the four attribute instances it must possess.

A version instance has a one-to-one aggregation relationship with a major release attribute instance that is an instance of data that contains the value for the major release according to the major release data implementation from the version implementation. A version instance has a one-to-one aggregation relationship with a minor release attribute instance that is an instance of data that contains the value for the major release according to the major release data implementation from the version implementation. The minor release attribute is reset to its initial value (which may be zero) when the major release is incremented. A version instance has a one-to-one aggregation relationship with a build release attribute instance that is an instance of data that contains the value for the major release according to the major release data implementation from the version implementation. The build release attribute is reset to its initial value (which may be zero) when the major release or minor release is incremented. A version instance has a one-to-one aggregation relationship with a revision release attribute instance that is an instance of data that contains the value for the major release according to the major release data implementation from the version implementation. The revision release attribute is reset to its initial value (normally zero) when the major release, minor release, or build release is incremented.

A version instance may include the following operations: incrementMajorRelease( ) that is used to increase the major release version, incrementMinorRelease( ) that is used to increase the minor release version, and incrementRevisionRelease( ) that is used to increase the revision release version.

An attribute change event is fired whenever a value is added, changed, or removed.

Hint implementations must be implemented in the model descriptor layer in order to be added to the metamodel. A hint implementation has a one-to-one association relationship with a hint descriptor is the hint descriptor that describes the hint implementation. A hint implementation has a zero-to-one association relationship with a description that is a description of the purpose of the hint implementation. A hint implementation has a zero-to-many association relationship with attribute implementations that are the implementation of the various attributes to hold the values for a hint.

A hint implementation includes a newInstance( ) operation to create a new hint instance. Hints may not take constructor arguments.

An implementation change event is fired when the hint descriptor is changed.

A hint instance holds the value or values fitting the definition of its hint implementation.

A hint instance has one-to-one association relationship with an implementation that is the hint implementation that describes the hint instance. A hint instance has one-to-many association relationship with attribute instances that are the attribute instances for capturing important details not captured by any other element of the metamodel layer.

An attribute change event is fired whenever the value held by the hint is changed.

A role implementation must be implemented in the model descriptor layer in order to be added to the metamodel. A role implementation has a one-to-one association relationship with a role descriptor that is the role descriptor that describes this implementation. A role implementation has a zero-to-many association relationship with role implementations that are storage locations for other roles that participate in this role. A role implementation has a zero-to-many association relationship with hint implementations that are storage locations for hints that participate in this role.

A role implementation may include the following operations: a newInstance( ) to create a new role instance. Roles may not take constructor arguments, getHints( ) that returns the current hints(s), addHint(HintImplementation) that add the hint given to the current hint implementations, removeHint(HintImplementation) that removes the given hint from the current hint values, clearHints( ) that remove all hints, getRoles( ) that return the current roles, addRole(RoleImplementation) that add the role given to the current role implementations, removeRole(RoleImplementation) that remove the given role from the current role values, and clearRoles( ) that remove all roles.

An implementation change event is fired whenever the hints or roles are added or removed. An implementation event is also fired when the role descriptor is changed to a different role descriptor.

A role instance of the present invention is a container for hint instances and other role instances. A role instance has a one-to-one relationship with a role descriptor that is the role descriptor that describes the role implementation. A role instance has a zero-to-many relationship with role instances that are storage locations for other role instances that participate in this role. A role instance has a zero-to-many relationship with hint instances that are storage location for a related group of hints that are applied in several locations to capture details about a model that are not captured in any other part of the metamodel layer.

A role instance may include the following operations: getHints( ) that returns the current hint instances, andgetRoles( ) that return the current role instances

An attribute change event is fired whenever hints or roles are added or removed.

A component integration engine of the present invention assembles metamodels describing how a software applications work. The tool then generates a meta-implementation or a virtual implementation directly without intermediate source code and compilation. Meta-implementations are combined to perform all the necessary software processes that make up an application. These processes are made available as client-server applications or web-based applications through user-access points designed for each type of application. Other user-access points can be developed for other types of applications like email list-serve or peer-to-peer applications.

The tool provides meta-implementations for many existing APIs provided as part of a programming language and meta-implementations for accessing database structures as models. The persistence engine and metamodel attributes ensure proper storage of business data. The tool may also be open to third-party metamodels and meta-implementations.

The virtual operations and meta-implementations are combined via metadata to perform new operation implementations for virtually any type of application. These operations are similar to those in a programming language: Boolean and numeric expressions, branching statements, and loop statements. These logical operations are combined with the common services (database access, email access, image operations, etc.) provided by the meta-implementation provider to assemble complex operations in the same way programming languages create operations out of existing libraries of application programming interfaces (APIs). In fact, by creating a meta-implementation descriptor for the existing APIs in a programming language, all of the functionality of a programming language can be made available as meta-implementation operations.

A component integration engine is capable of all of these functions. It serves to integrate components through descriptions of the components and descriptions of processes. Rather than generating source code to implement each metamodel accessor in a specific way, the component integration engine uses assemblies of accessors to create software applications.

Use of a component integration engine to build software using a meta-implementation layer dramatically decreases the amount of time necessary to implement a model. Rather than first modeling the software, then building that software; the modeling process is also the building process. Modeling is required to be a complete, but the modeling process may always have been complete.

While some metamodel components require special programming to complete an implementation, the meta-implementation provider can provide a wide range of operations as a set of common services. These services implement commonly used operations in computer software like object-relational mapping, object-XML mapping, object instantiation and configuration, naming and directory operations, database operations, email operations, DNS operations, logging operations, object caching and pooling, web accessibility, image generation, text formatting, batch scheduling, and resource security. Since the meta-implementation layer provides these services, they can simply be defined as part of the metamodel without requiring additional implementation.

Meta-implementation layers are extensible. The meta-implementation layer is extensible since any object wishing to participate in the meta-implementation layer can simply implement the appropriate interface and begin participation. Being extensible means new model concepts and technology components can be added directly to any component integration engine implementation.

Applications built using meta-implementation are easier to maintain. The meta-implementation layer imposes loose coupling between components in an application. Each component accesses the other components through a very limited number of interfaces (the meta-implementation layer interfaces), no direct access occurs. Therefore, changes to the implementation of one model require a minimal or no changes to other models. Models are isolated from implementation errors in other models by the meta-implementation layer. Operations that comply with the metamodel definition for preconditions, postconditions, parameter value constraints, parameter access constraints, service access constraints, and metamodels access constraints are unlikely to propagate errors undetected through the meta-implementation layer. Care must still be taken to thoroughly document side effects of operations since the component integration engine may not check for all possible side effects. Side effects are effects resulting from executing an operation that are not obvious through changes to the parameters or return type. An example of a side effect is running a findSquareRoot(int) operation to retrieve the square root of a number, and finding out that this program has entered data into a database table. While this functionality might be correct, it is a side effect, since it is not obvious that some external change has been made.

The component integration engine of the present invention reduces complexity by simplifying or eliminating the mapping of a metamodel to a model to an implementation. It reduces time to implementation by automating the implementation from the metamodel. It reduces software code maintenance by not producing code and by providing common services. It reduces maintenance by providing easy to change, loosely coupled assemblies. It allows for the integration of any new or existing technology through meta-implementation.

Domains in the Component Integration Engine (CIE) are the logical grouping of resources, meta-implementations, services, and a persistence engine as they relate to a specific subject matter or problem domain. None of the components available in a domain can be accessed without the user of the domain first being authenticated.

Authentication is the process of confirming a user's true identity. Authentication in a component integration engine is delegated to an authentication component. Like all other components in a component integration engine, the authentication component is configurable and swappable. This “pluggable” approach to authentication allows any valid authentication component to perform the authentication according to the current configuration. Components for authentication can then be developed for biometrics, UNIX login, database login, Windows NT login, file-based login, Kerberos login, smart card login or any other current or future authentication technology.

The problem domain holds resource managers to manage shared resources. Shared resources are pre-configured component instances that provide details about the running environment or access to resources, services, or functionality that can be shared amongst all users and processes running in the domain. Example resources are database connections, thread pools, object caches, and resource stores. One manager exists for each type of shared resource. Managers are accessed by the name of the resource they manage. Resources are retrieved from the managers by name or query.

Package accessors are described above. The package accessors in a component integration engine allow the CIE or any program using the CIE the ability to access any implementation for which a package has been modeled. Programs can be dynamically constructed at runtime by accessing the various packages and models and performing operations. Since there exists a single set of interfaces defining the API to call any method or construct any component, it becomes relatively easy to build applications that use a CIE to construct dynamic programs at runtime.

A persistence engine is necessary for a component integration engine that wishes to store data related to instances created or dynamic programs to be stored for future use. The persistence engine can be as simple as saving the assemblies to files as XML or it may be as complex as a full Object-Relational Mapping Engine (see details in section below). The persistence engine uses metamaps (a mapping of one meta-implementation to another meta-implementation) to determine how to persist the given instance. A broker that performs the actual work of storing or retrieving the object interprets these maps. Like all other parts of a CIE, the persistence engine enforces access and security constraints based on authorizations related to the authentication of the user.

Providing commonly used services as components in the component integration engine increases the reuse of that code and reduces the amount of code necessary to create new applications. A common pattern for providing these services is to create command architectures. Each command takes a set of input and produces output. With a component integration engine, commands become much more powerful and flexible. Since each component has the metamodel layer to describe the structure of its input and output, commands can be created with much more complex input and output models while still being understandable to the user. Commands are also more configurable through the use of the meta-implementation layer, allowing generalized commands to be configured to perform specific tasks.

The services described below are examples of the types of services a component integration engine may provide. These do not represent all possible services. Like all other parts of a CIE, the common services enforce access and security constraints based on authorizations related to the authentication of the user.

This service provides access to the objects in the environment in which the component integration engine is running. It provides the ability to read the configuration of any shared object or service in the environment, to add or remove these objects or services, or reconfigure these objects and services.

A database service provides access to databases and other database-like data stores like flat-files, fixed-length files, and spreadsheets. Commands may exist to execute SQL, store and retrieve data, and alter the relational structures in the database. Database specific commands may allow configuration of the database environment.

A domain service provides access to the domains that exist in the component integration engine. Commands may exist to start, suspend, resume, stop, or dispose of services and shared objects. Commands may exist to create new virtual hosts and domains. Used together with the configuration service, the domain service provides complete control over the environment in which the CIE resides.

An email service provides access to email servers. Commands may exist to send and receive email messages, manage mail stored on an email server, add or remove users from message lists, and add or remove users from the email server.

A formatting service provides formatting of textual information. Commands may exist to process mail-merge templates, XSLT transformations, or tag libraries.

An image service provides access to image manipulation and creation activities. Commands may exist to create images from GUI components, create images based on XML descriptors, or draw text as images.

A messaging service provides access to messaging services. Messaging services guarantee delivery of a message to those parties that have registered interest in receiving messages or to those parties to whom the message is addressed.

A naming service provides access to directory and naming context servers. Commands may exist for user lookup, user password verification, computer registry access and modification, and phone book lookups.

An object store service converts an object structure to a state where it will exist even after the object has been destroyed. Commands may provide object-relational mapping, Enterprise Java Beans, or XML file creation.

A processing service allows the creation of new commands or services through the creation of a process control structure. This control structure may contain loops and branches and other operations available as part of the CIE. When a user requests the execution of a specific process, it is executed like a virtual program. Security restrictions determine the ability of users or programs to create new processes.

A resource service provides access to files, URLs, database LOBS, and other sources of binary and textual data. Resources serve as a persistence mechanism for binary and textual data. Commands may exist to create new resources, delete existing resources, or read the content of a resource.

A roadmap service allows the creation of new commands or services through the straightforward combination of other existing commands. A roadmap specifies each step in a process in the order in which it should occur. The commands in this service execute the roadmap.

A schedule service provides for the scheduling of activities on a one-time or reoccurring basis. Commands exist to schedule activities and reminders for these activities for any desirable interval and reoccurrence. Commands also exist to view existing activities and remove activities.

A security service provides access to the system security settings. Normally, security is read-only and restricted to those users with appropriate access. Sometimes it is useful to have access to commands that retrieve the current user's identity, so it can be passed as parameters to other commands (like logging).

Several very difficult to implementation concepts become very simple when a component integration engine is applied to them. Described below are some of these implementations and the manner in which a component integration engine simplifies them.

Code generators may be easily constructed from a well defined metamodel. Many CASE and UML tools already provide code generation based on metamodels. In those cases, a complex mapping is necessary to generate appropriate source code. The introduction of a meta-implementation layer simplifies code generation significantly. Operations cannot be fully captured in the current UML and CASE tools without resorting to a programmer typing code into the metamodel tool. A virtual implementation, on the other hand, contains a drag-and-drop interface for adding “pseudo-code” logic that the virtual implementation is able to execute directly. By constructing the virtual implementation for a model, a simple one-to-one mapping exists between the virtual implementation and the metamodel. By further constructing a serializer for each virtual implementation, source code can be generated for any language with similar concepts. A serializer is an object that writes the lines of code related to one virtual implementation. For example, a CSharp_ForLoopSerializer would accept a ForLoopImplementation and generate the appropriate C# source code as follows:

```
Write( “for( int i=” );
Serialize( ForLoopImplementation.getMinValue( ) );
Write( “; i<” );
Serialize( ForLoopImplementation.getMaxValue( ) );
Write( “; i=i+” );
Serialize( ForLoopImplementation.getIncrement( ) );
WriteLine( “{” );
//For-each sub-operation serialize it
    for( Iterator itr= ForLoopImplementation.getSubOperations( );
    itr.hasNext( ); ) {
        Serialize( itr.next( ) );
    }
    //close the loop
    Write( “}” );
    In the above code, each call to Serialize( ) gets the serializer
appropriate for the implementation object returned. The resulting code
would look something like this:
    for( int i=0; i<10; i++ ) {
      System.out.println( “Hello World” );
    }
```

Object query languages provide a simple scripting language, similar to SQL, for querying sets of objects. The query places constraints on the objects that should be returned and may also select attribute values from those objects.

Selection of various attributes of objects is simplified by using a component integration engine that describes every object as a model containing attributes. Retrieval of these attributes is performed using Attribute Accessors.

The value constraints and the logical expressions already developed in the meta-implementation layer form all the structures necessary for expressions used in the object selection constraints.

After implementing the language serializers according to the process described above the final component necessary to perform an object query language is a parser. Where the serializers convert virtual implementations to source code, parsers convert source code into a structure understood by the computer. In this case, a parser would need to be implemented to convert the Object Query Language (OQL) back into virtual implementations. Parsers are well understood by computer programmers. The reference component integration engine, component integration engine, even provides all the structures necessary to rapidly build a parser for a new language and convert that language into virtual implementations.

An object-relation mapping engine stores object data to records in a relational database. The process involves retrieving the object data, performing some simple conversions on this data to ensure that the data is in the proper form for storage, and generating the SQL statements necessary for inserting, updating, and deleting this data. Object-relational mapping engines also perform the mapping from the database back to an object. In this case, the object to be retrieved is selected by a process. This process must use the object's identity (the primary key in the database) or some of the object's characteristics (an OQL query). The records returned from the database are converted back to an object structure using the same mapping used to store them (conversions are reversed).

By using a component integration engine with a meta-implementation layer which uses databases to create instances and a second meta-implementation layer for objects (virtual or compiled), an object can be stored in a database by simply mapping from the attributes of one meta-implementation layer to the attributes of another meta-implementation layer. When the object meta-implementation is copied into the database meta-implementation, a record is created in the database and the attribute values are stored in each of the columns. More complex mappings involving more than one table would simply involve more than one database meta-implementation model or would use the facilities the database meta-implementation provides for mapping objects to database tables. All the implementation related to SQL generation, object selection, attribute retrieval, and conversion are already part of the component integration engine (with a database meta-implementation).

An Extract Transform Load (ETL) tool provides the ability to select data from a data source (a database table, comma delimited file, fixed-length file, spreadsheet) and perform transformations on that data (conversions, merges, value lookups, etc.) to create a new record to be loaded into a database. The entire process can then be saved and reused to add more data to that database table at some future date. The ETL tool may also allow scheduling of these extracts on a continuous basis. ETL tools are very complex. Metadata needs to exist to describe each transformation operation so it can be reconstructed. This data needs to be saved to a database or file in order to be persisted for future use. The transformations must describe an implementation of an operation that accepts parameters and returns a result. The transformation process may include branching statements and loops. The resulting data must be stored in the appropriate database table.

A component integration engine can contain components for each type of datasource to create an object representation of the data contained in that data source. As discussed in the Object-Relational Mapping section, data retrieval and data storage related to objects is a trivial extension of a component integration engine. By simply adding the virtual operation implementations from a component integration engine to an Object-Relational Mapping Engine, an ETL tool results.

Document workflow requires data storage for documents and the recording of a documents progress through a series of steps. The document workflow must additionally create a process entity model that is written to the database each time a step is started or completed. The computer executes some steps. People who perform some task and enter additional data into the computer complete other steps. Frequently, one or more steps involve approval of a document in order to progress to the next step.

Document Workflow essentially uses the scheduling service of a component integration tool to scan for records in a database table periodically. Any record entering into an automated step is retrieved through object-relational mapping and given as a parameter to the step, which is an operation implementation.

If the step is not automatic, the document workflow generally must provide a way to enter data into an object model that is then stored in the database before marking a step complete. The object structure and mapping to a database has already been discussed. Providing a mechanism for user input can be accomplished through web services by using the serializer concept to generate an HTML form directly from the object description, then setting the attributes of the object from the values entered on this form. Alternatively, a client-server program could create form elements based on the model descriptors and set the values directly on the object from those form elements. Once entered from a form, the object data and the process entity for the step can be recorded.

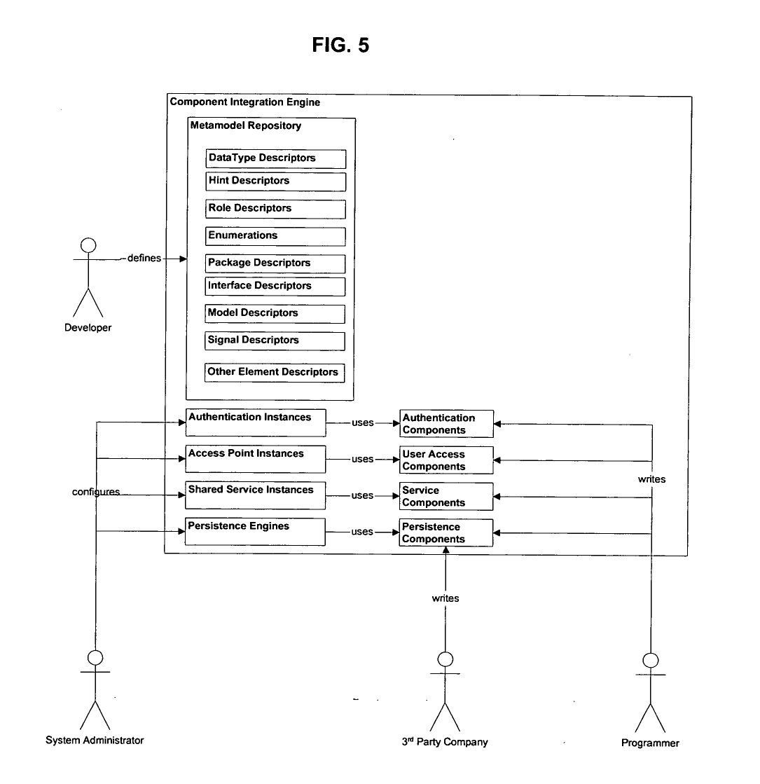

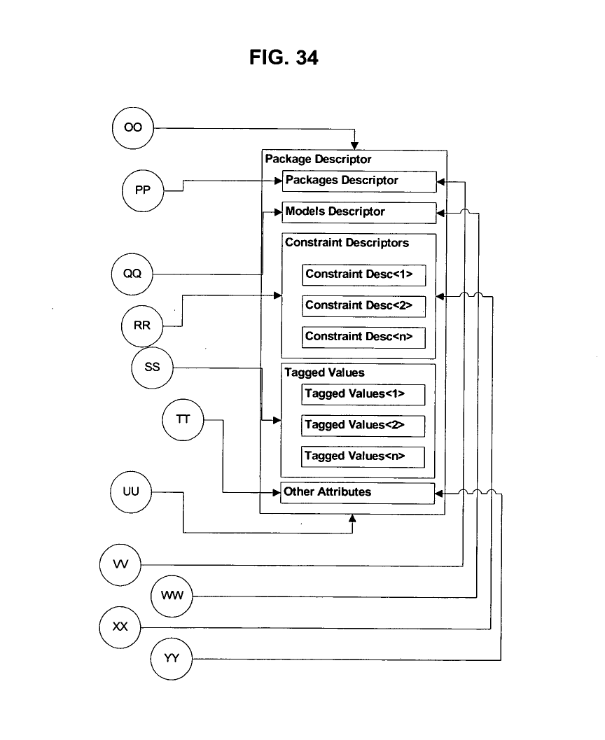

FIGS. 5-34 is a multi-part diagram illustrating how a component integration engine of the present invention operates. In FIGS. 5-34, the “user” is an end user.

After a developer defines the software models that are part of each part of each application, the system administrator can configure the parts of the Component Integration Engine of the present invention of FIG. 5. The parts of the Component Integration Engine are based on standards to allow the use of existing and new components developed by third parties or by the programmers who program the component integration engine. In many cases, the components of the Component Integration Engine, such as: databases, email servers, etc. are already owned by the company for whom the system administrator works or the components are provided as part of the Component Integration Engine to the system administrator. The Component Integration Engine is open to allow new components if existing components are not a good fit.

As illustrated in FIG. 5, a developer defines the descriptors of a metamodel repository of a component integration engine of the present invention. A system administer configures authentication instances, access point instances, shared service instances and persistence engines that use authentication components, user access components, service components and persistence components, respectively. A 3^{rd} party company and a programmer are both able to write to authentication components, user access components, service components and persistence components.

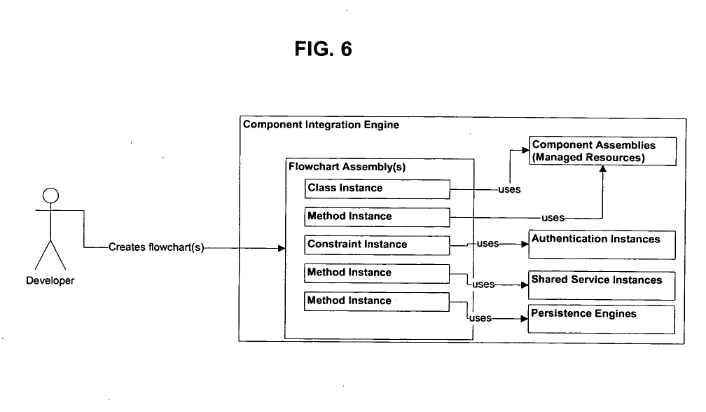

In FIG. 6, with the Component Integration Engine configured and the application models available, a developer may now create flowchart assemblies. The flowcharts describe various responses to events that may occur. Some events may originate from a user and other events may originate from automatic triggers. The flowchart may create or dispose of model instances, invoke methods, generate signals or perform other necessary work. The flow chart assembly may also call upon shared service or component assemblies as necessary. The user access point provides a mechanism for organizing these flow charts in a way that the user may execute them to perform some useful activity. This organization of flowcharts, services, models, and instances creates a software application.

As shown in FIG. 6, a developer creates flowcharts in the flow chart assembly(s) of the Component Integration Engine. A model instance of the flowchart assembly(s) uses component assemblies. A method instance of the flowchart assembly(s) also uses component assemblies. A constraint instance of the flowchart assembly(s) uses authentication instances. A method instance of the flowchart assembly(s) uses shared service instances. A method instance of the flowchart assembly(s) uses persistent engines.

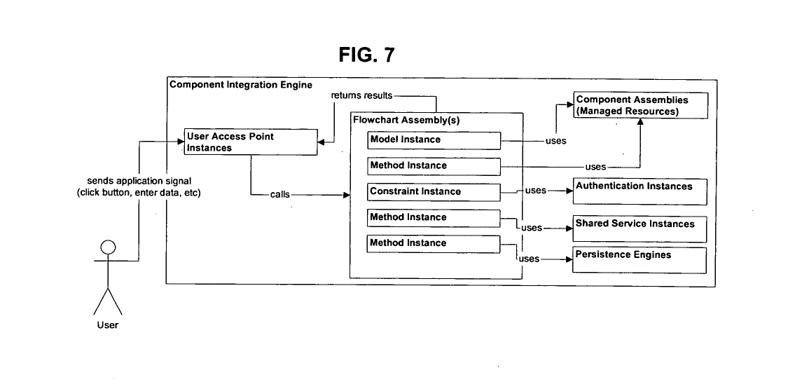

In FIG. 7, a user of a software application is unaware of the Component Integration Engine. The user accesses the software application through a user accesspoint, such as: a client-server program, a socket, a web page, an email message, etc. The user access point determines the correct flowchart assembly to invoke. The parts of this assembly are free to create new instances of any of the existing implementations, invoke operations, or use any of the shared services or resources. The results from the flowchart assembly are returned to the user access point and the display to the user is updated appropriately.

As shown in FIG. 7, a user sends an application signal by clicking a button, entering data, etc. to user access point instances of the Component Integration Engine. The user access point instances calls the flowchart assembly(s) and the flow chart assemblies return results to the user access point instances.

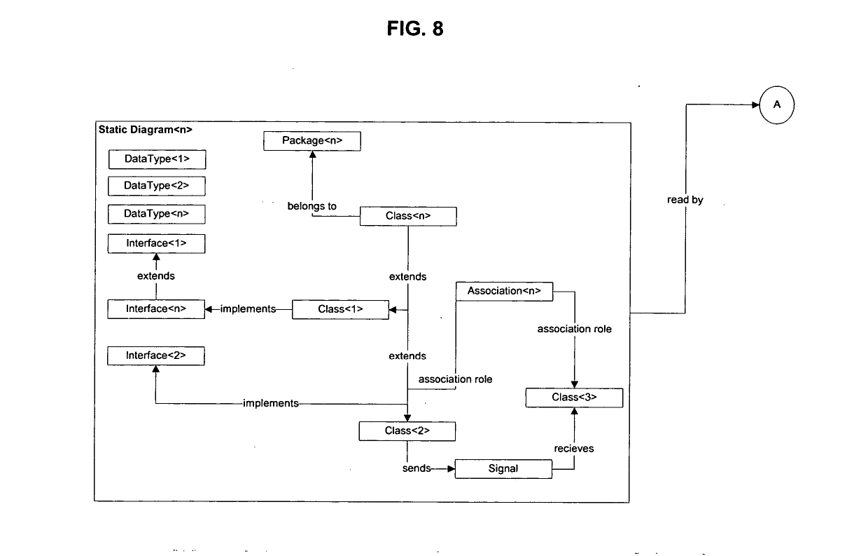

FIG. 8 is a static diagram showing the relationships between classifiers such as: interfaces, datatypes, models, etc. of the Component Integration Engine. One or more static diagrams may be converted to descriptors to be stored in the metamodel repository of the meta-implementation layer of the Component Integration Engine. To convert from UML to the metamodel repository, the metametamodel repository contains descriptions of the UMS metamodel elements.

In the following figure descriptions, the use of <1>, <2>, <n> following an element name in a figure indicates that zero-to-many instances of that named element may exist in the containing element. In some instances only the <1> and <n> or just the <n>appears; the same meaning is intended in these cases, but for reasons of space or clarity the <1> and <2> are omitted.

In the figures described below, “handler” refers to a component that understands a certain format of input and converts that input into the appropriate object structure as its output. In the figures described below, many handlers produce descriptors and source from an input object that has the same first part of the name as the descriptor but no following tag. These are “descriptions” originating from an external source and may vary in format. In one embodiment of the present invention, these external sources are UML documents or XMI documents. In another embodiment, these are text files in a predetermined format. In yet another embodiment, these are table structures in a database. It is only required, that these “descriptions” have a format understood by a handler designed for that format and contain data related to the descriptor the handler will produce.

Many simple handlers simply copy a string value from the description to the descriptor. Other handlers create a feature descriptor of the output descriptor and set attributes based on string values in the description. In this way, a description is converted a descriptor to participate in the meta-implementation layer.

Handlers mapping a descriptor to an implementation have a very well defined input and a very well defined output. The handler constructs the output implementation, then sets the attributes, signals, operations, etc. of that implementation based on the description given in the descriptor. In many cases, the handler is able to construct a fully functional implementation based on the descriptor. In cases where the descriptor is not fully defined, the handler will complete as much of the implementation as possible based on the available data and return a warning to the user. In this way, a descriptor is converted into an implementation to be used in the meta-implementation layer and component integration engine.

Several handlers occur repeatedly in the figures. The name handler simply copies a string of input representing a name to the appropriate attribute in the output. The documentation handler simply copies a string of input representing a description to the appropriate attribute in the output. The tagged values handler copies a pair of strings, one representing a name the other representing a value, to a hint instance with a name attribute and a value attribute. The constraint handler tries to interpret the description input to construct a constraint descriptor. In many cases, the input source is insufficient to construct a constraint descriptor. In these cases the constraint handler will simply construct a constraint descriptor with the appropriate name from the input description and as much detail as possible and warn the user of the incomplete constraint.

Some descriptions will contain a string representing the preferred language in which to be implemented. This string is unimportant in the context of a meta-implementation layer, but is preserved as a hint for code generators to convert the meta-implementation to compilable source code. The language string is used as the name of a pre-defined role containing zero-to-many hints used by these code generators.

Handlers dealing with input with the string “Type” in the name use the input string to lookup a datatype, interface, or model to use as the classifier type in the handler's output. The output consists of the identity of the type as the type is stored in the metamodel repository. Handlers dealing with input with the string “Kind” in the name use the input string to lookup a value in an enumeration. The name of the input generally matches the name of the enumeration and the value of the input matches the name of the value selected in the enumeration. For example, an “Owner scope” input with a value of “classifier” is used to lookup the “Owner scope” enumeration in the metamodel repository and select the “classifier” value from that enumeration as output from the handler. Several other predefined enumerations exist for use by the handlers including “Changeability”, “Visibility”, “Concurrency”, “Parameter Kind”, “Model Stereotype”, and “Operation Kind”. More enumerations may be defined by other embodiments of the present invention or by users of the present invention to handle other current and future descriptor inputs.

In some of the descriptors, the attribute name ends with the string “Indicator” or “Flag”. These attributes hold a Boolean (“true” or “false”) value. Handlers which create these outputs determine if the input represents a “true” value (“T”, “true”, “True”, 1, etc.) or a false value (“F”, “false”, “False”, 0, <null>, etc.) and set the attribute accordingly.

In the figures described below, implementations contain a pointer to the descriptor for which they are an implementation. By holding a descriptor, the implementation allows a user of the system to understand what the implementation does and why it does it. By providing its own metadata, the implementation allows a user to understand how the implementation does what it does. Instances also hold a pointer to the implementation that created them, allowing a user (human or otherwise) to retrieve the implementation and through the implementation retrieve the descriptor.

As shown in FIG. 8, Static Diagrams (Static Diagram<n>) include zero-to-many DataTypes (DataType<1>, DataType<2>, DataType<n>), zero-to-many Packages (Package<n>), zero-to-many Models (Model<1>, Model<2>, Model<n>), zero-to-many Interfaces (Interface<n>), zero-to-many Signals, and zero-to-many Associations. Each class (Class<n>) belongs to a single package (Package<n>). Some classes will implement interfaces (Class<1>, Interface<n>) but not all classes implement interfaces (Class<3>). Not all classes implement the same interfaces (Class<2> and Interface<2> and Class<1> and Interface<n>). Some classes participate in association relationships (Class<2>, Class<3>, Association<n>) but not all classes participate in association relationships (Class<1>). Some classes generate signals (Class<2>, Signal) but not all classes generate signals (Class<1>, Class<3>). Some classes receive signals (Class<3>), but not all classes receive signals (Class<2>, Class<1>). Although not pictured, classes may send or receive signals without necessarily being in an association relationship.

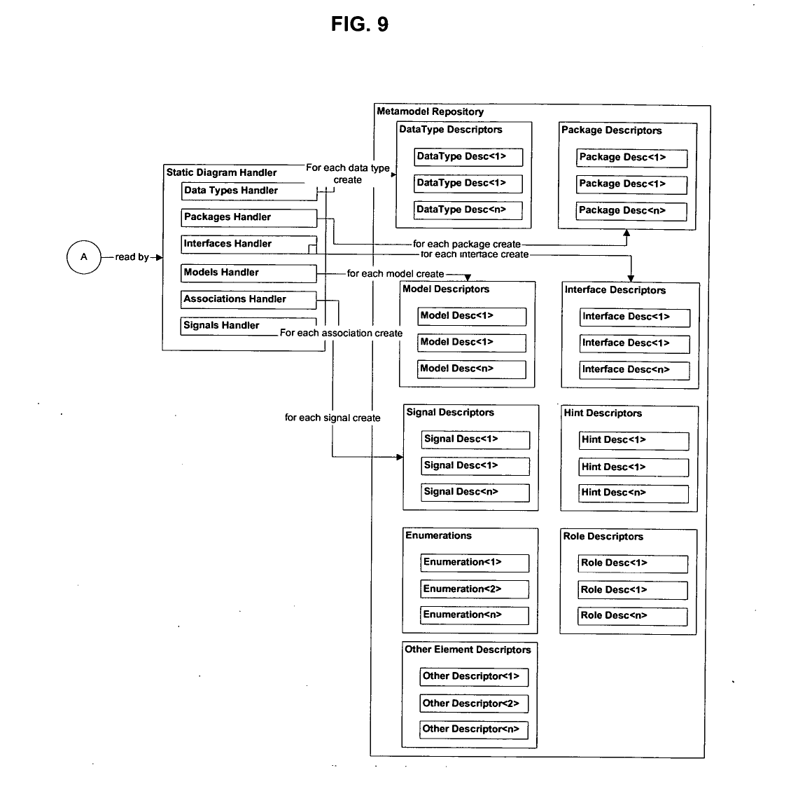

As shown in FIG. 9, the Metamodel Repository of the Component Integration Engine includes DataType Descriptors, Model Descriptors, Signal Descriptors, Enumerations, Other Element Descriptors, Package Descriptors, Interface Descriptors, Hint Descriptors, and Role Descriptors. As shown in FIG. 9, a Static Diagram Handler of the Component Integration Engine includes a DataTypes Handler, a Packages Handler, an Interfaces Handle, a Models Handler, an Associations Handler, and a Signals Handler.

As indicated by connector A of FIGS. 8 and 9, State Diagram<n> is read by Static Diagram Handler shown in FIG. 9. The static diagram handler is composed of a datatypes handler, packages handler, interfaces handler, models handler, associations handler, and signals handler. These handlers are described in the following sections. Each handler handles a specific description in the static diagram and creates the appropriate descriptor which is stored in the metamodel repository. The datatypes handler handles each datatype in the static diagram to create a datatype descriptor. The packages handler handles each package in the static diagram to create a package descriptor. The interfaces handler handles each interface in the static diagram to create an interface descriptor. The models handler handles each model in the static diagram to create a model descriptor. The signals handler handles each signal in the static diagram to create a signal descriptor. The associations handler handles each association in the static diagram to create a model descriptor which is a process entity for that association.

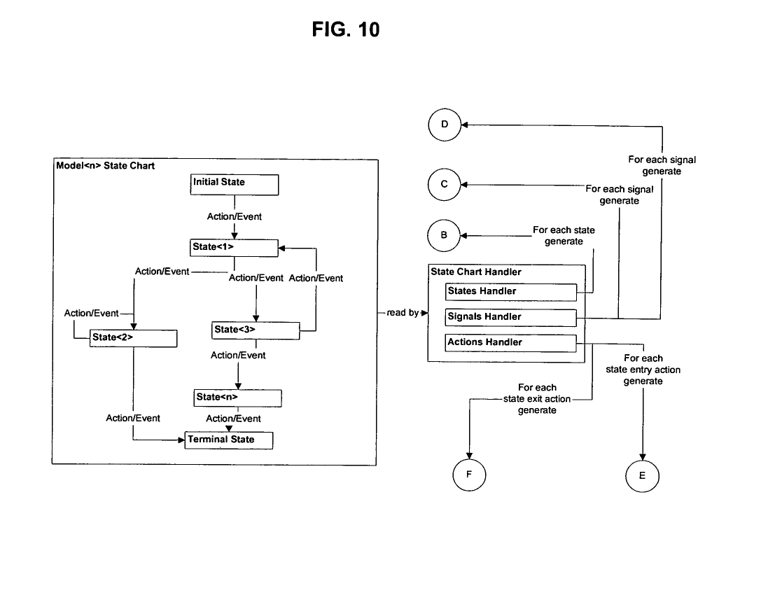

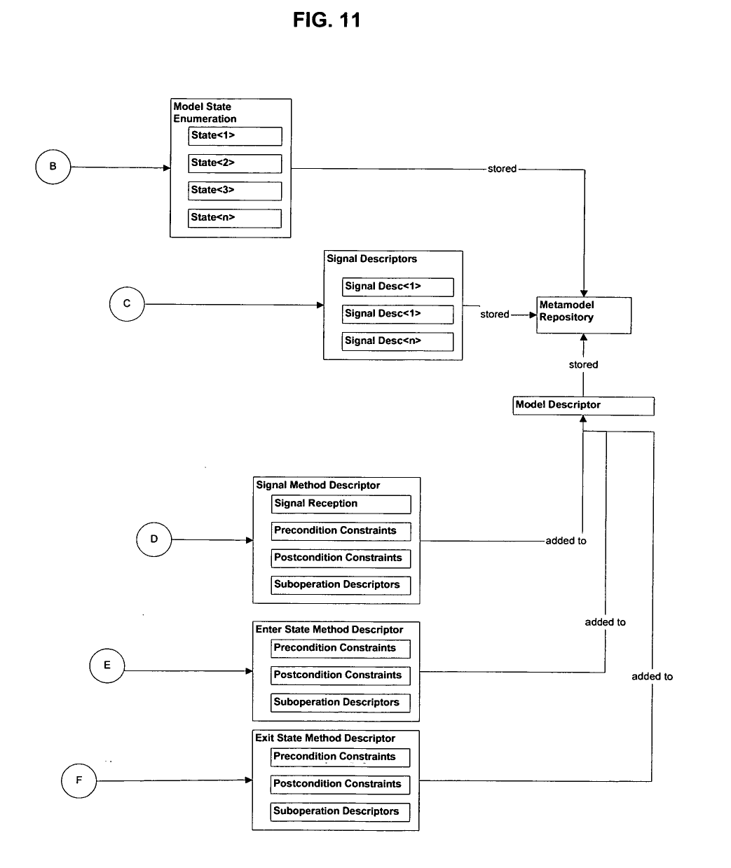

In FIGS. 10 and 11, the method to convert model state charts to model state enumerations and model operations is described. Each model state chart (Model<n> State Chart) may contain zero-to-many States (State<1>, State<2>, . . . , State<n>). Events trigger the change between one state and the next state (as indicated by “Action/Event” on the association connectors). When an event occurs triggering a state change one or more actions may be executed (as indicated by “Action/Event” on the association connectors). An action may be marked as an entry action for a state or as an exit action for a state. Actions may also contain zero-to-many subactions. A Model State Chart describes the allowable states into which a model can enter, the actions (operations) associated with entering that state, and the actions (operations) associated with exiting from that state.

In the Model<n> State Chart, events cause a state attribute to move between an Initial State, State<1>, State<2>, State<3>, State<n>, and a Terminal State. The Model<n> State Chart is read by a State Chart Handler that includes a States Handler, a Signals Handler, and an Actions Handler. As indicated by connector B in FIGS. 10 and 11, the States Handler generates an enumeration implementation with an enumeration value for each state. As indicated by connector C in FIGS. 10 and 11, the Signals Handler generates a signal descriptor for each signal. As indicated by connector D in FIGS. 10 and 11, the Signals Handler generates a signal method descriptor for each signal. As indicated by connector E of FIGS. 10 and 11, the Actions Handler generates an Enter State Method Descriptor for each entry action. As indicated by connector F of FIGS. 10 and 11, the Actions Handler generates an Exit State Method Descriptor for each state exit action. The Model State Enumeration and the Signals Descriptors are stored in the Metamodel repository of the Component Integration Engine. The Signal Method Descriptor, the Enter State Method Descriptor, and the Exit State Method Descriptor are each added to a Model Descriptor that, in turn, is stored in the Metamodel Repository.

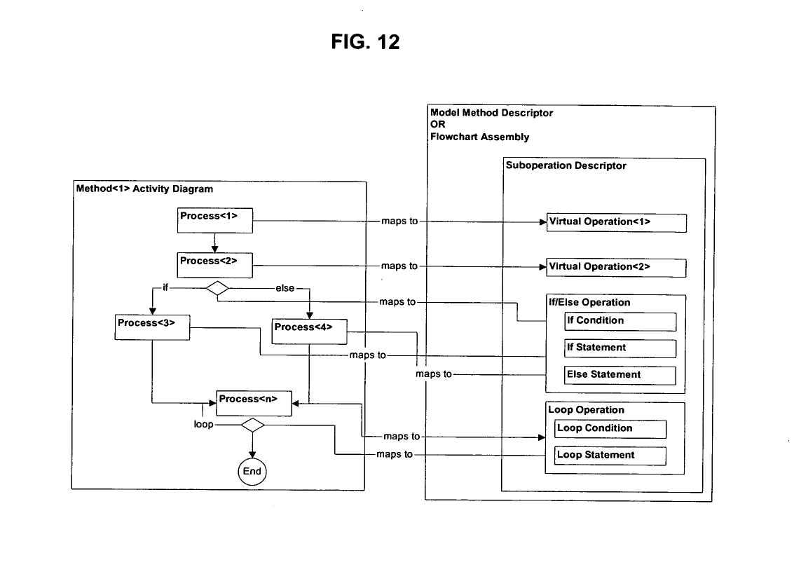

In FIG. 12 activity diagrams create method descriptors or flowchart assemblies. Some activity diagrams show the activity (operations) performed by a method (an operation which is a feature on a model). These activity diagrams are converted to Method descriptors and set on model descriptors as a method descriptor. Some activity diagrams show activity that is not specific to one model and are transformed into flowchart assemblies. Flowchart assemblies are simply component assemblies designed to perform a specific operation. Flowchart assemblies may use language construct operations such as: loops, branches, variables, etc. or may call static methods on models or instance methods on instances. As discussed previously, component assemblies are similar to models but have a shorter duration of use. Flowchart assemblies are given a name and saved in the component integration engine as a component assembly.

A Model Method Descriptor or Flowchart Assembly of the Component Integration Engine includes a Suboperation Descriptor including zero-to-many virtual operations (Virtual Operation<1>, a Virtual Operation<2>, an If/Else Operation, and Loop Operation). Some operations may control which other operations are executed (If/Else Operation) and others may control how many times other operations are executed (Loop Operation). As shown in FIG. 12, a Method<1> Activity Diagram includes a Process<1> that transfers control to a Process<2> when Process<1> terminates. If the If Condition of the If/Else Operation is satisfied, then Process<2> transfers control to Process<3> else Process<2> transfers control to Process<4>. After Process<3>, terminates, Process<3> transfers control to Process<n> After Process<4> terminates, Process<4> transfers control to Process<n>. Process<n> then loops upon itself until the Loop Condition of the Loop Operation is satisfied. Process<1> maps to Virtual Operation<1>. Process<2> maps to Virtual Operation<2>. The If/Else decision diamond between Process<3> and Process<4> maps to the If/Else Operation. Process<3> Maps to the If Statement of the If/Else Operation. Process<4> maps to the Else Statement of the If/Else operation. The decision diamond for the loop for Process<n> maps to the Loop Statement.

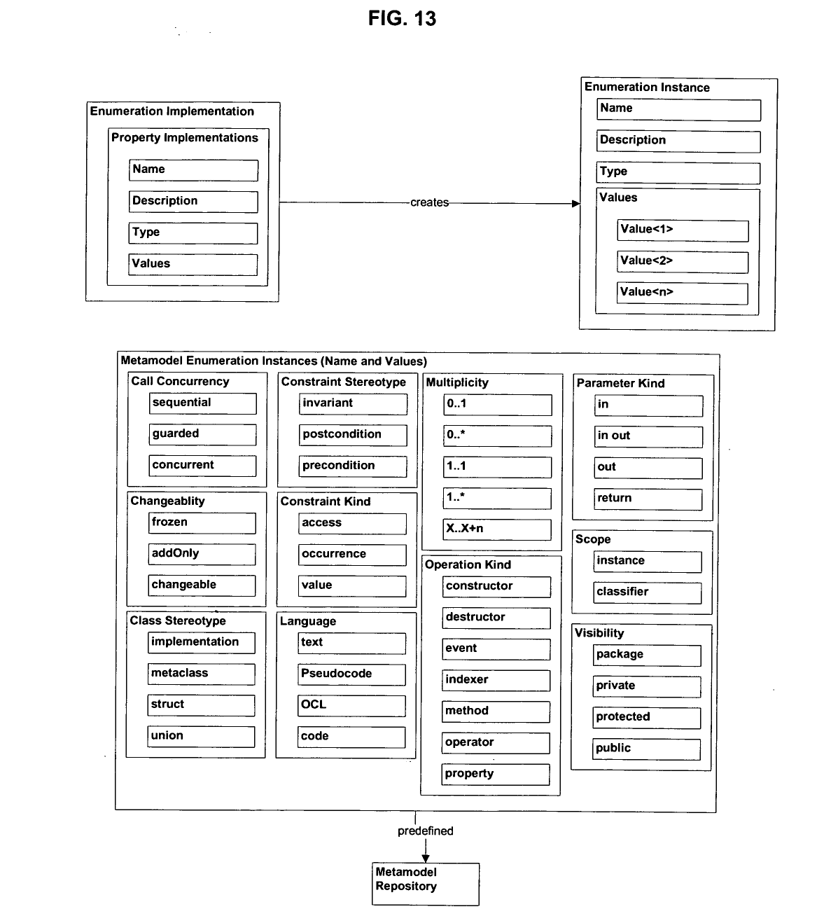

FIG. 13 illustrates some of the enumerations predefined in the metamodel repository of the component integration engine due to the enumerations' use of UML. New enumerations may be created and added just as with any other modeling element.

As shown in FIG. 13, an Enumeration Implementation creates an Enumeration Instance. The Enumeration Implementation includes the Attribute Implementations: Name, Description, Type and Values. The Enumeration Instance includes a Name, a Description, a Type and one or more values (indicated by Value<1>, Value<1>, and Value<n>).

Also as shown in FIG. 13, are the Metamodel Enumeration Instances of the Component Integration Engine: Call Concurrency, Changeability, Model Stereotype, Constraint Stereotype, Constraint Kind, Language, Multiplicity, Operation Kind, Parameter Kind, Scope, Visibility. The Metamodel Enumeration Instances are predefined by the Metamodel Repository. The metamodel repository allows for the definition of new enumerations, but predefines those enumerations related to the metamodeling process.

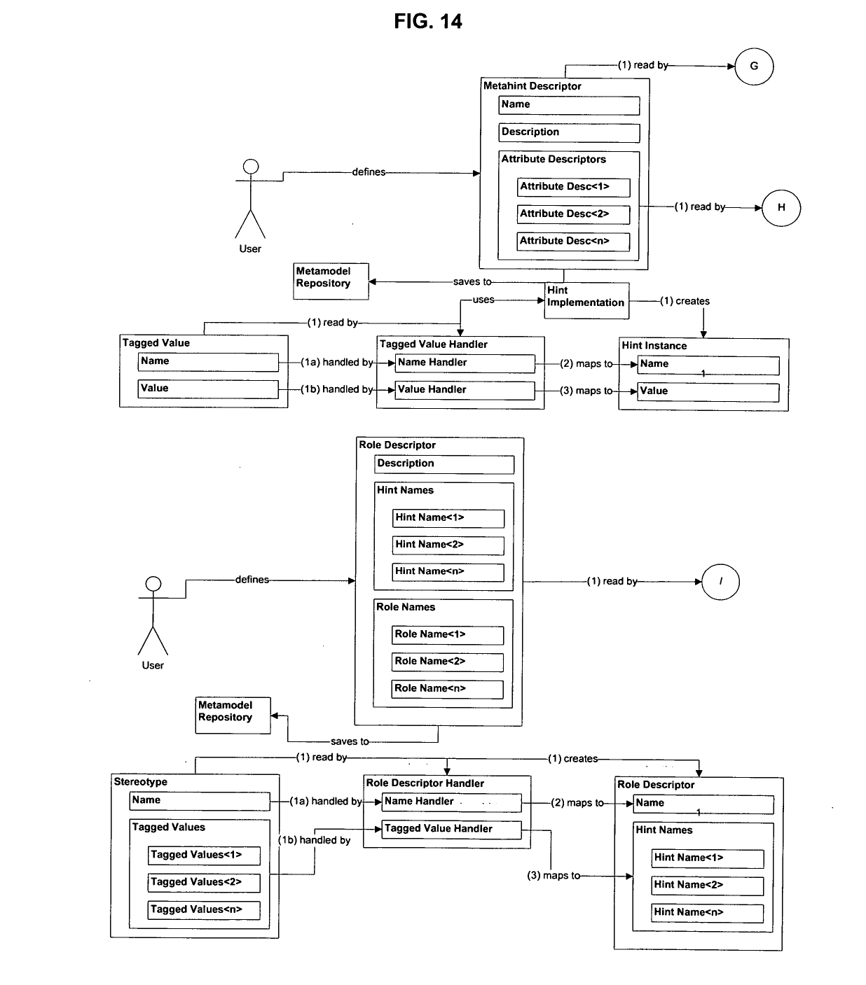

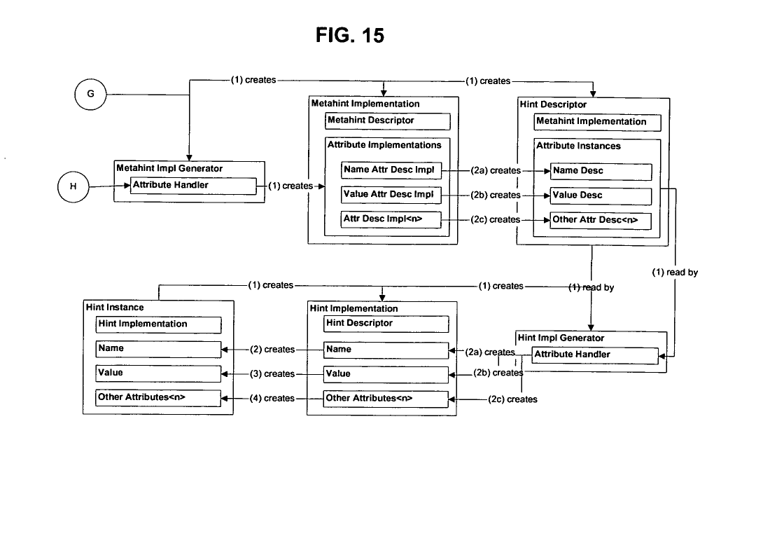

In FIG. 14, a user defines a Metahint Descriptor that includes a Name, a Description and Attribute Descriptors. This metahint descriptor is saved to the metamodel repository (specifically in the meta-metarepository section of the metamodel repository). As indicated by connector G of FIGS. 14 and 15, the Metahint Descriptor is read by a Metahint Impl(ementation) Generator, creates a Metahint Implementation, and creates a Hint Descriptor of FIG. 15. Instances of a metahint implementation are hint descriptors that describe the model used to describe a hint.

As indicated by connector H of FIGS. 14 and 15, the Attribute Descriptors are read by an Attribute Handler of the Metahint Impl Generator. In FIG. 15, the Attribute Handler of the Metahint Impl Generator creates Attribute Implementations of the Metahint Implementation. In addition to the Attribute Implementations, the Metahint Implementations includes the Metahint Descriptor it implements. The Name Attr(ibute) Impl(ementation) of the Attribute Implementations creates a Name of the Attribute Instances of the Hint Descriptor. The Value Attr(ibute) Impl(ementation) of the Attribute Implementations creates a Value of the Attribute Instances of the Hint Descriptor. Any other attribute implementations (Other Attr Impl) of the Attribute Implementations create attributes appropriately (Other Attribute<n>) in the Hint Descriptor. In addition to the Attribute Instances, the Hint Descriptor includes the Metahint Implementation of which Hint Descriptor is an instance.

The Hint Descriptor is read by the Hint Impl(ementation) Generator, which creates a Hint Implementation. An Attribute Handler of the Hint Impl Generator creates a Name, Value and other attributes (Other Attributes<n>) of the hint implementation. The Hint Implementation also includes the Hint Descriptor of which the Hint Implementation is an implementation. The Name, Value and Other Attributes of the Hint Implementation create the Name, Value and Other Attributes<n>, respectively of the Hint Instance. The Hint Instance also includes a pointer to the Hint Implementation that created it of which it an instance.

In FIG. 14, a Tagged Value description is read by a Tagged Value Handler to create a Hint Instance. The Tagged Value handler uses the appropriate Hint Implementation to create the Hint Instance then maps the Name and Value from the Tagged Value to the Name Attribute Instance and Value Attribute Instance held by the Hint Instance.

Although not shown in every figure of FIGS. 5-34, every descriptor is defined by a Meta<Element> descriptor just as pictured in the Metahint Descriptor of FIG. 14.

As shown in FIG. 14, a user defines a Role Descriptor including a Description, Hint Names and Role Names. As indicated by connector 1 of FIGS. 14 and 15, the Role Descriptor is ready by a Role Impl Generator of FIG. 15. The Role Descriptor is saved to the Metamodel Repository of the Component Integration Engine.

A Role Implementation of the Component Integration Engine includes a pointer to the Role Descriptor for which the Role Implementation is an implementation and looks up roles and looks up hints from the Metamodel Repository. The Metamodel Repository is used to lookup the Hint Implementation to create Hint Instances for each Hint Name held by the Role Implementation. The Metamodel Repository is also used to lookup the Role Implementation to create Role Instances for each Role Name held by the Role Implementation.

Also as shown in FIG. 14, a Stereotype is read by a Role Descriptor Handler and creates a Role Descriptor. A Name of the Stereotype is handled by a Name Handler of the Role Descriptor Handler to set the value of the Name Attribute Instance on the Role Descriptor. Tagged Values of the Stereotype are handled by a Tagged Value Handler of the Role Descriptor Handler to create the Hint Names of the Role Descriptor.

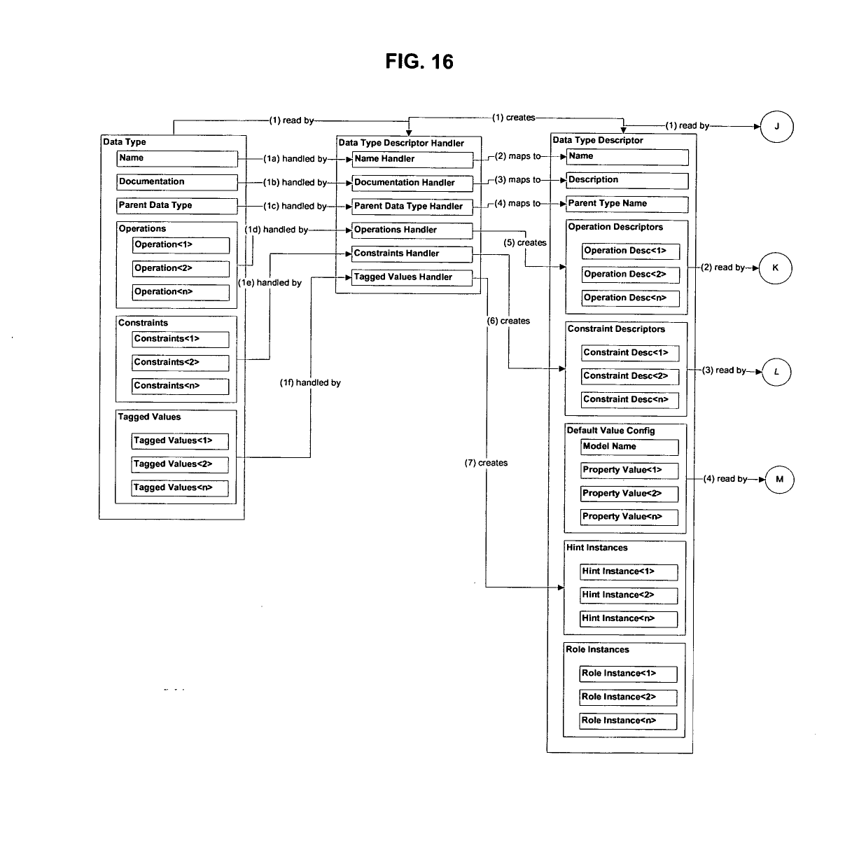

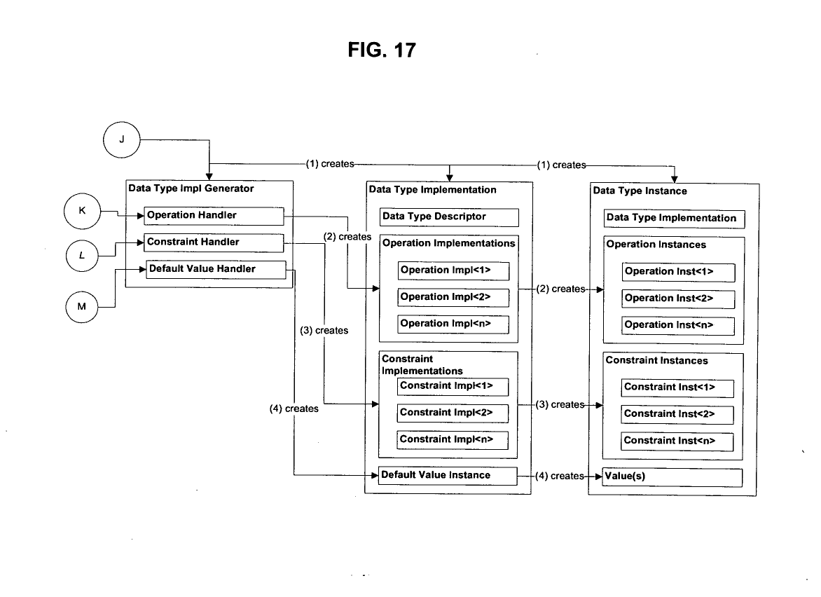

In FIGS. 16 and 17 a DataType is read by a DataType Descriptor Handler to create a DataType Descriptor. The data type descriptor is read by a DataType Impl(ementation) Generator, as indicated by connector J, to create a DataType Implementation. The DataType Implementation can then be used to create DataType Instances. A Name, Documentation, a Parent DataType, Operations, Constraints and Tagged Values of the DataType are handled by a Name Handler, a Documentation Handler, a Parent DataType Handler, an Operations Handler, a Constraints Handler and a Tagged Values Handler, respectively, of the DataType Description Handler. The Name Handler of the DataType Descriptor Handler handles the Name of the DataType Descriptor. The Documentation Handler of the DataType Descriptor Handler handles the Description of the DataType Descriptor. The Parent DataType Handler of the DataType Descriptor Handler handles the Parent Type Name of the DataType Descriptor. The Operations Handler of the DataType Descriptor Handler creates the Operation Descriptors of the DataType Descriptor. The Tagged Values Handler of the DataType Descriptor Handler creates the Hint Instances of the DataType Descriptor.

The Operations Descriptor is read by the Operations Handler of the DataType Impl Generator as indicated by connector K. The Constraint Descriptors are read by the Constraint Handler of the DataType Impl Generator, as indicated by connector L. The Initial Value Config(uration) of the DataType Descriptor is read by the Initial Value Handler, as indicated by connector M. The DataType Descriptor also includes Role Instances added by a user to further capture details about the datatype which are not adequately captured anywhere else.

The Operation Handler of the DataType Impl Generator creates the Operation Implementations of the DataType Implementation. The Constraint Handler of the DataType Impl Generator creates the Constraint Implementations of the DataType Implementation. The Initial Value Handler of the DataType Impl Generator creates the Initial Value Instance of the DataType Implementation. The DataType Implementation also includes a pointer to the DataType Descriptor of which the DataType Implementation is an implementation.

The Operation Implementations of the DataType Implementation creates Operation Instances of the DataType Instance. The Constraint Implementations of the DataType Implementation create Constraint Instances of the DataType Instance. The Initial Value Instance creates Value(s) of the DataType Instance. The DataType Instance also includes a pointer to the DataType Implementation of which the DataType Instance is an instance.

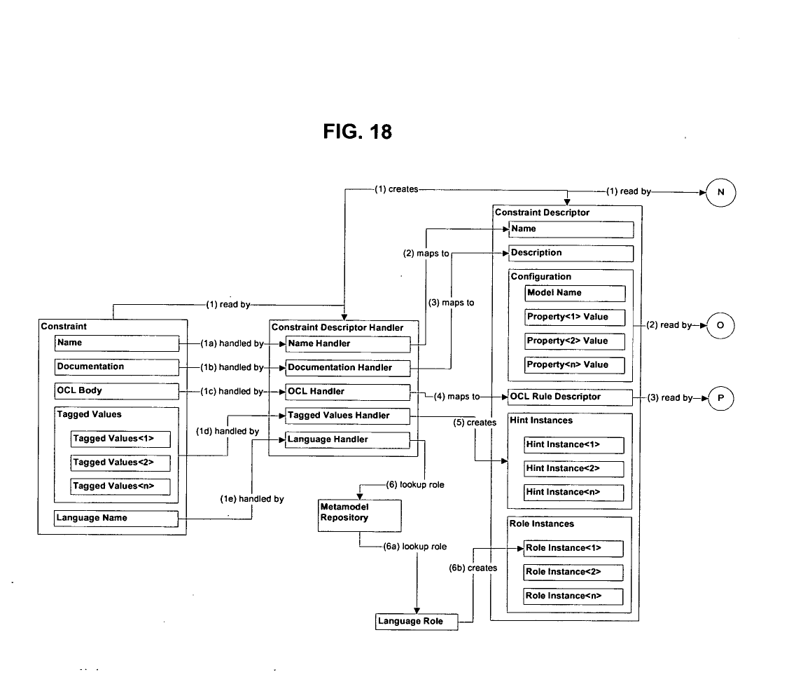

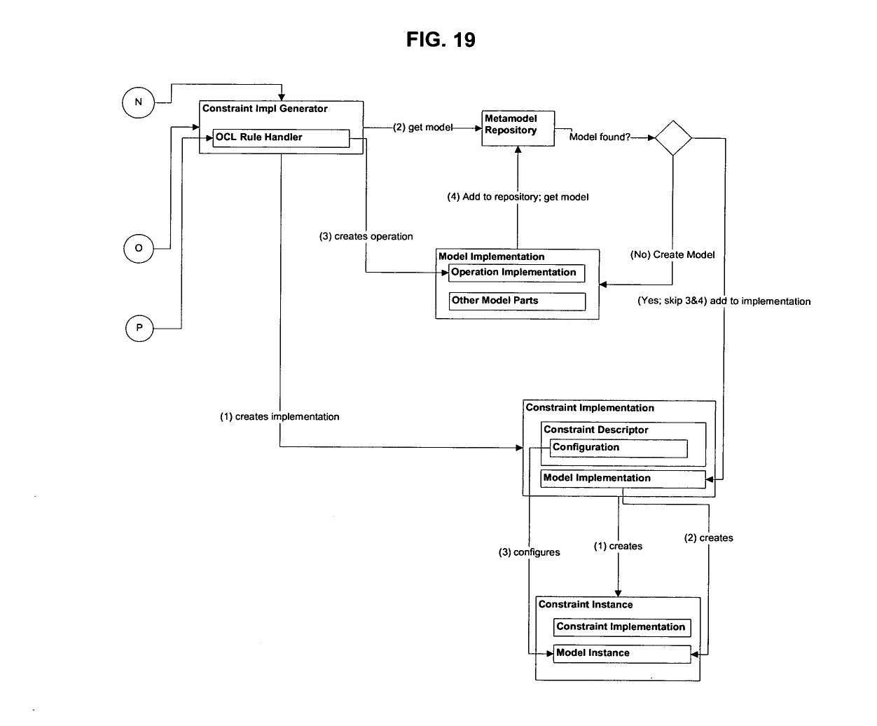

In FIGS. 18 and 19 a Constraint is read by a Constraint Descriptor Handler to create a Constraint Descriptor. The constraint descriptor is read by the Constraint Impl(ementation) Generator, as indicated by connector N to create a Constraint Implementation. The Constraint Implementation can then be used to create Constraint Instances. A Name, Documentation, an OCL Body, and Tagged Values of the Constraint description are handled by the Name Handler, Documentation Handler, OCL Handler, Tagged Value Handler, and Language Handler, respectively, of the Constraint Descriptor Handler.

The Name Handler, Documentation Handler and OCL Handler of the Constraint Descriptor Handler map to the Name, Description and OCL Rule Descriptor, respectively, of the Constraint Descriptor. The Tagged Values Handler of the Constraint Descriptor Handler creates Hint Instances of the Constraint Descriptor. The Language Handler of the Constraint Descriptor Handler looks up a role in the Metamodel Repository for the language named by the language name description. The language handler retrieves the Role Implementation for that language and uses it to create one of the Role Instances of the Constraint Descriptor. The language role may be used by code-generators to generate source code from the Constraint Descriptor in the appropriate language. The language role may contain one or more hint instances to aid the code-generation process.

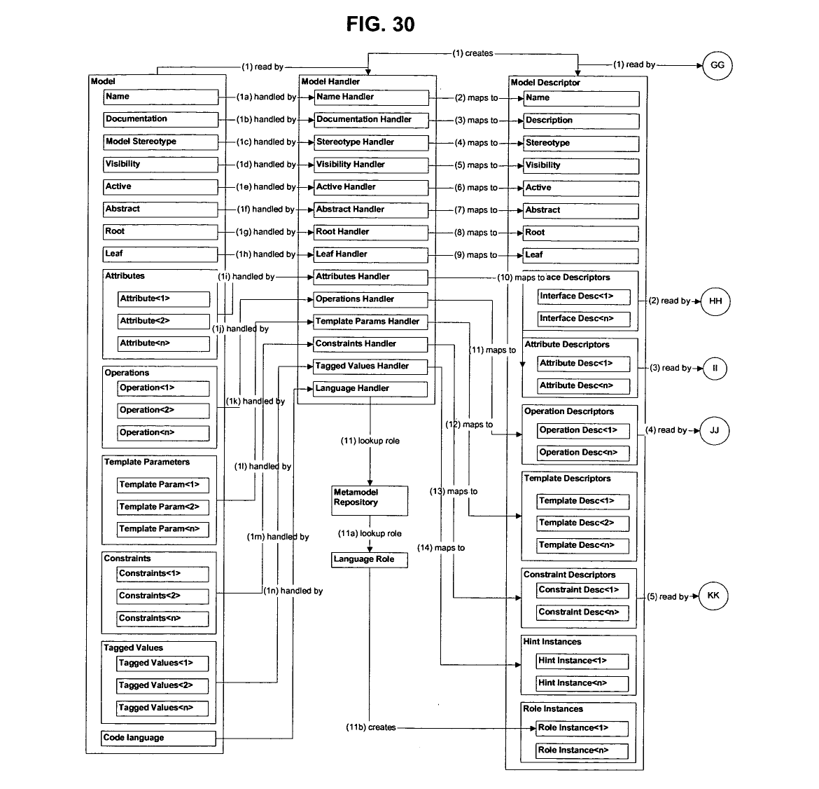

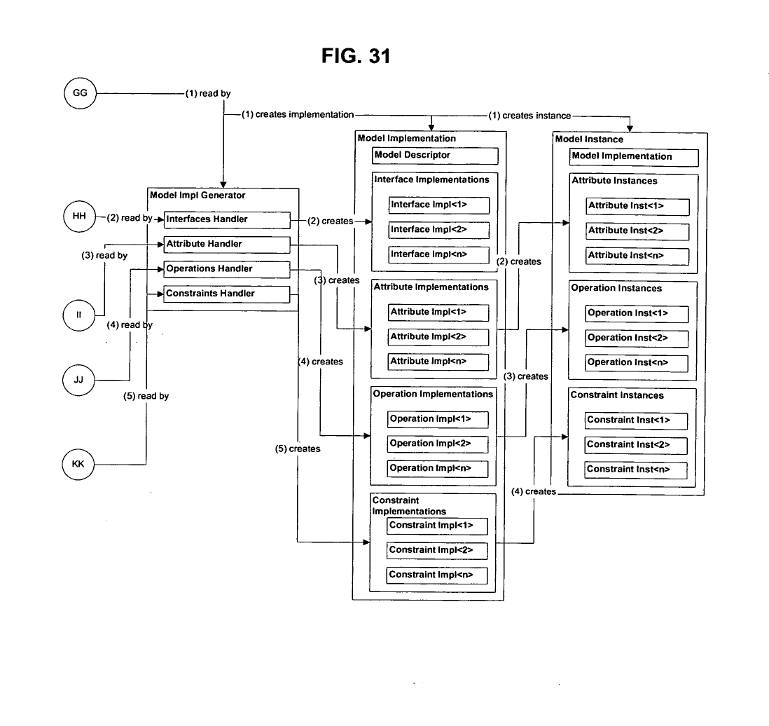

The Configuration of the Constraint Descriptor is read by the Constraint Impl Generator, as indicated by connector O. The OCL rule Descriptor is read by the OCL Rule Handler of the Constraint Impl Generator. The Constraint Impl Generator gets a model from the Metamodel Repository. If the model is found, an implementation is added to the Model Implementation of the Constraint Implementation. If no model is found, a model is created in the Model Implementation. The Model Implementation then adds the Model to the Metamodel Repository. The OCL Rules Handler of the Constraint Impl Generator creates an operation in the Operation Implementation of the Model Implementation. In one embodiment of the present invention, an OCL parser interprets the OCL language to construct virtual operations corresponding to the OCL language. The Model Implementation also includes Other Model Parts as described in the Model Implementations described in FIG. 30 and FIG. 31.

In FIG. 18, the Constraint Implementation includes a pointer to the Constraint Descriptor for which the Constraint Implementation is an implementation. During the creation process, the constraint implementation uses the Model Implementation to create the Model Instance used by the Constraint Instance. The constraint implementation uses the configuration from this constraint descriptor when creating constraint instances to configure the model instance held by the constraint instance. The Constraint Instance also includes a pointer to the Constraint Implementation that created it of which the Constraint Instance is an instance.

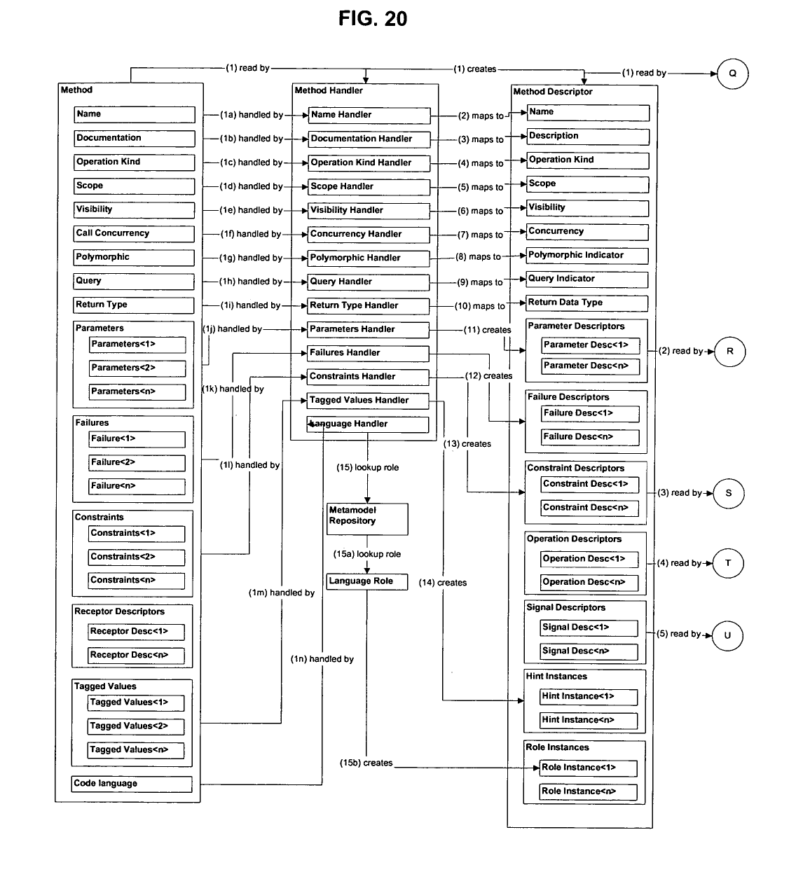

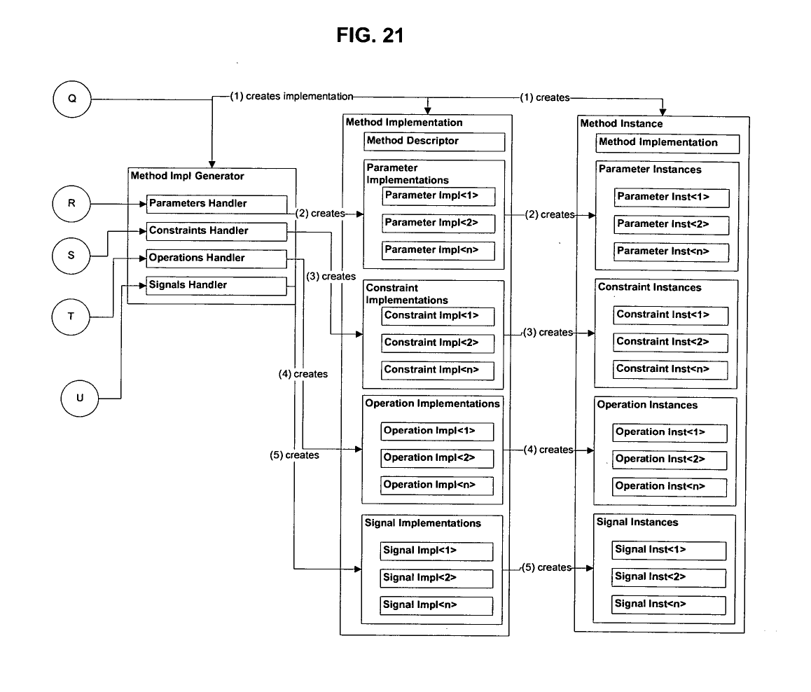

In FIGS. 20 and 21, a Method description is read by a Method Handler to create a Method Descriptor. The method descriptor is read by a Method Impl(ementation) Generator, as indicated by connector Q, to create a Method Implementation. The Method Implementation can then be used to create a Method Instance. A Name, Documentation, an Operation Kind, a Scope, Visibility, Call Concurrency, Polymorphic, Query, Return Type, Parameters, Failures, Constraints, Receptor Descriptors, Tagged Values and Code Language in the Method description are handled by a Name Handler, Documentation Handler, Operation Kind Handler, Scope Handler, Visibility Handler, Concurrency Handler, Polymorphic Handler, Query Handler, Return Type Handler, Parameters Handler, Failures Handler, Constraints Handler, Tagged Values Handler, and Language Handler, respectively, of the Method Handler. The Name Handler, Documentation Handler, Operation Kind Handler, Scope Handler, Visibility Handler, Concurrency Handler, Polymorphic Handler, Query Handler, and Return Type Handler of the Method Handler map to the Name, Description, the Operation Kind, the Scope, the Visibility, the Concurrency, the Polymorphic Indicator, the Query Indicator, and the Return DataType Indicator, respectively, of the Method Descriptor. The Parameters Handler, Failures Handler, Constraints Handler, Tagged Values Handler, and Language Handler of the Method Handler create the Parameter Descriptors, the Failure Descriptors, the Constraint Descriptors, the Hint Instances, and the Role Instances, respectively, of the Method Descriptor.

The Parameter Descriptors, Constraint Descriptors, the Operation Descriptors, and the Signal Descriptors of the Method Descriptor are read by the Parameters Handler, as indicated by connector R, by the Constraints Handler, as indicated by connector S, by the Operations Handler, as indicated by connector T, and by the Signals Handler as indicated by the connector U, respectively, of the Method Impl Generator. The Parameters Handler, the Constraints Handler, the Operations Handler, and the Signals Handler of the Method Impl Generator create the Parameter Implementations, the Constraint Implementations, the Operation Implementations and the Signal Implementations, respectively, of the Method Implementation. The Method Implementation also includes a pointer to the Method Descriptor of which the Method Implementation is an implementation.

The Parameter Implementations, the Constraint Implementations, the Operation Implementations and the Signal Implementations of the Method Implementation create the Parameter Instances, the Constraint Instances, the Operations Instances, and the Signal Instances, respectively, of the Method Instance. The Method Instance also includes a pointer to the Method Implementation of which the Method Instance is an instance.

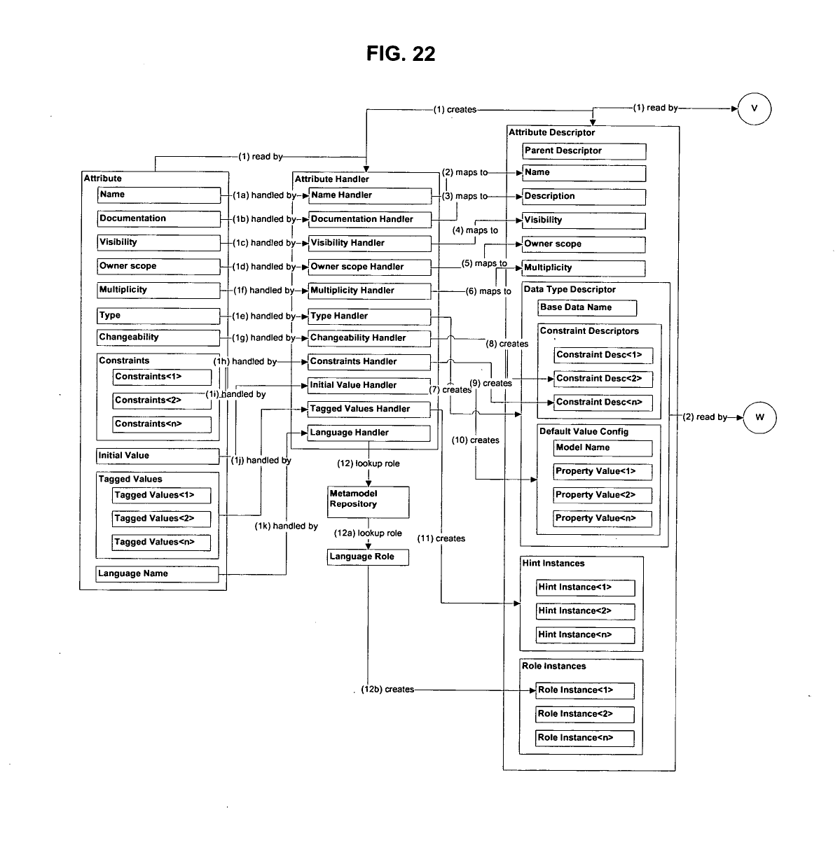

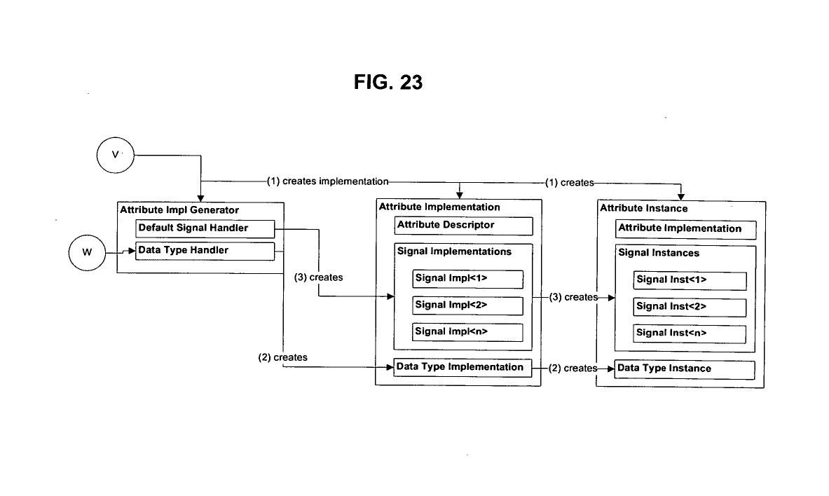

In FIGS. 22 and 23, an Attribute is read by an Attribute Handler to create an Attribute Descriptor. The attribute descriptor is read by an Attribute Impl(ementation) Generator, as indicated by connector V, to create an implementation of the an Attribute Implementation. The Attribute Implementation can be used to create Attribute Instances. A Name, Documentation, Visibility, Owner Scope, Multiplicity, Type, Changeability, Constraints, an Initial Value, Tagged Values and a Language Name of the Attribute description are handled by a Name Handler, a Documentation Handler, a Visibility Handler, an Owner Scope Handler, a Multiplicity Handler, a Type Handler, a Changeability Handler, a Constraints Handler, an Initial Value Handler, a Tagged Values Handler, and a Language Handler, respectively, of the Attribute Handler.

The Name Handler, Documentation Handler, Visibility Handler, Owner Scope Handler, and Multiplicity Handler of the Attribute Handler map to a Name, Description, Visibility, Owner Scope and Multiplicity, respectively, of the Attribute Descriptor. The Type Handler creates the Datatype Descriptor of the Attribute Descriptor. The Changeability Handler used the Attribute Changeability Enumeration, which is predefined in the metamodel repository, to create an access constraint to prevent certain types of changes to the attribute instances. The constraints handler creates constraint descriptors and the tagged values handler creates hint instances. The language handler reads in the name of a language to create a role descriptor used by code generators for that specific language. The initial value handler converts its input into a configuration for constructing an instance of the initial value. Generally, descriptions from an external source will limit initial values to primitives or strings so a configuration is not strictly necessary. The present invention does not impose the same limitations on the initial value, so a configuration is necessary when the initial value is a more complex datatype or model. The Attribute Descriptor also includes a Parent Descriptor which is a pointer to the classifier which holds the attribute descriptor as a feature.

The DataType Descriptor of the Attribute Descriptor includes a Base Data Name, the Constraint Descriptors, and the Initial Value Config. The DataType Descriptor of the Attribute Descriptor is also read by a DataType Handler of the Attribute Impl Generator, as indicated by connector W.

A Default Signal Handler of the Attribute Impl Generator creates Signal implementations of the Attribute Implementation. The default signal handler creates signals commonly generated by attributes during access and modification. The DataType Handler of the Attribute Impl Generator creates a DataType Implementation of the Attribute Implementation. The Attribute Implementation also includes a pointer to the Attribute Descriptor of which the Attribute Implementation is an implementation.

The Signal Implementations and DataType Implementations of the Attribute Implementation create Signal Instances and DataType Instances, respectively, of the Attribute Instance. The Attribute Instance also includes a pointer to the Attribute Implementation of which the Attribute Instance is an instance.

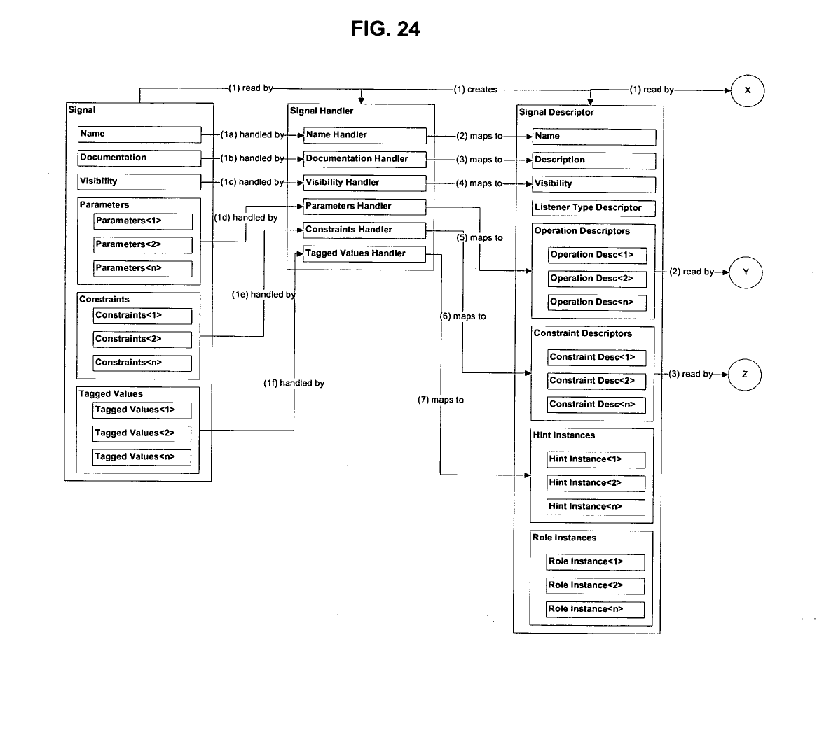

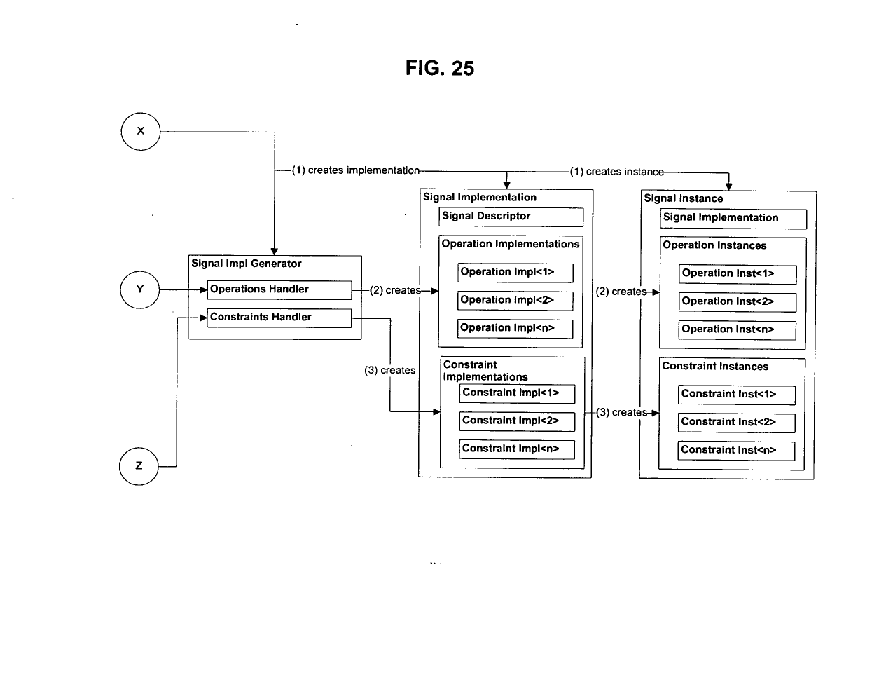

In FIGS. 24 and 25, a Signal is read by a Signal Handler, to create a Signal Descriptor. The Signal Descriptor is read by a Signal Impl(ementation) Generator, as indicated by connector X, to create a Signal Implementation. The signal implementation can then create Signal Instances. A Name, Documentation, Visibility, Parameters, Constraints, and Tagged Values of the Signal description are handled by a Name Handler, a Documentation Handler, a Visibility Handler, a Parameters Handler, a Constraints Handler, and a Tagged Values Handler, respectively, of the Signal Handler.

The Name Handler, Documentation Handler, Visibility Handler, Parameters Handler, Constraints Handler, and Tagged Values Handler of the Signal Handler map to a Name, Description, Visibility, Operations Descriptors, Constraint Descriptors, and Hint Instances, respectively, of the Signal Descriptor. The Signal Descriptor also includes a Listener type Descriptor and Role Instances.

The Operation Descriptors and Constraint Descriptors of the Signal Descriptor are read by an Operations Handler, as indicated by connector Y, and a Constraints Handler, as indicated by a connector Z, respectively, of the Signal Impl Generator. The Operations Handler, and the Constraints Handler of the Signal Impl Generator create Operation Implementations and Constraint Implementations, respectively, of the Signal Implementation. The Signal Implementation also includes a pointer to the Signal Descriptor of which the Signal Implementation is an implementation.

The Operation Implementations and Constraint Implementations of the Signal Implementation create the Operation Instances and Constraint Instances of the Signal Instance. The Signal Instance also includes a pointer to the Signal Implementation of which the Signal Instance is an instance.

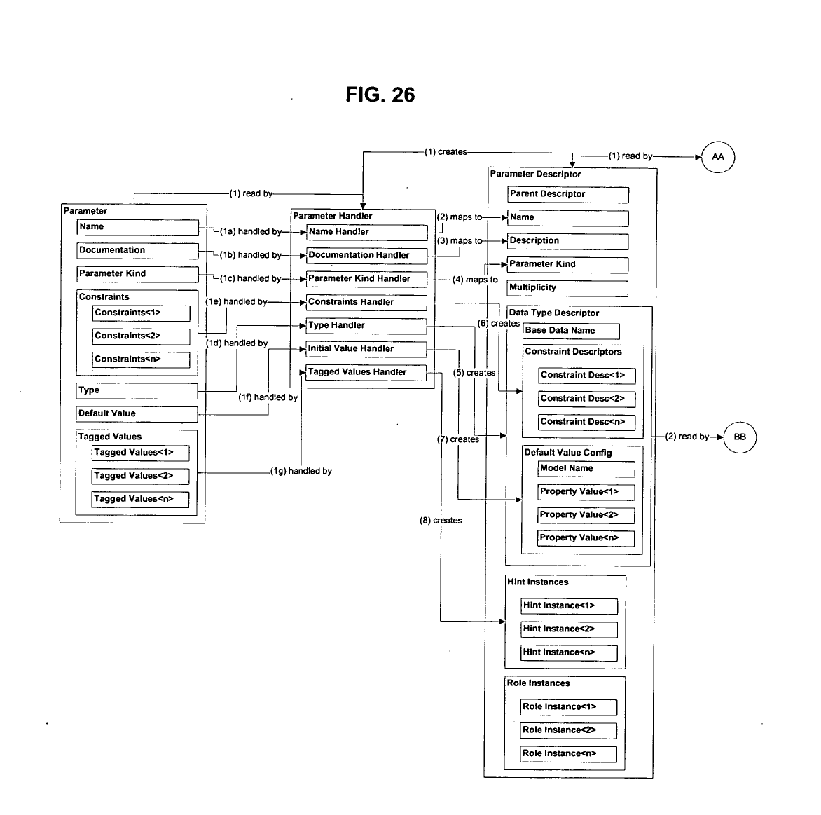

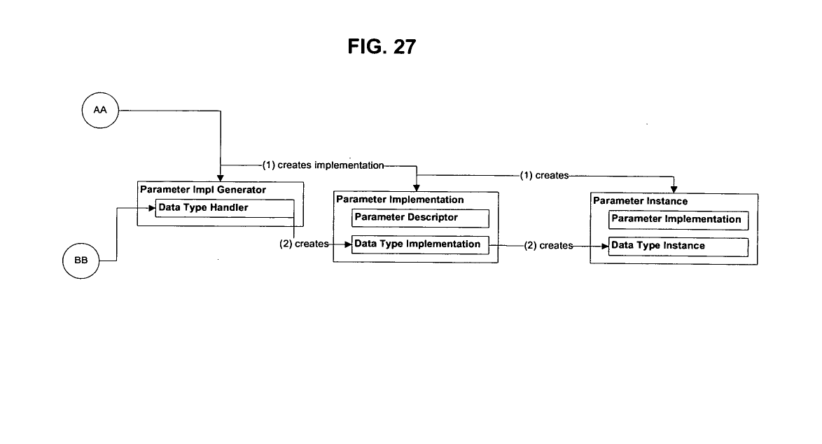

In FIGS. 26 and 27, a Parameter is read by a Parameter Handler, creates a Parameter Descriptor, is read by a Parameter Impl(ementation) Generator, as indicated by connector AA, creates an implementation of a Parameter Implementation, and creates a Parameter Instance. A Name, Documentation, Parameter Kind, Constraints, type, Default Value and Tagged Values of the Parameter are handled by a Name Handler, a Documentation Handler, a Parameter Kind Handler, a Constraints Handler, a Type Handler, an Initial Value Handler, and a Tagged Values Handler, respectively, of the Parameter Handler.

The Name Handler, Documentation Handler, and Parameter Kind Handler map to a Name, Description, and Parameter Kind, respectively, of the Parameter Descriptor. The Constraints Handler, Type Handler, Initial Value Handler, and Tagged Value Handler of the Parameter Handler create the Constraint Descriptors of the DataType Descriptor, the Default Value Config(uration) of the DataType Descriptor, and the Hint Instances of the Parameter Descriptor The Parameter Descriptor also includes a Parent Descriptor, Multiplicity, and Role Instances and the DataType Descriptor also includes a Base Data Name.

The DataType Descriptor is read by a DataType Handler of the Parameter Impl Generator, as indicated by connector BB.

The DataType Handler of the Parameter Impl Generator creates a DataType Implementation of the Parameter Implementation. The Parameter Implementation also includes a pointer to the Parameter Descriptor of which the Parameter Implementation is an implementation.

The DataType Implementation of the Parameter Implementation creates a DataType Instance of the Parameter Instance. The Parameter Instance also includes a pointer to the Parameter Implementation of which the Parameter Instance is an instance.

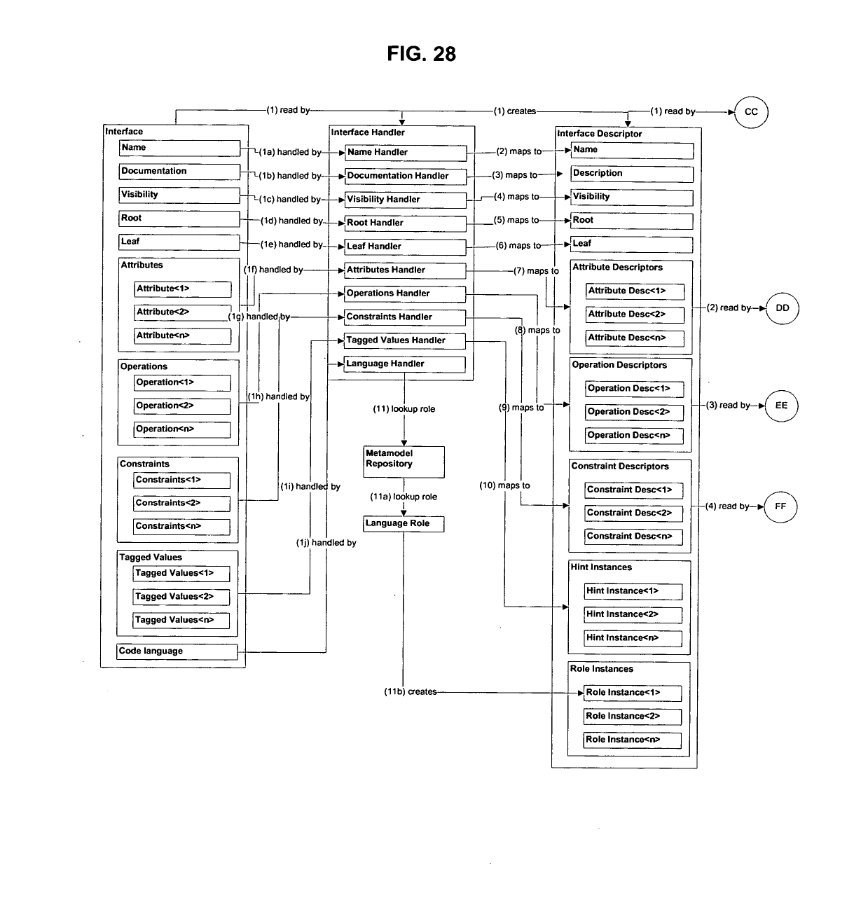

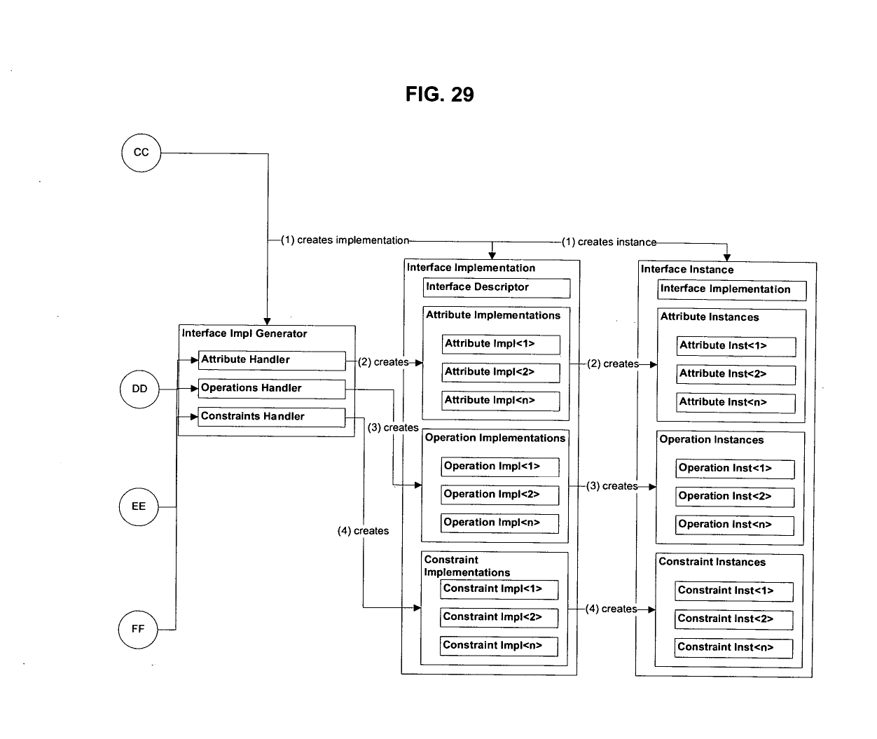

In FIGS. 28 and 29, an Interface is read by an Interface Handler, creates an Interface Descriptor, is read by an Interface Impl(ementation) Generator, as indicated by connector CC, creates an implementation of an Interface Implementation, and creates an Interface Instance. A Name, Documentation, Visibility, Root, Leaf, Attributes, Operations, Constraints, Tagged Values, and Code Language of the Interface are handled by a Name Handler, a Documentation Handler, a Visibility Handler, a Root Handler, a Leaf Handler, an Attributes Handler, an Operations Handler, a Constraints Handler, a Tagged Values Handler, and a Language Handler, respectively, of the Interface Handler.

The Name Handler, Documentation Handler, Visibility Handler, Root Handler, Leaf Handler, Attributes Handler, Operations Handler, Constraints Handler, and Tagged Values Handler, map to the Name, Description, Visibility, Root, Leaf, Attribute Descriptors, Operation Descriptors, Constraint descriptors and Hint Instances, respectively, of the Interface Descriptor. The Language Handler of the Interface Handler looks up a role in the Metamodel Repository. The Language Handler uses the Metamodel Repository to lookup up a role in the Language Role that creates an instance of the language role (Role Instance<1>) of Role Instances of the Interface Descriptor.

The Attribute Descriptors, Operation Descriptors, and Constraint Descriptors are read by an Attribute Handler, as indicated by connector DD, by an Operations Handler, as indicated by connector EE, and by a Constraints Handler, as indicated by connector FF, respectively, of the Interface Impl Generator.

The Attribute Handler, Operation Handler and Constraints Handler of the Interface Impl Generator create Attribute Implementations, Operation Implementations, and Constraint Implementations, respectively, of the Interface Implementation. The Interface Implementation also includes a pointer to the Interface Descriptor of which the Interface Implementation is an implementation.

The Attribute Implementations, Operation Implementations, and Constraint Implementations of the Interface Implementation create Attribute Instances, Operation Instances, and Constraint Instances, respectively, of the Interface Instance. The Interface Instance also includes a pointer to the Interface Implementation of which the Interface Instance is an instance.

In FIGS. 30 and 31, a Model is read by a Model Handler, creates a Model Descriptor, is read by a Model Impl(ementation) Generator, as indicated by connector GG, creates an implementation of a Model Implementation, and creates an instance of a Model Instance. A Name, Documentation, Visibility, Active, Abstract, Root, Leaf, Attributes, Operations, Template Parameters, Constraints, Tagged Values, and Code Language of the Model are handled by a Name Handler, a Documentation Handler, a Stereotype Handler, a Visibility Handler, an Active Handler, an Abstract Handler, a Root Handler, a Leaf Handler, an Attributes Handler, an Operations Handler, a Template Parameters Handler, a Constraints Handler, a Tagged Values Handler, and a Language Handler, respectively, of the Model Handler.

The Name Handler, Documentation Handler, Stereotype Handler, Visibility Handler, Active Handler, Abstract Handler, Root Handler, Leaf Handler, Attributes Handler, Operations Handler, Template Parameters Handler, Constraints Handler, and Tagged Values Handler, map to the Name, Description, Stereotype, Visibility, Active, Abstract, Root, Leaf, Interface Descriptors, Attribute Descriptors, Operation Descriptors, Constraint Descriptors and Hint Instances, respectively, of the Model Descriptor. The Language Handler of the Model Handler looks up a role in the Metamodel Repository. The Model Handler uses the Metamodel Repository to lookup up a role in the Language Role that creates an instance of the language role (Role Instance<1>) of Role Instances of the Model Descriptor.

The Interface Descriptors, Attribute Descriptors, Operation Descriptors, and Constraint Descriptors are read by an Interface Handler, as indicated by connector HH, by an Attribute Handler, as indicated by connector II, by an Operations Handler, as indicated by connector JJ, and by a Constraints Handler, as indicated by connector KK, respectively, of the Model Impl Generator.

The Interfaces Handler, Attribute Handler, Operation Handler and Constraints Handler of the Model Impl Generator create Interface Implementations, Attribute Implementations, Operation Implementations, and Constraint Implementations, respectively, of the Model Implementation. The Model Implementation also includes a pointer to the Model Descriptor of which the Model Implementation is an implementation.

The Attribute Implementations, Operation Implementations, and Constraint Implementations of the Model Implementation create Attribute Instances, Operation Instances, and Constraint Instances, respectively, of the Model Instance. The Model Instance also includes a pointer to the Model Implementation of which the Model Instance is an instance.

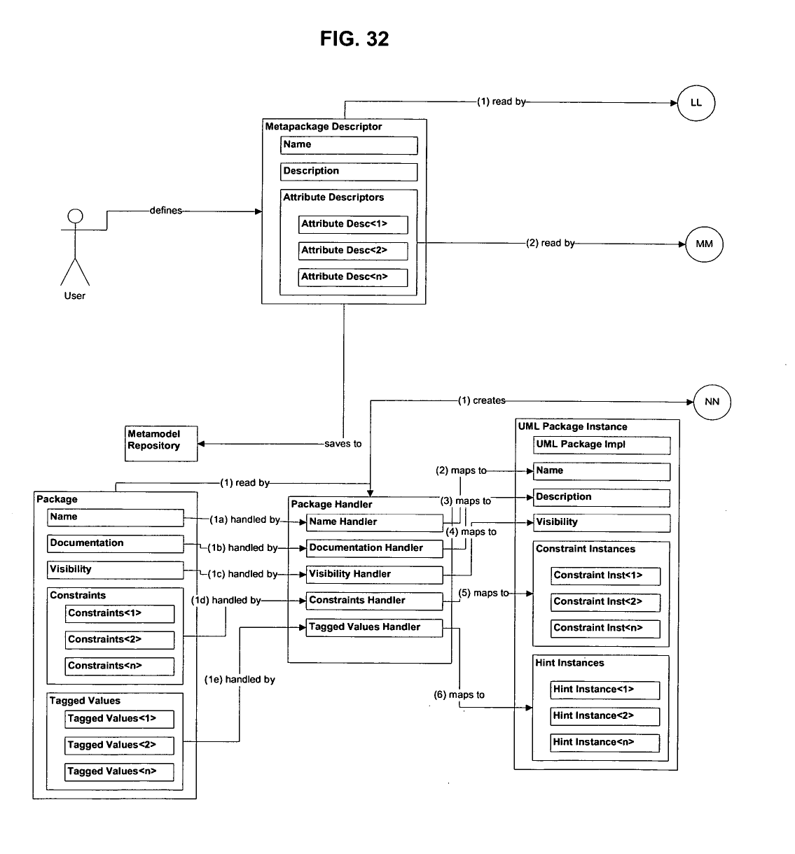

In FIGS. 32, 33 and 34 a user defines a Metapackage Descriptor including a Name, a Description and Attribute Descriptors. The Metapackage descriptor is read by a Metapackage Impl(ementation) Generator, as indicated by connector LL, creates a Metapackage Implementation, which creates a Metapackage Instance which is synonymous with a Package Descriptor, as indicated by connector 00, respectively. Attribute Descriptors of the Metapackage Descriptor are read by an Attribute Handler, as indicated by connector MM, of the Metapackage Impl Generator. The Metapackage Descriptor saves to the Metamodel Repository (specifically the meta-metamodel repository section of the metamodel repository).

A Package is read by a Package Handler, creates a Package Descriptor, creates a Package Instance, as indicated by connector NN, creates a Package Implementation, creates a Package Impl(ementation) Generator, and is read by a Package Descriptor, as indicated by connector UU, respectively. A Name, Documentation, Visibility, Constraints, and Tagged Values, of the Package are handled by a Name Handler, a Documentation Handler, a Visibility Handler, a Constraints Handler, and a Tagged Values Handler, respectively, of the Package Handler.

The Name Handler, Documentation Handler, Visibility Handler, Constraints Handler, and Tagged Values Handler, map to the Name, Description, Visibility, Constraint Instances and Hint Instances, respectively, of the Package Descriptor.

The Attribute Handler of the Metapackage Impl Generator creates Attribute Implementations of the Metapackage Implementation. Package Descriptor Attr(ibutes), Models Descriptor Attr(ibutes), Constraint Descriptor Attr(ibutes), Tagged Value Descriptor Attribute Implementations, and Other Attr Impl<n> of the Attribute Handler of the Metapackage Implementations create a Package Descriptor, a Models Descriptor, a Tagged Values Descriptor, and Other Attribute<n>, respectively, of Attribute Instances of the Metapackage Instance. The Metapackage Implementation also includes a pointer to the Metapackage Descriptor of which the Metapackage Implementation is an implementation.

Package Descriptor, Models Descriptor, Tagged Values Descriptor, and Other Attribute<n> of other Attribute Instances of the Attribute Instances of the Metapackage instance are a Package Descriptor, as indicated by connector PP, a Models descriptor, as indicated by connector QQ, are Constraint Descriptors, as indicated by connector RR, are Tagged Values as indicated by connector SS, and are other Attributes, as indicated by connector TT, respectively, of the Package Descriptor.

The Packages, Models, Constraint Instances and Other Attribute Instances of the Package Instance create Package Implementations, Models Implementations, Constraint Implementations, and Attribute Implementations, respectively, of the Package Implementation. The Package Instance also includes a pointer to the Package Implementation of which the Package Instance is an instance.

The Packages Implementation, Models Implementation, Constraint Implementations, and Attribution Implementations create a Packages Handler, a Models Handler, a Constraints Handler, and an Other Attributes Handler of the Package Impl Generator.

The Handler, Models Handler, Constraints Handler, and Other Attributes Handler of the Package Impl Generator are read by the Packages Descriptor, as indicated by connector WW, the Models Descriptor, as indicated by the connector WW, the Constraint Descriptors, as indicated by the connector XX, and by the Other Attributes, as indicated by the connector YY, respectively, for the Package Descriptor.

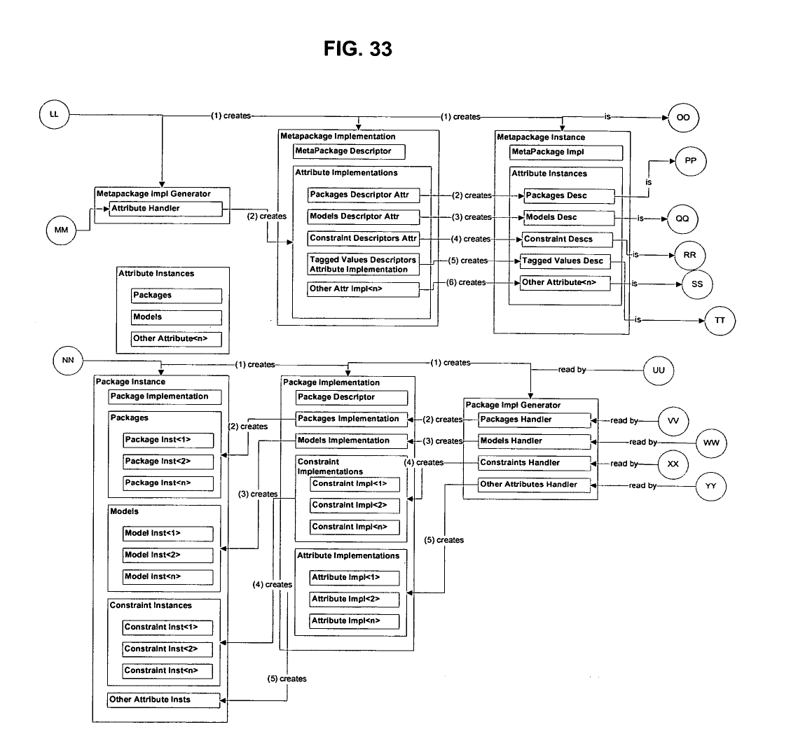

FIG. 33 also shows Attribute Instances including Packages, Models and Other Attributes.

In FIGS. 5-34, there are automatic conversions from UML, such as text descriptions, to the descriptor objects in the Meta-Implementation Layer of the Component Integration Engine. Although not shown in the embodiment of the component integration engine of the present invention of FIGS. 5-34, there may be zero or more handlers to convert various source data to the appropriate descriptor. For each handler there exists a Serializer to convert from a descriptor that that source data format. The user may also directly create a descriptor without using a handler.

A component integration engine of the present invention may be used to create connections between objects dynamically at run-time instead of creating object connections at compile-time. Since object connections are not created at compile time, each object must operate correctly independently of the connections that might be established later. This statement is equivalent to saying that code is more reliable. Creating connections at run-time rather than compile-time offers significantly more flexible functionality at run-time. Using metadata to perform these connections makes connections self-describing. Flexible functionality that is easy to understand (due to its self-describing nature) leads to lower maintenance costs.

Using metadata in at least some embodiments of the component integration engine of the present invention to perform connections between components prevents unexpected access from one component to another component. This restriction on access reduces unexpected side effects between components reducing the types of errors that can occur and limiting the scope of an error if it should occur. In fact, errors are unlikely to cross the metadata connection. These restrictions significantly reduce testing and debugging.

In some embodiments, the component integration engine of the present invention may check security restrictions before performing connections between objects. This allows security to be centralized in the component integration engine, meaning components need to perform little or no additional security checks, while still providing security throughout the entire application.

In some embodiments, the component integration engine of the present invention may identify performance bottlenecks at run-time by logging performance characteristics for each component or component connection. Components can be dynamically reconfigured or replaced at run-time to eliminate bottlenecks. Since the creation of object connections can be performed at runtime and can be performed through compiled metadata that is negligibly slower than compiled code, smaller components can be developed and connected at run-time. Smaller components represent smaller units of functionality and smaller units of data, which leads to a reduction in the proliferation of models and increases the reusability of code (non-redundant code). This propensity of the system to produce smaller units of code, which do not require extensive inheritances, leads to a reduction in development (which correspondingly leads to a reduction in testing and debugging).

The component integration engine of the present invention describes a software application in order to dynamically create that software application without programming is a new category of software. The only similar software in existence is a system of metadata used to describe relational data structures for storage and retrieval (a database). Overcoming implementation difficulties and discovering a high-performing, secure, scalable mechanism to assemble components of any type to affect data of any type in an effort to perform a software task of any type requires several novel software patterns and requires the use of compiled metadata.

In some embodiments, the component integration engine of the present invention may include Hierarchical Model View Controller using events based on metadata (an HMVC 4.6.2 pattern). The model-view-controller pattern has been redesigned to use a “model”—“model controller”—“view controller”—“view” pattern each part of which is allowed to be a hierarchy of objects. Communications occur only between adjacent parts. Communications between the model controller and view controller only occur at the top-most level of the hierarchy, instead of the traditional MVC or HMVC patterns which allow communication between any parts in the system and at any level. Adding this restriction between the model and view controllers allows greater distribution to occur by inserting a “forward” between them (leading to the pattern of “model”—“model controller”—“server-side forward”—“client-side forward”—“view controller”—“view”). Events define the values they carry using a definition. Upon initial registration of an event listener, the metadata definitions are passed to the listener followed by the current values. This innovation allows listeners to more correctly respond to events by adjusting to differences in the metadata, or using the metadata to more fully constrain values.

In another embodiment, the present invention provides a two-part graphical user interface design The first part is the use of metadata as part of the events sent between the model and view. The second part is the change in the structure used to handle these events. The events sent between the model and view relate to changes in values that need to be displayed on the view or adjusted on the model. Different events signify a request for an action to occur, a failure occurring, a change in the display, a change in selection, a change in cursor position, etc. In order to make event handling and event registration easier, the wide variety of different events have been consolidated into a single type of event: an application event. In order to still support the variety that exists in the original event types, events carry a topic object. The topic object carries a function type that is currently one of the following: data, state, action, or log. Additional function types can be added at a later point if a new function type is discovered. These function types correspond to the main event types that are divided in different ways through many different components in different languages. Further, a different topic interfaces exist to describe the type of data they carry. The interfaces that exist for topics currently include the following: definition, destruction, enable, instantiation, invocation, and value. These interfaces also serve as either a notification or a request. The definition topic type contains the metadata definition, which defines valid values that can occur in the event. Destruction events either notify of an object being destroyed or request that another component destroy an object. Enable allows view components or model components to be “disabled” to prevent changes. Instantiation is the opposite of destruction, relating to the creation of objects. Invocation requests a command be executed, or notifies that a command (or method) is being executed. Value notifies (or requests) the current value for a specific name.

For any event name, the combination of a function type, a topic type and the event serving as either a notification or a request allows a very small number of interfaces (4 function types, 6 topic types, and 2 topic roles) to replace all other events models. These interfaces lead to the “4.6.2” in HMVC 4.6.2.

The second part of this innovation is the use of a different structure for handling events between the model and view. The most popular approach is to use a model-view-controller pattern approach. In that approach, all view logic and view components are grouped into the view; all domain logic and business logic is grouped into the model; and all input handling (reacting to events to invoke methods on the model) is placed in the controller. Unfortunately, this does not allow for both small components and high reusability of code.

By placing all the component logic and display logic in the view, the view must handle the logic for getting and setting the data for each component in the view, as well as handling the interactions that occur between components. If selection of one item in a drop-down box causes the addition or removal of items in a different drop-down, the view must handle this. However, if the exact same components, arranged in the exact same layout for display, need to display a slightly different functionality, it may be impossible to reuse the view if the code is not moved into a separate component. If the view does move this logic into a separate component, in the MVC pattern, the view is still the responsibility of the view to setup and add the new component, which still prevents substitution of this logic, and still prevents the reuse of the view.

A solution is to create a new component in the architecture that is responsible for the interactions between components, while leaving the view responsible for individual components. This new object is the view controller. The view controller can be substituted without requiring any changes to the view, allowing complete reuse of a single component or a set of components. To allow substitution of smaller logical parts, a view controller consists of a hierarchy of small functional units, each handling one small group of interactions between components. This allows componentization of display logic and reuse of common functionality even when applied to different sets of components. A view controller therefore meets the two goals of this invention: it reduces direct object connections (by connecting objects through event handling) and improves code reuse (by using a hierarchy of reusable components and moving small differences of display logic out of a view so the view can be reused without submodeling).

A similar situation and solution occurs in the model. By placing all the model logic and attributes in the model, the model must handle the logic for getting and setting the data for each attribute in the model, as well as handling the interactions that occur between attributes. In the case of an on-line order for products, the “order” model holds the “line items” attribute that can contain one or more items being purchased and the “total cost” attribute which is the sum of the cost of each line item. The order model is responsible for adding and removing items from the order as well as the logic to request a credit card number, calculate the total cost of the items, check for authorization, and bill the correct amount to the credit card. Even by separating the credit card and billing logic into a separate model, it is still the responsibility of the order model to setup and use the credit card authorization model. The replacement of credit card billing logic with logic for another method of payment (micro-transactions, electronic check, direct withdrawal) requires a rewrite of the order model to make it aware of these new methods. In the case of micro-transactions, even the calculations for the total cost of the order will be different.

A solution is to create a new component in the architecture that is responsible for interactions between attributes, while leaving the model responsible for the getting and setting attributes. This new object is the model controller. The model controller can be substituted without requiring any changes to the model, allowing complete reuse of a single attribute or a set of attributes. To allow substitution of smaller logical parts, a model controller consists of a hierarchy of small functional units, each handling one small group of interactions between attributes. This allows componentization of model logic and reuse of common functionality even when applied to different sets of attributes. A model controller therefore meets the two goals of this invention: it reduces direct object connections (by connecting objects through event handling) and improves code reuse (by using a hierarchy of reusable components and moving small differences of display logic out of a view so the view can be reused without model inheritance).

So the first adjustment for the HMV is to use a “model-view controller-view-input controller-model controller-model” pattern. Using the pattern of the first adjustment for the HMV, it becomes apparent that the original MVC pattern did not allow events from the model to be changed before being received by the view components, even though it did allow input events from the view to be altered. To give this flexibility, the input controller will be renamed “view out controller” and an equivalent “model out controller” are be added in the same location on the model side to form a “model-model out controller-view in controller-view-view out controller-model in controller-model” pattern.

It also becomes apparent that two object connections are required for each component. To reduce the number of object connections (allowing greater flexibility), and to add more flexibility to modify events that are fired from the model before they reach the view controller an additional modification is made. The view sends its events only to the view controller and the model sends its events only to the model controller. The need for the input controller goes away as the responsibility is placed in the “view controller” hierarchy. The model sends its events to the “model controller” instead. The additional functionality, which otherwise would be gained by adding an “input controller” equivalent to the model side, is added to the “model controller”.

Finally, it becomes apparent that the input events understood by a “view in controller” and the events generated and sent out through the “view out controller” are related and may be managed by the same component. The same is true for the “model in controller” and the “model out controller”. As a side effect of this consolidation of controllers, events no longer flow from the model to the view controller or from the view to the model controller, instead all events flow between the view controller and the model controller. This allows the insertion of “forward” components between the model controller and view controller, which simply convert an event for transport over a network and convert it back once it arrives on the other side.

This results in a HMVC design where from the model side event flow from the model to several submodels. Events from the several submodels flow to a respective subcontroller for each submodel. Each of the subcontrollers transfers events to the model controller. The model controller then transfers events to the model. Events transfer from the Model Controller to the Forward to View and events transfer from the Forward to View to the Model Controller.

In the view side of the HMVC design, events transfer from the view to several subviews that in turn transfer events to respective subcontrollers. The subcontrollers transfer events to the view controller. And events transfer back and forth between the view controller and the forward to model. Also events transfer to the view controller from the view.

The final result is an enhanced version of MVC (HMVC 4.6.2) that uses metadata in order to reduce the number of events from several hundred different types of events to a set of twelve models. Additional models can be added to the HMVC pattern as necessary, but the design will continue to keep the number of models low. HMVC 4.6.2 can programmatically check whether a model will correctly work with a view, which is a task ordinarily left to error-prone human programming. HMVC 4.6.2 is component oriented, supporting increased code reuse while simultaneously decreasing the number of direct object connections to allow greater flexibility.

As a result of the new design, “forward” components can be inserted, adding support for transport over networks without modifying any code in the model, view, model controller, or view controller. As a result of the separation of view logic from view controller logic, a sophisticated view controller can dynamically construct an appropriate view for presenting data for any model based on the model controller's metadata. As a result of the separation of model control logic from the model logic, a sophisticated model controller can support actions (business logic) added dynamically through the CI Engine and which define its data (metadata, enable state, values) through the metadata retrieved for the model the CI Engine is given. Without writing any code, this model controller can be combined with the dynamic view controller to automatically create a view for a model. Using the component integration engine allows the configuration of a forward to support a network distribution, and automatically inherits scalability, security, and database persistence from the component integration engine. Since metadata can be used to describe database records as a model object, the HMVC 4.6.2 model results in a network or web-enabled 3-tier client-server application with dynamically configurable functionality, with automatically created views, automatic view controller logic, and automatic model controller logic without programming a single line of source code.

The use of metadata in events to describe the types of available application functions and data, the definitions of these units, the current state of these units, and the current value of these units allows greater reuse of smaller user interface components. Metadata in events allows a view controller to use the metadata to assemble the correct individual components necessary for display. The metadata used in the events is the descriptors used in the meta-implementation layer.

The HMVC4.6.2 design of the present invention makes use of metadata for defining the events that will be exchanged rather than relying on the programmer to know what events will be passed. Additionally, it provides new mechanisms for coordinating the appropriate view to a model by comparing metadata definitions.

### EXAMPLE 1

The interrelationships between concepts of the present invention may be illustrated by describing the problem domain of pet store management in a hypothetical pet store. A pet store may contain many animals: bunnies, birds, cats, dogs, and fish. Details related to circulatory system processes, eyesight acuity, and fastest recorded land-speed are not related to the problem domain and are abstracted away from the software model. The types of animals suggest the creation of a software model for Bird, Bunny, Cat, Dog, and Fish. Common features between the various types of animals could be grouped into a base model, animal. Animal is an abstraction of Bird, Bunny, Cat, Dog, and Fish because it does not include details specific to these animal types but includes only features common to all these animal types. Dog is a sub-model of Animal that is generally loyal, may slobber a bit, and enjoys chasing cats.

A pet store may also require models related to pet food inventory management. Models related to food inventory are still related to the pet store problem domain, but are not logically similar to software models for the animals. Therefore the Animal, Bird, Bunny, Cat, Dog, and Fish models could be grouped into a package named “animals”. The software models related to food management could be grouped into a package named “inventory”. Both of these packages would be contained in a parent package named “pet store”.

### EXAMPLE 2

The use of a component integration engine of the present invention in system administration will now be described.

A user connects to or communicate with component integration engine through user access points. A user access point is simply a component that understands how to interpret a request from the user and forward that request to the component integration engine. The component integration engine provides two primary user access points: the CommandServiceServlet and the CommandSocketService.

The CommandServiceServlet component accepts requests made using the HTTP protocol (web page submissions). The CommandSocketService accepts incoming socket connections. The component integration engine allows new user access points to be created for any other type of incoming connection. Future user access points might include named pipes, email requests, or remote method invocation.

In order for a user to access a service, it must be made available. The component integration engine server separates services for logical and security reasons. The primary separation is the virtual host. A virtual host is a grouping of services and resources made available for a particular group of users. A virtual host splits one physical computer into multiple virtual computers each of which displays different resources and services to its users. In order to access the resources in a virtual host, a user must be granted permission to use the virtual host.

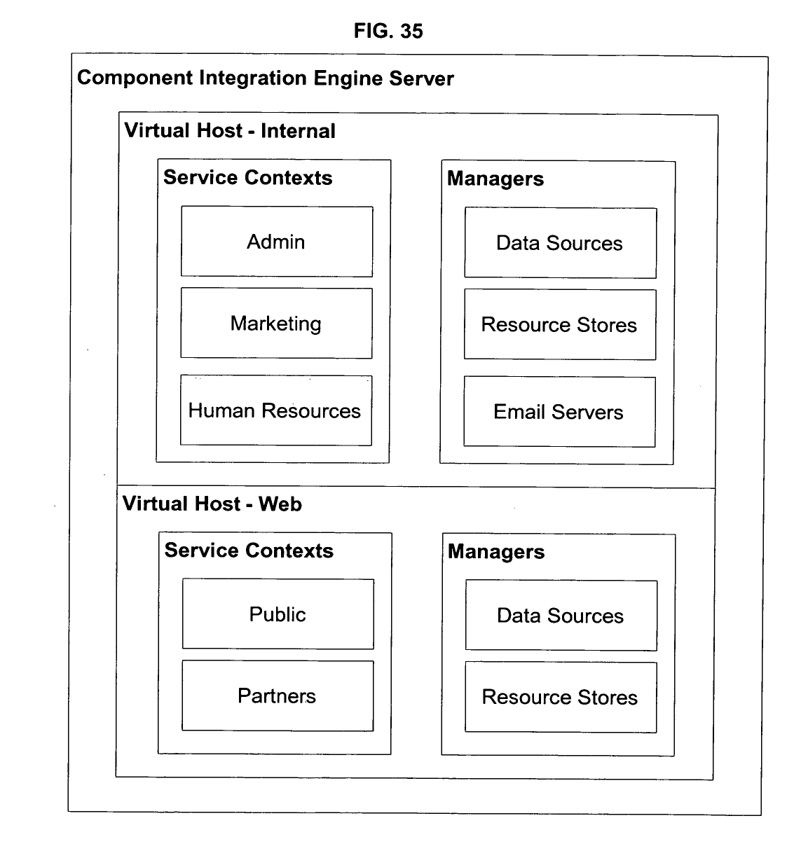

As illustrated in FIG. 35, in the present example, there are two virtual hosts. The internal host contains services and resources useful to employees of the company. These services and resources are not available to users in the second virtual host. The second virtual host includes services for partner businesses and people browsing the company web site.

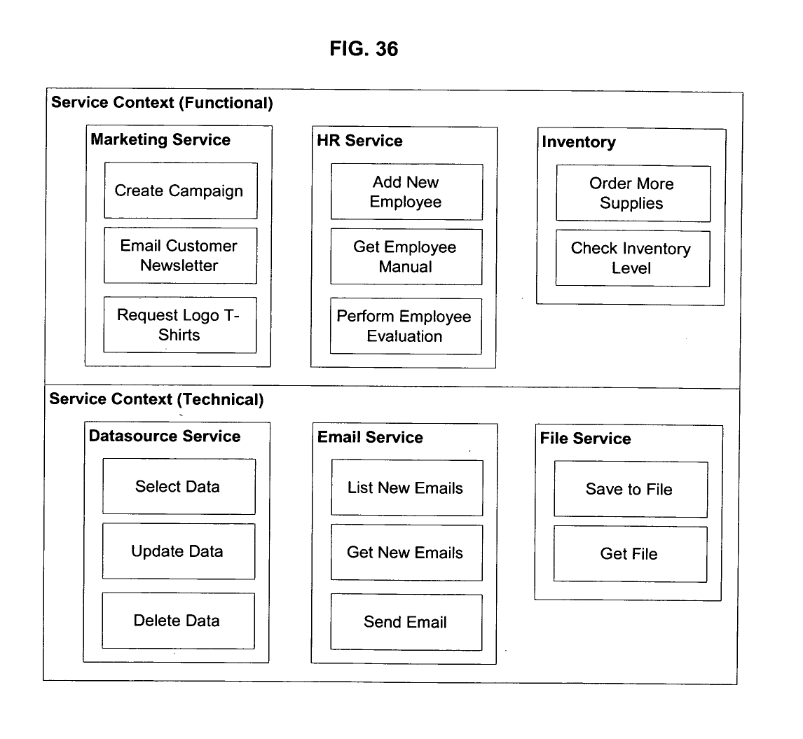

The secondary separation is the service context. A service context is a logical grouping of services available for a particular group of users within a virtual host. While all users in a virtual host have access to the shared components of that virtual host, the services available are determined by the service context. In this way the administrator can control what types of services each group of users is capable of performing. For example, marketing services can be restricted to users in the marketing service context while human resource services can be restricted to users in the human resource service context. Examples of service contexts are illustrated in FIG. 36. In FIG. 36, the Marketing Service, HR Service and Inventory service contexts are classified as functional service contexts and the Database Service, Email Service and File Service contexts are classified as Technical service contexts.

In order to access the services in a service context, a user must be granted permission to use the service, the service context containing that service, and the virtual host containing that service context.

Components are made available to the user through managers in the virtual host. A manager is a group of shared components of the same type. Components provide access to resources like file systems, databases, or email servers. Managed components can also perform specific tasks like multithreading, object customization, or conversion of objects to XML. Each manager has a name used to describe the type of components it manages. Each component in a manager is also given a name for retrieval. Applications retrieve resources by knowing the type of component and the name of the component.

Sharing components improves scalability by reducing processing related to instantiation, configuration, and destruction. In most cases, shared components are created and configured only once (at startup) and are destroyed only once (at shutdown). These components can be reused thousands of times before shutdown and may even be used by multiple users at the same time.

Sharing components also formally separates administrative tasks from development tasks. Shared component configuration and maintenance are the responsibility of the administrator. Rather than writing configuration information directly into application code, developers ask the administrator to setup a shared component. Developers and administrators agree upon the name for a specific resource. Developers use the manager to retrieve a component of the correct type. Administrators select and configure the best component for filling that role.

As an example, the marketing email server may be managed by the email_server manager and stored under the name “marketing.” The developer creates a program for sending emails to every customer in the marketing database and uses the email server with the name “marketing.” The administrator configures an email component optimized for the Microsoft Exchange Server used for marketing. Later, if the administrator replaces the current email server with a Lotus Notes email server, no changes are required in any application. Instead, the administrator simply configures a Lotus Notes email component and stores it under the “marketing” name.

A service is a task performed on the server on behalf of a user. This section describes several different types of services. All services are required to have a name and a description and support start, stop, suspend, and resume operations. The start operation tells a service to prepare itself for use and begin responding to requests. The stop operation tells a service to stop responding to requests and allows the service an opportunity to release resources. The suspend operation tells a service to stop responding to requests but does not require the release of resources. The resume operation tells the service to begin responding to requests again and can only be used on a service in a suspended state.

A threaded service is a service that is always running and performing its task even if no user is connected. These types of services are useful for long-running tasks and background activities that do not necessarily require user interaction. Examples include scheduling events, performance monitoring, and batch processing.

A socket service is a service that accepts network connections on a specific port, following a specific protocol. A socket service interprets the data sent over the network connection and responds accordingly. It sends data back over the network connection in the correct format for the protocol. Examples include POP3 and SMTP servers for sending and receiving email, FTP servers for file transfers, and HTTP servers for web page requests.

A command service is a grouping of commands. A command, which is also a component, is a set of configurable instructions that process input to produce output. Multiple commands can be combined to perform more complex tasks. Some of the largest advantages of component integration engine are derived from command services component integration engine makes command services available and provides the mechanism for combining multiple commands together to accomplish a more complex task component integration engine manages the security and resource access related to these commands, and can return the results in a format appropriate to the user access point. Examples include DatasourceCommandService for accessing data stored in databases, EmailCommandService for sending and receiving email, XSLTXMLService for formatting HTML and XML, and RoadMapService for combining commands to perform more complex tasks.

The components and resources available as part of component integration engine will now be described. Developers may create additional components to support existing and new technologies not already part of component integration engine, so this list may not describe all available components. Other components integrated into the component integration engine may include similar documentation.

Certificates are public keys that can be used to digitally sign data or encrypt data that can be decrypted only with the correct private key. Certificates are held in certificate stores and are accessed by retrieving the appropriate certificate store from the certificate_store manager. Certificates are read-only and can be used by any number of processes simultaneously.

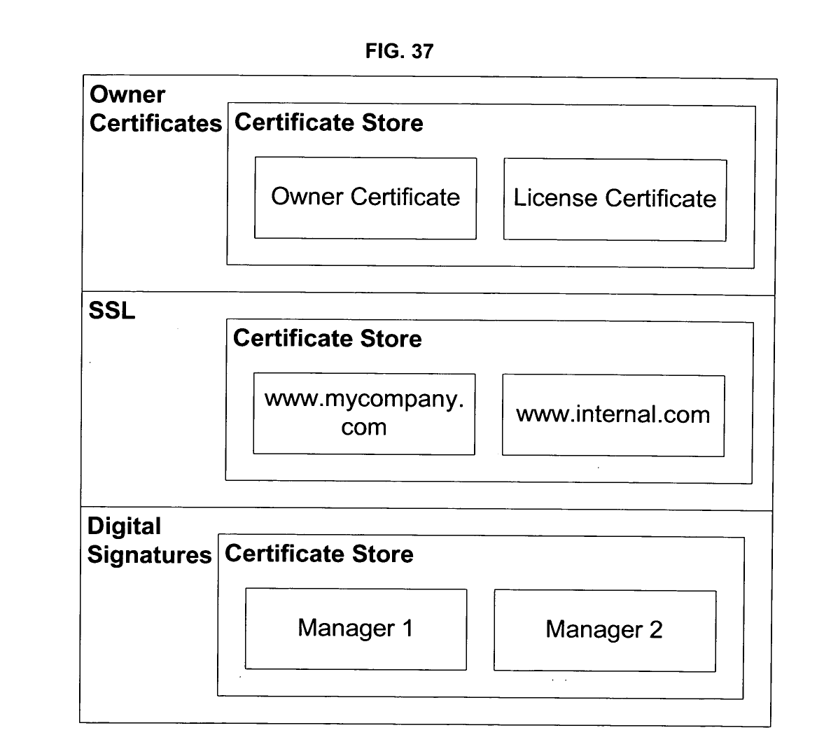

FIG. 37 illustrates the certificate_store manager. In this case, three certificate stores have been bound to the manager: la_license, SSL, and Digital Signatures. The first, la_license, is required to verify licensing. SSL contains certificates that can be used to implement secure web connections using the secure socket layer (SSL) protocol. SSL is an earlier form of the transport layer security (TLS) standard. The last store contains the certificates for two company executives “manager 1” and “manager 2.” These executives can use the certificates to sign electronic documents verifying their own identity and ensuring that the document cannot be changed after their signature is attached.

One certificate store named “license”, that is authenticated by the owner of the computer integration engine server, may be necessary in order to start the component integration engine.

Four managers exist to control functionality related to models: model to common, common to model, known models and modelloader: 1. The model_to_common manager translates between the fully qualified model name and a simpler name. For example, the model mail.server.DefaultMailStore of the present invention can be mapped to DefaultMailStore to make it easier to remember and less confusing. 2. The common_to_model manager translates between the simpler name and the fully qualified model name. 3. The known_models manager maps an interface to a list of models that implement the interface. This manager is useful whenever a component of a specific type is needed. Instead of trying to remember the names of components of that type, a list of all known components is provided. 4. The modelloader manager controls modelloaders. A modelloader is a component that finds the binary representation of a model and loads it into the program as a model. Modelloaders represent strategies for finding binary representations of models and can allow model loading from files, compressed files, databases, network sockets, or other locations.

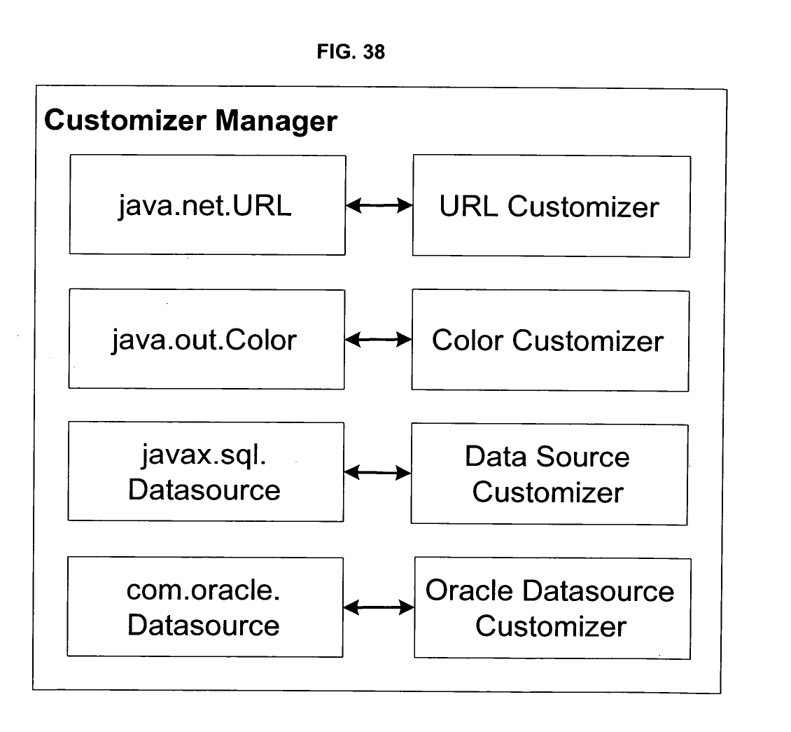

A customizer or customizer manager is a component that knows how to configure, or setup, some other component for use. The customizer can build a metadata object containing all the constructor descriptors, method descriptors, attribute descriptors, and signal descriptors. A customizer can also access one attribute at a time or create a configuration object holding all attribute values. Configuration files can be stored and used to later reset all values. This mechanism is used during startup to configure the virtual hosts, service contexts, services, and managers. FIG. 38 shows a customizer manager mapping a type of component to the customizer responsible for customizing that type of component.

The datasource manager controls datasource objects. Some, but not all datasource objects, that are databases. Datasources return connections for the purpose of retrieving or modifying data. The datasource object is responsible for determining how to share connections and whether or not individual security credentials are required.

Three managers are related to images: image, image decoder and image encoder: 1. The image manager stores image descriptors for common images. An image descriptor knows how to load or build an image. 2. The image_decoder manager stores image-decoding components. Images stored on disk are stored in different formats such as GIF, JPEG, or bitmap. Image decoders convert between the stored format and the format used to render (draw) the image on the screen. 3. Image encoders, managed by the image_encoder manager, perform the opposite task of converting a screen image to a format for storage.

Two managers are related to logging events and failures: log and log target: 1. The log manager is responsible for managing logger objects. Logger objects accept messages and errors and write those messages to each of its log targets. Multiple loggers can share log target objects, so they are shared in the log_target manager. 2. A log target can store messages in a file, on screen, in a database or any other location desired. A log target can also filter messages to accept only messages with high error levels, errors of a certain type or in a certain type, or errors that occur at certain times of day. Filtering log messages accepted by a log target can allow for scenarios where all error messages occurring after 5:00 pm are sent to the system administrator's pager.

Two managers manage email components: mail server and mail store. 1. The mail_server manager contains known email servers configured to send outgoing email or receive incoming email. The details related to socket protocols, login information for shared accounts, and stored protocols are handled by the mail server component. 2. The mail_store manager manages local email storage. Mail stores are used by socket services that provide POP3, IMAP, and SMTP socket protocols. The emails sent or received are stored in the mail store until retrieved by a user.

A mime type is a simple component that describes the content of a stream of data, array of bytes or a file. The mime type consists of the primary part and subpart, separated by a slash. The primary part groups data by datatype like “text” or “image”. The subtype specifies the format of the data exactly like “gif” or “jpeg”. File extensions can also be associated with mime types in order to aid in file processing.

An object pool is a component that stores interchangeable components of the same type. Processes can remove an object from the pool and use it. Each object is returned to its original state before being placed in the pool for use by another process. Using an object pool makes sense when it takes a lot of time to construct or destroy an object, but very little time to clean or reset the object.

An object cache stores infrequently changed objects. Processes can use the object while it remains in the cache. Using an object cache makes sense for objects that take a long time to construct and change infrequently. When the object must be changed, the cache can place a lock on the object to prevent access while the changes are made. Once the object has been updated, the lock can be removed.

Both object pools and object caches store objects in memory in order to reduce the amount of processing performed by the system. In order to balance memory use and processing power, strategies must be employed to control the amount of memory used. These strategies may be examined periodically to ensure that the correct one is being used and is configured optimally. Caches usually use a “least-frequently-used” strategy to eliminate objects that are not used often enough to warrant remaining in memory. Pools often implement a “preferred-level strategy” which slowly decreases the number of objects in the pool to a preferred number.

A resource store is an abstraction away from a specific type of binary storage. Rather than have file managers, database large object binary managers, encoded image managers, zip file managers, and many other forms of binary data access, these concepts are all grouped into a binary “resource” concept. Each type of resource store handles access to one type of binary resource. For example, a file resource store would provide a mechanism for reading and writing the data store in a file. A Blob resource store would provide a mechanism for reading and writing database binary large objects.

The sequence manager manages sequence components. Sequences are components that generate numbers according to some rule. A very simple sequence starts with 1 and then returns each subsequent integer (2, 3, 4, 5, etc.). Other sequences may be much more complex or even random. Sequences are useful for generating numbers for primary keys or other unique identities.

Threads are a mechanism for a computer to execute multiple instructions in a way that appears to be simultaneous. Each set of instructions is executed for a period of time and then swapped out for some other thread's instructions. By swapping threads quickly, each makes progress toward completion and each appears to be running at the same time. Threads are grouped into thread pools. The thread_pool manager manages these pools. By controlling the manner in which threads execute the instructions, a thread pool can throttle or accelerate the processing occurring within the thread pool.

XML is a popular data markup standard. The ability to convert between objects and XML is handled by the xml_serializer and xml_taghandler managers. The XML serializer manager manages XML serializer components that convert objects to XML. The XML taghandler manager converts XML back into objects. XML serializers are retrieved by the type of object that needs to be converted to XML. XML taghandlers are retrieved by the XML tag name being converted into an object.

For an object to be a manager, the developer must implement the manager interface. This allows for many other types of managers to be added to the system as the need for them arises. Therefore, the above list may not contain all possible managers and the above managers can be bound to different names to serve different purposes. For example an image manager might be bound to “campaign_images” to store the images related to a specific campaign. Or an XML serializer manager might be bound to “partner_xml” to write XML used only by a partner company.

Side effects are events that happen during code execution and continue to exist after execution has ended. For example a component that writes files may construct the directory structure prior to writing the file. Once the files are written, the directory structure remains. A component may create an index on a database table to make record selection faster. While not necessarily undesirable, side effects can make it more difficult to share a component if they alter the environment.

Security is required for any multi-user architecture. The component integration engine enforces security at the levels detailed below.

No amount of software security will protect a system not physically under lock and key. If a thief has the ability to access the computer hardware, all software techniques stand a much greater chance of being circumvented. Data can be accessed without going through the system's security constraints. Passwords can be physically overwritten on the disk or password scanners can be applied to retrieve passwords. Only encrypted data pose a problem to someone with physical access to a secure system and even then the data may eventually be decrypted given enough time and processing power.

Sandbox security refers to security built into the programming language. The sandbox security policy controls which components are allowed to run and what actions they are allowed to take. The mechanism for how this is controlled is language dependant. One embodiment of the present invention might use Java's sandbox security policy. Another embodiment of the present invention might use Net's security policies. The CIE owner will standardize the sandbox security mechanisms of each platform into a security policy component type.

The authorization policy is similar to the sandbox policy except that it lists the privileges to execute code and access resources associated with each user. The sandbox policy decides whether or not code is trusted to execute at all. The authorization policy decides if the user is trusted to execute a specific piece of code.

In order to determine the user associated with the current execution of a task, the user must provide credentials verifying identity. Usually some part of these credentials is a secret known only to the user such as a username and password. Sometimes these credentials are publicly known, but hard to duplicate like a passport, driver's license or fingerprint.

To support different types of authentication, component integration engine allows the swapping of components used to perform the authentication. By stacking authentication modules, the administrator can require more than one form of authentication.

The component integration engine of the present example provides six layers of component level security by restricting access to the various components. If the current user does not have the correct privileges, the component cannot be accessed. Component security is checked in all of the following situations: a user tries to access a virtual host, a user tries to access a service context, a user tries to access a service, a user tries to execute a command, a user tries to access a manager, and a user tries to retrieve a component from a manager.

Component security is based on the name of the component being accessed or the operation being performed. The mechanism for controlling user access is called a privilege. The following is an example of components and the necessary privileges if the system administrator has setup a virtual host named localhost, a service context named marketing, and several services and managers: 1. A user must have the localhost privilege in order to access the virtual host named localhost. 2. A user must have the localhost.marketing privilege in order to access the marketing service context in the localhost virtual host. The user must also have enough privileges to use the localhost virtual host. The general format for privileges required to access a service context is<virtual host name>.<service context name>. 3. A user must have the localhost.marketing.datasource privilege in order to access the datasource service in the marketing service context of the localhost virtual host. The user must also have enough privileges to use the marketing service context. The general format for privileges required to access a service is<virtual host name>.<service context name>.<service name>. 4. A user must have the localhost.email_server privilege in order to use components in the email_server manager in the localhost virtual host. The user must also have enough privileges to use the localhost virtual host. The general format for privileges required to access a manager is<virtual host name>.<manager name>. 5. A user must have the localhost.email_server.marketing privilege in order to use the marketing component in the email_server manager in the localhost virtual host. The user must also have enough privileges to use the email server manager. The general format for privileges required to access a managed component is<virtual host name>.<manager name>.<component name>.

Privileges are associated with a thread of execution. For this reason, it is not possible to use thread pools to execute secure tasks without first associating the correct credentials and removing those credentials at the end of the execution. In fact certain credentials are required just to start the component integration engine. These credentials are associated with the system principal and no user other than the system administrator may be allowed to use the system principal account.

The component integration engine checks permissions associated with an assembly of components. If the component assembly specifies permission requirements, these permissions must be held by a user in order for the assembly to be executed.

The component integration engine also provides encryption and digital signature components. An encryption component can be used to encrypt data to prevent access to anyone without the correct decryption credentials. Digital signatures provide a mechanism to prove that the source of the data was from a specific user and that the data was not altered in any way.

Unlike the previous security sections, encryption and digital signatures are optional security features. A component integration engine provides components to perform encryption and digital signatures because data is not always accessed through the component integration engine. Databases, files, and email can all be accessed directly. By encrypting the data stored in these locations, data access is restricted to a user with the correct decryption credentials using the component integration engine.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

1. A meta-implementation layer comprising:
a metamodel repository containing a plurality of descriptors;
a plurality of implementations for providing access to software components described by said plurality of descriptors;
a metametamodel repository including a plurality of metamodel descriptors for describing said descriptors and a plurality of metamodel implementations for describing said implementations, wherein said meta-implementation layer provides access to an implementation of said plurality of implementations to thereby allow a user to have access to said software components of a software program.

2. The meta-implementation layer of claim 1, wherein said plurality of descriptors include at least one enumeration descriptor.

3. The meta-implementation layer of claim 2, wherein said plurality of implementations includes at least one enumeration implementation associated with said enumeration descriptor.

4. The meta-implementation layer of claim 1, wherein said plurality of descriptors include at least one role descriptor.

5. The meta-implementation layer of claim 4, wherein said plurality of implementations includes at least one role implementation associated with said role descriptor.

6. The meta-implementation layer of claim 1, wherein said plurality of descriptors include at least one hint descriptor.

7. The meta-implementation layer of claim 6, wherein said plurality of implementations includes at least one hint implementation associated with said hint descriptor.

8. The meta-implementation layer of claim 1, wherein said plurality of descriptors include at least one datatype descriptor.

9. The meta-implementation layer of claim 8, wherein said plurality of implementations includes at least one datatype implementation associated with said datatype descriptor.

10. The meta-implementation layer of claim 1, wherein said plurality of descriptors include at least one constraint descriptor.

11. The meta-implementation layer of claim 10, wherein said plurality of implementations includes at least one constraint implementation associated with said constraint descriptor.

12. The meta-implementation layer of claim 1, wherein said plurality of descriptors include at least one attribute descriptor.

13. The meta-implementation layer of claim 12, wherein said plurality of implementations includes at least one attribute implementation associated with said attribute descriptor.

14. The meta-implementation layer of claim 1, wherein said plurality of descriptors include at least one otherelement descriptor.

15. The meta-implementation layer of claim 14, wherein said plurality of implementations includes at least one otherelement implementation associated with said otherelement descriptor.

16. The meta-implementation layer of claim 1, wherein said plurality of descriptors include at least one parameter descriptor.

17. The meta-implementation layer of claim 16, wherein said plurality of implementations includes at least one parameter implementation associated with said parameter descriptor.

18. The meta-implementation layer of claim 1, wherein said plurality of descriptors include at least one method descriptor.

19. The meta-implementation layer of claim 18, wherein said plurality of implementations includes at least one method implementation associated with said method descriptor.

20. The meta-implementation layer of claim 1, wherein said plurality of descriptors include at least one signal descriptor.

21. The meta-implementation layer of claim 20, wherein said plurality of implementations includes at least one signal implementation associated with said signal descriptor.

22. The meta-implementation layer of claim 1, wherein said plurality of descriptors include at least one interface descriptor.

23. The meta-implementation layer of claim 22, wherein said plurality of implementations includes at least one interface implementation associated with said interface descriptor.

24. The meta-implementation layer of claim 1, wherein said plurality of descriptors includes at least one model descriptor.

25. The meta-implementation layer of claim 24, wherein said plurality of implementations includes at least one model implementation associated with said model descriptor.

26. The meta-implementation layer of claim 1, wherein said plurality of descriptors include at least one package descriptor.

27. The meta-implementation layer of claim 26, wherein said plurality of implementations includes at least one package implementation associated with said package descriptor.

28. The meta-implementation layer of claim 1, wherein said plurality of implementations include at least one accessor.

29. The meta-implementation layer of claim 28, wherein said plurality of implementations include a plurality of accessors and wherein said plurality of accessors includes at least one selected accessor associated with at least one descriptor and at least one implementation.

30. The accessor of claim 29, wherein said selected accessor participates in said meta-implementation layer as an enumeration implementation, role implementation, hint implementation, datatype implementation, constraint implementation, attribute implementation, otherelement implementation, parameter implementation, method implementation, signal implementation, interface implementation, model implementation, or package implementation.

31. The meta-implementation layer of claim 1, wherein said meta-implementation layer is stored in a computer system.

32. A component integration engine comprising:
a meta-implementation layer for allowing a user to have access to software components of a software program;
a plurality of component integration instances for providing access to software component instances to thereby allow said software component instances to be assembled in said software program;
communication means for allowing said user to communicate with said component integration engine; and
assembly means for assembling said component integration instances to build said software program.

33. The component integration engine of claim 32, wherein said meta-implementation layer comprises:
a metamodel repository containing a plurality of descriptors;
a plurality of implementations for providing access to said software components described by said plurality of descriptors;
a metametamodel repository including a plurality of metamodel descriptors for describing said descriptors and a plurality of metamodel implementations for describing said implementations, wherein said meta-implementation layer provides access to an implementation of said plurality of implementations to thereby allow said user to have access to said software components of said software program.

34. The component integration engine of claim 32, further comprising an authentication means for verifying the identity of said user and for verifying that said user has permission to use said component integration engine

35. The component integration engine of claim 32, further comprising one or more component assemblies for creating interactions between said software components to accomplish a specific task.

36. The component integration engine of claim 35, further comprising one or more persistence engines for storage and retrieval of configuration and state data of said software components and of said component assemblies.

37. The component integration engine of claim 32, wherein said plurality of instances includes at least one enumeration instance.

38. The component integration engine of claim 32, wherein said plurality of instances includes at least one role instance.

39. The component integration engine of claim 32, wherein said plurality of instances includes at least one hint instance.

40. The component integration engine of claim 32, wherein said plurality of instances includes at least one datatype instance.

41. The component integration engine of claim 32, wherein said plurality of instances includes at least one constraint instance.

42. The component integration engine of claim 32, wherein said plurality of instances includes at least one attribute instance.

43. The component integration engine of claim 32, wherein said plurality of instances includes at least one otherelement instance.

44. The component integration engine of claim 32, wherein said plurality of instances includes at least one parameter instance.

45. The component integration engine of claim 32, wherein said plurality of instances includes at least one method instance.

46. The component integration engine of claim 32, wherein said plurality of instances includes at least one signal instance.

47. The component integration engine of claim 32, wherein said plurality of instances includes at least one interface instance.

48. The component integration engine of claim 32, wherein said plurality of instances includes at least one model instance.

49. The component integration engine of claim 32, wherein said plurality of instances includes at least one package instance.

50. The component integration engine of claim 32, wherein said component integration engine is stored in a computer system.

51. A computer system having a meta-implementation layer stored therein, wherein said meta-implementation layer comprises:
a metamodel repository containing a plurality of descriptors;
a plurality of implementations for providing access to software components described by said plurality of descriptors;
a metametamodel repository including a plurality of metamodel descriptors for describing said descriptors and a plurality of metamodel implementations for describing said implementations, wherein said meta-implementation layer provides access to an implementation of said plurality of implementations to thereby allow a user to have access to said software components of a software program.

52. The computer system of claim 51, wherein said computer system has a component integration engine stored therein, wherein said computer integration engine comprises:
said meta-implementation layer;
a plurality of component integration instances for providing access to software component instances to thereby allow said software component instances to be assembled in said software program;
communication means for allowing said user to communicate with said component integration engine; and
assembly means for assembling said component integration instances to build said software program.

53. A machine readable medium including instructions stored thereon that when executed by a computer system produce a meta-implementation layer, wherein said meta-implementation layer comprises:
a metamodel repository containing a plurality of descriptors;
a plurality of implementations for providing access to software components described by said plurality of descriptors;
a metametamodel repository including a plurality of metamodel descriptors for describing said descriptors and a plurality of metamodel implementations for describing said implementations, wherein said meta-implementation layer provides access to an implementation of said plurality of implementations to thereby allow a user to have access to said software components of a software program.

54. The machine readable medium of claim 53, wherein said instructions when executed by said computer system produce a component integration engine, and wherein said computer integration engine comprises:
said meta-implementation layer;
a plurality of component integration instances for providing access to software component instances to thereby allow said software component instances to be assembled in said software program;
communication means for allowing said user to communicate with said component integration engine; and
assembly means for assembling said component integration instances to build said software program.
